(19) United States
(12) Patent Application Publication
(10) Pub. No.: US 2026/0211291 A1
(43) Pub. Date: Jul. 23, 2026

(54) DISPLAY SUBSTRATE AND DISPLAY DEVICE

(71) Applicant: Sharp Display Technology Corporation, Kameyama City (JP)

(72) Inventor: Masakatsu TOMINAGA, Kameyama City (JP)

(21) Appl. No.: 19/444,381

(22) Filed: Jan. 9, 2026

(30) Foreign Application Priority Data
Jan. 20, 2025 (JP) 2025-007608

(51) Int. Cl. G02F 1/1362; G02F 1/1343; G06F 3/041

(52) U.S. Cl. CPC G02F 1/136286; G02F 1/134309; G06F 3/0412

(57) ABSTRACT

A display substrate includes a first pixel electrode interposed between a first scanning wiring line and a second scanning wiring line, a second pixel electrode arranged with a space from the first pixel electrode, a first control wiring line arranged with a space from the first scanning wiring line, a second control wiring line arranged with a space from the second scanning wiring line, a first signal wiring line, a first switching element connected to the first control wiring line and the first signal wiring line, a second switching element connected to the first scanning wiring line, the first switching element, and the first pixel electrode, a third switching element connected to the second control wiring line and the first signal wiring line, and a fourth switching element connected to the second scanning wiring line, the third switching element, and the second pixel electrode.

### CROSS-REFERENCE TO RELATED APPLICATIONS

This application claims the benefit of priority to Japanese Patent Application Number 2025-007608 filed on Jan. 20, 2025. The entire contents of the above-identified application are hereby incorporated by reference.

### BACKGROUND

Technical Field

The techniques disclosed in the present specification relate to display substrates and display devices, in which parasitic capacitance can be reduced.

In the related art, examples of display devices described in JP 09-329809 A and JP 2000-276110 A are known. In both JP 09-329809 A and JP 2000-276110 A, liquid crystal display devices are disclosed as display devices. The liquid crystal display device described in JP 09-329809 A includes scanning lines and signal lines provided in a matrix shape, control lines provided in parallel with the signal lines, first switching elements that are turned on by drive signals applied to the scanning lines and apply signals applied to the signal lines to liquid crystal, and second switching elements that are connected in series with the first switching elements and are controlled to be turned on and off by signals applied to the control lines.

The display portion included in the liquid crystal display device described in JP 2000-276110 A is divided into first to n-th blocks. In the display portion, a plurality of scanning lines and signal lines are arrayed in a matrix shape, and a pixel cell is disposed at each intersection of the scanning lines and the signal lines. The pixel cell includes a pixel aSW (pixel analog switch) that is an analog switch controlled by block control signals, and a pixel TFT controlled by scanning signals. For example, the pixels in the first block are connected to the block control lines, and the pixels aSW in the second block are connected to the block control lines. The display signals are written into the pixel cells selected by the block control signals and the scanning signals.

### SUMMARY

According to the liquid crystal display device described in the above-mentioned JP 09-329809 A, although the number of signal lines can be reduced to about one half of that in the related art, the number of signal lines to be reduced is limited. On the other hand, according to the liquid crystal display device described in the above-mentioned JP 2000-276110 A, depending on the number of block control lines, the number of signal lines can be further reduced as compared with JP 09-329809 A. However, in JP 2000-276110 A, n block control lines parallel to the scanning lines are collectively arranged on the same side as the scanning lines with respect to the rows of the pixel cells. For this reason, in addition to the parasitic capacitance occurring between the scanning lines and the block control lines, parasitic capacitance also occurs between the n block control lines, respectively. Moreover, the gate electrodes of pixels aSW belonging to the n-th block are in a crossing relationship with (n−1) block control lines in addition to the scanning lines, so that the number of intersection points with the respective lines increases, which causes parasitic capacitance to become large. Due to such parasitic capacitance, signal dullness easily occurs in the respective lines, and as a result, the operation of the pixel TFT and the pixel aSW becomes unstable, and the potential of the pixel cell may also be likely to fluctuate.

The techniques described in the present specification have been completed based on the circumstances described above, and an object thereof is to reduce parasitic capacitance.

(1) A display substrate according to the techniques described in the present specification includes a first scanning wiring line extending along a first direction, a second scanning wiring line extending along the first direction and arranged with a space from the first scanning wiring line, a first pixel electrode interposed between the first scanning wiring line and the second scanning wiring line, a second pixel electrode interposed between the first scanning wiring line and the second scanning wiring line and arranged with a space from the first pixel electrode in the first direction, a first control wiring line extending along the first direction and arranged with a space from the first scanning wiring line without the first pixel electrode and the second pixel electrode being interposed, a second control wiring line extending along the first direction and arranged with a space from the second scanning wiring line without the first pixel electrode and the second pixel electrode being interposed, a first signal wiring line extending along a second direction intersecting with the first direction and intersecting with the first scanning wiring line, the second scanning wiring line, the first control wiring line, and the second control wiring line, a first switching element connected to the first control wiring line or the first scanning wiring line and the first signal wiring line, a second switching element connected to the first scanning wiring line or the first control wiring line, the first switching element, and the first pixel electrode, a third switching element connected to the second control wiring line or the second scanning wiring line and the first signal wiring line, and a fourth switching element connected to the second scanning wiring line or the second control wiring line, the third switching element, and the second pixel electrode.

(2) In addition to the above (1), in the display substrate, the first switching element may be connected to the first control wiring line, the second switching element may be connected to the first scanning wiring line, the third switching element may be connected to the second control wiring line, and the fourth switching element may be connected to the second scanning wiring line.

(3) In addition to (2), the display substrate may include a third pixel electrode arranged with at least the first scanning wiring line and the first control wiring line interposed between the third pixel electrode and the first pixel electrode, a third scanning wiring line extending along the first direction and interposed between the first pixel electrode and the third pixel electrode, a fifth switching element connected to the first control wiring line and the first signal wiring line, and a sixth switching element connected to the third scanning wiring line, the fifth switching element, and the third pixel electrode.

(4) In addition to (2) or (3), in the display substrate, the first scanning wiring line may be arranged closer to the first pixel electrode and the second pixel electrode than the first control wiring line, and the second scanning wiring line may be arranged closer to the first pixel electrode and the second pixel electrode than the second control wiring line.

(5) In addition to any one of (2) to (4), the display substrate may include a fourth pixel electrode interposed between the first scanning wiring line and the second scanning wiring line and arranged with a space from the first pixel electrode and the second pixel electrode in the first direction, a fifth pixel electrode interposed between the first scanning wiring line and the second scanning wiring line and arranged with a space from the first pixel electrode, the second pixel electrode, and the fourth pixel electrode in the first direction, a third control wiring line extending along the first direction and arranged with a space from the first scanning wiring line and the first control wiring line without the first pixel electrode, the second pixel electrode, the fourth pixel electrode, and the fifth pixel electrode being interposed, a fourth control wiring line extending along the first direction and arranged with a space from the second scanning wiring line and the second control wiring line without the first pixel electrode, the second pixel electrode, the fourth pixel electrode, and the fifth pixel electrode being interposed, a seventh switching element connected to the third control wiring line and the first signal wiring line, an eighth switching element connected to the first scanning wiring line, the seventh switching element, and the fourth pixel electrode, a ninth switching element connected to the fourth control wiring line and the first signal wiring line, and a tenth switching element connected to the second scanning wiring line, the ninth switching element, and the fifth pixel electrode.

(6) In addition to (5), the display substrate may include the first signal wiring line branched into a first branch portion extending along the second direction and a second branch portion extending along the second direction and arranged with a space from the first branch portion in the first direction, the first branch portion being connected with at least the first switching element and the seventh switching element, the second branch portion being connected with at least the third switching element and the ninth switching element, the first pixel electrode and the fourth pixel electrode being arranged with the first branch portion interposed between the first pixel electrode and the fourth pixel electrode in the first direction, and the second pixel electrode and the fifth pixel electrode being arranged with the second branch portion interposed between the second pixel electrode and the fifth pixel electrode in the first direction, the display substrate includes a second signal wiring line extending along the second direction and including a portion interposed between the first branch portion and the second branch portion in the first direction, a sixth pixel electrode arranged with a space from the second signal wiring line in the first direction, a seventh pixel electrode arranged with the second signal wiring line interposed between the sixth pixel electrode and the seventh pixel electrode in the first direction, an eleventh switching element connected to the second control wiring line and the second signal wiring line, a twelfth switching element connected to the second scanning wiring line, the eleventh switching element, and the sixth pixel electrode, a thirteenth switching element connected to the fourth control wiring line and the second signal wiring line, a fourteenth switching element connected to the second scanning wiring line, the thirteenth switching element, and the seventh pixel electrode, and a signal supply unit configured to supply signals opposite in polarity to each other to the first signal wiring line and the second signal wiring line.

(7) In addition to (5), the display substrate may include a second signal wiring line extending along the second direction, a first signal wiring line branched into a first branch portion extending along the second direction and a second branch portion extending along the second direction and arranged with a space from the first branch portion in the first direction, the first branch portion being connected with at least the first switching element and the seventh switching element, the second branch portion being connected with at least the third switching element and the ninth switching element, a second signal wiring line branched into a third branch portion extending along the second direction and a fourth branch portion extending along the second direction, the fourth branch portion being arranged with the first branch portion interposed between the third branch portion and the fourth branch portion in the first direction and interposed between the first branch portion and the second branch portion, the first pixel electrode and the fourth pixel electrode being arranged with at least the first branch portion interposed between the first pixel electrode and the fourth pixel electrode in the first direction, and the second pixel electrode and the fifth pixel electrode being arranged with at least the second branch portion interposed between the second pixel electrode and the fifth pixel electrode in the first direction, the display substrate may include an eighth pixel electrode arranged with the fourth branch portion interposed between the second pixel electrode and the eighth pixel electrode in the first direction and interposed between the first pixel electrode and the fourth branch portion, a ninth pixel electrode arranged with the first branch portion interposed between the first pixel electrode and the ninth pixel electrode in the first direction and interposed between the fourth pixel electrode and the first branch portion, a tenth pixel electrode arranged with the second branch portion interposed between the fifth pixel electrode and the tenth pixel electrode in the first direction and interposed between the second pixel electrode and the second branch portion, a fifteenth switching element connected to the second control wiring line and the fourth branch portion, a sixteenth switching element connected to the second scanning wiring line, the fifteenth switching element, and the eighth pixel electrode, a seventeenth switching element connected to the first control wiring line and the third branch portion, an eighteenth switching element connected to the first scanning wiring line, the seventeenth switching element, and the ninth pixel electrode, a nineteenth switching element connected to the fourth control wiring line and the fourth branch portion, and a twentieth switching element connected to the second scanning wiring line, the nineteenth switching element, and the tenth pixel electrode.

(8) In addition to (5), the display substrate, including the first pixel electrode, the second pixel electrode, the fourth pixel electrode, and the fifth pixel electrode constituting a first pixel electrode row, may include a second pixel electrode row including a plurality of pixel electrodes arranged with at least the second scanning wiring line and the second control wiring line interposed between the first pixel electrode row and the second pixel electrode row in the second direction, and a second signal wiring line extending along the second direction, wherein the first signal wiring line includes a first wiring line portion crossing the first pixel electrode row and extending along the second direction, a second wiring line portion crossing the second pixel electrode row, arranged at a position spaced apart from the first wiring line portion in the first direction and extending along the second direction, and a first bridging portion connecting the first wiring line portion and the second wiring line portion, the second signal wiring line includes a third wiring line portion crossing the first pixel electrode row, positioned in the same column as the second wiring line portion and extending along the second direction, a fourth wiring line portion crossing the second pixel electrode row, positioned in the same column as the first wiring line portion and extending along the second direction, and a second bridging portion connecting the third wiring line portion and the fourth wiring line portion, the first pixel electrode and the fourth pixel electrode are arranged with the first wiring line portion interposed between the first pixel electrode and the fourth pixel electrode in the first direction, an eleventh pixel electrode is arranged with a space from the third wiring line portion in the first direction, a twelfth pixel electrode is arranged with the third wiring line portion interposed between the eleventh pixel electrode and the twelfth pixel electrode in the first direction, a thirteenth pixel electrode is the pixel electrode constituting the second pixel electrode row and is arranged with a space from the second wiring line portion in the first direction, a fourteenth pixel electrode is the pixel electrode constituting the second pixel electrode row and is arranged with the second wiring line portion interposed between the thirteenth pixel electrode and the fourteenth pixel electrode in the first direction, a fifteenth pixel electrode is the pixel electrode constituting the second pixel electrode row and is arranged with a space from the fourth wiring line portion in the first direction, a sixteenth pixel electrode is the pixel electrode constituting the second pixel electrode row and is arranged with the fourth wiring line portion interposed between the fifteenth pixel electrode and the sixteenth pixel electrode in the first direction, a fourth scanning wiring line extends along the first direction and is arranged with the second pixel electrode row interposed between the second scanning wiring line, the second control wiring line, and the fourth control wiring line in the second direction, a fifth control wiring line extends along the first direction and is arranged with a space from the fourth scanning wiring line without the second pixel electrode row being interposed, a sixth control wiring line extends along the first direction and is arranged with a space from the fourth scanning wiring line and the fifth control wiring line without the second pixel electrode row being interposed, a fifth scanning wiring line extends along the first direction and is interposed between the first pixel electrode row and the second pixel electrode row in the second direction, a twenty-first switching element is connected to the first control wiring line and the third wiring line portion, a twenty-second switching element is connected to the first scanning wiring line, the twenty-first switching element, and the eleventh pixel electrode, a twenty-third switching element is connected to the third control wiring line and the third wiring line portion, a twenty-fourth switching element is connected to the first scanning wiring line, the twenty-third switching element, and the twelfth pixel electrode, a twenty-fifth switching element is connected to the fifth control wiring line and the second wiring line portion, a twenty-sixth switching element is connected to the fourth scanning wiring line, the twenty-fifth switching element, and the thirteenth pixel electrode, a twenty-seventh switching element is connected to the sixth control wiring line and the second wiring line portion, a twenty-eighth switching element is connected to the fourth scanning wiring line, the twenty-seventh switching element, and the fourteenth pixel electrode, a twenty-ninth switching element is connected to the fifth control wiring line and the fourth wiring line portion, a thirtieth switching element is connected to the fourth scanning wiring line, the twenty-ninth switching element, and the fifteenth pixel electrode, a thirty-first switching element is connected to the sixth control wiring line and the fourth wiring line portion, a thirty-second switching element is connected to the fourth scanning wiring line, the thirty-first switching element, and the sixteenth pixel electrode, and a signal supply unit is configured to supply signals opposite in polarity to each other to the first signal wiring line and the second signal wiring line.

(9) In addition to any one of (1) to (8), the display substrate may include a common electrode arranged to overlap at least the first pixel electrode and the second pixel electrode with an insulating film interposed between the common electrode and at least the first pixel electrode and the second pixel electrode and a common wiring line extending along the second direction and connected to the common electrode, wherein the common wiring line includes at least the first common wiring line arranged with the first pixel electrode interposed between the first signal wiring line and the first common wiring line in the first direction.

(10) In addition to any one of (1) to (8), the display substrate may include a position detection electrode arranged to overlap at least the first pixel electrode and the second pixel electrode with an insulating film interposed between the position detection electrode and at least the first pixel electrode and the second pixel electrode and a position detection wiring line extending along the second direction and connected to the position detection electrode, wherein the position detection wiring line includes at least a first position detection wiring line arranged with the first pixel electrode interposed between the first signal wiring line and the first position detection wiring line in the first direction.

(11) A display device according to the techniques described in the present specification includes the display substrate according to any one of (1) to (10), and a counter substrate arranged to face the display substrate.

According to the techniques described in the present specification, parasitic capacitance can be reduced.

### BRIEF DESCRIPTION OF DRAWINGS

The disclosure will be described with reference to the accompanying drawings, wherein like numbers reference like elements.

FIG. 1 is a plan view of a liquid crystal panel, drivers, a flexible substrate, and a control substrate according to a first embodiment.

FIG. 2 is a cross-sectional view of the liquid crystal panel, the driver, and the flexible substrate according to the first embodiment.

FIG. 3 is a plan view schematically illustrating a relationship among gate drive circuits, control trunk wiring lines, pixel electrodes, gate wiring lines, and control wiring lines included in the liquid crystal panel according to the first embodiment

FIG. 4 is a plan view illustrating a pixel array of an array substrate constituting the liquid crystal panel according to the first embodiment.

FIG. 5 is a cross-sectional view of the liquid crystal panel according to the first embodiment, taken along line v-v in FIG. 4.

FIG. 6 is a cross-sectional view of the liquid crystal panel according to the first embodiment, taken along line vi-vi in FIG. 4.

FIG. 7 is a circuit diagram illustrating an electrical configuration of the liquid crystal panel according to the first embodiment.

FIG. 8 is a circuit diagram illustrating enlarged main portions of the electrical configuration of the liquid crystal panel according to the first embodiment.

FIG. 9 is a timing chart relating to an operation of a control TFT and a pixel TFT according to the first embodiment.

FIG. 10 is a circuit diagram illustrating an electrical configuration of a liquid crystal panel according to a second embodiment.

FIG. 11 is a plan view illustrating a pixel array of an array substrate constituting the liquid crystal panel according to the second embodiment.

FIG. 12 is a circuit diagram illustrating an electrical configuration of a liquid crystal panel according to a third embodiment.

FIG. 13 is a plan view illustrating a pixel array of an array substrate constituting the liquid crystal panel according to the third embodiment.

FIG. 14 is a circuit diagram illustrating an electrical configuration of a liquid crystal panel according to a fourth embodiment.

FIG. 15 is a plan view illustrating a pixel array of an array substrate constituting the liquid crystal panel according to the fourth embodiment.

FIG. 16 is a cross-sectional view of the array substrate constituting the liquid crystal panel according to the fourth embodiment, taken along line xvi-xvi in FIG. 15.

FIG. 17 is a plan view of a liquid crystal panel, drivers, and a flexible substrate according to a fifth embodiment.

FIG. 18 is a circuit diagram illustrating an electrical configuration of the liquid crystal panel according to the fifth embodiment.

FIG. 19 is a plan view illustrating a pixel array of an array substrate constituting the liquid crystal panel according to the fifth embodiment.

FIG. 20 is a cross-sectional view of the array substrate constituting the liquid crystal panel according to the fifth embodiment, taken along line xx-xx in FIG. 19.

FIG. 21 is a plan view of a liquid crystal panel, drivers, and a flexible substrate according to a sixth embodiment.

FIG. 22 is a circuit diagram illustrating an electrical configuration of the liquid crystal panel according to the sixth embodiment.

FIG. 23 is a circuit diagram illustrating an electrical configuration of a liquid crystal panel according to a seventh embodiment.

### DESCRIPTION OF EMBODIMENTS

### First Embodiment

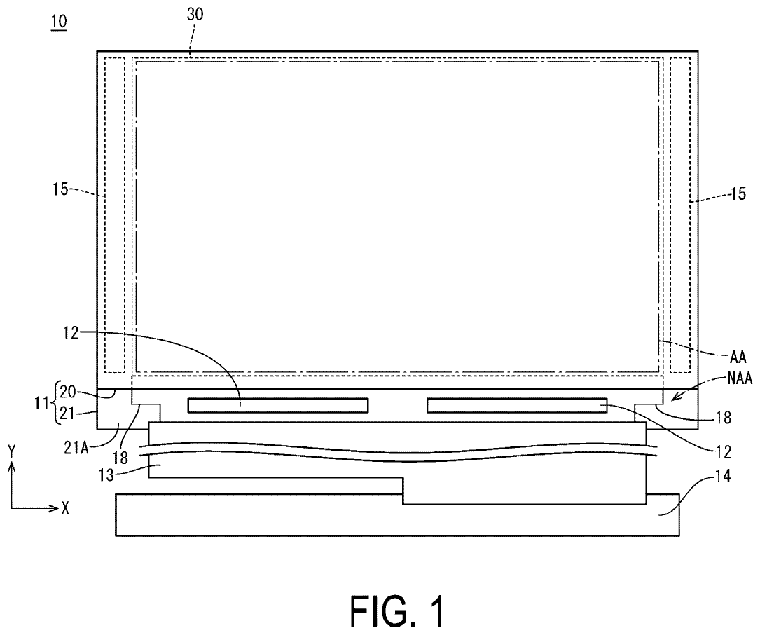

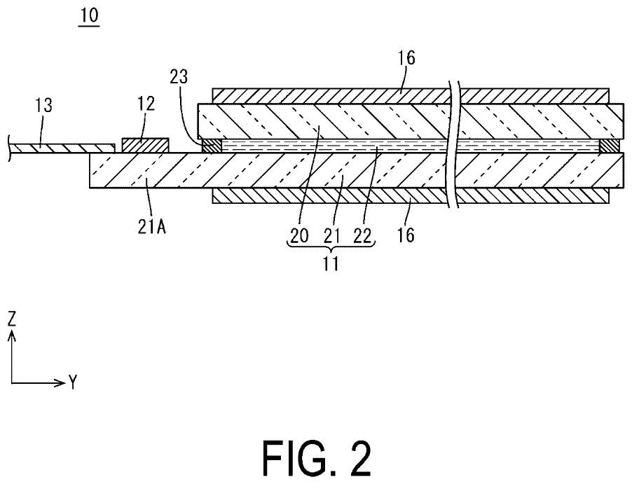

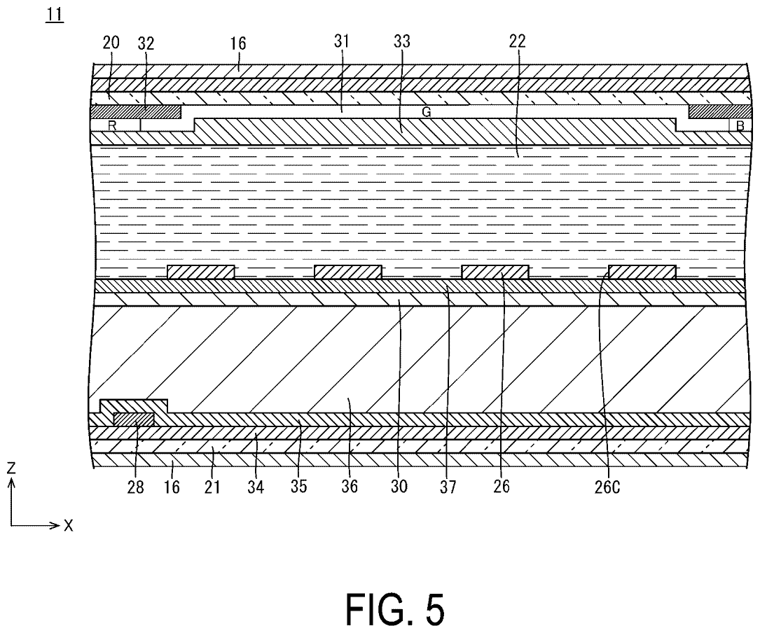

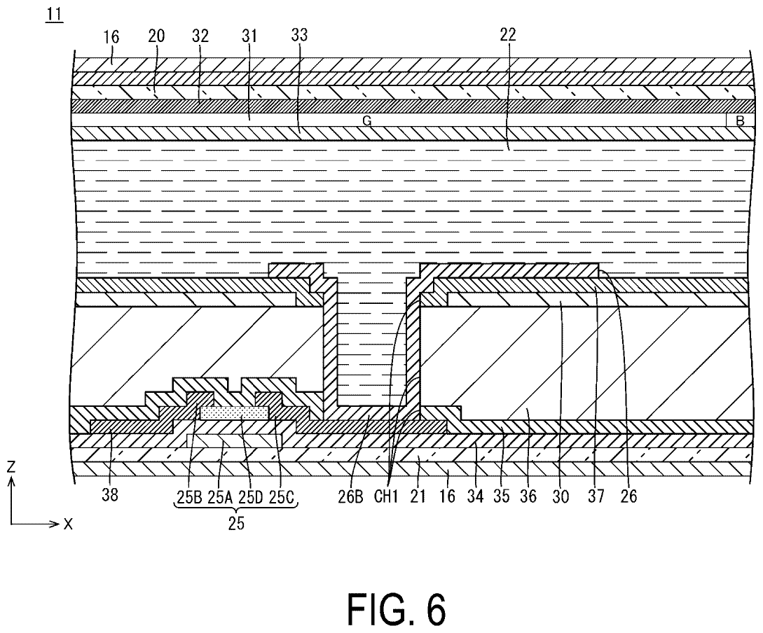

The first embodiment will be described with reference to FIGS. 1 to 9. In the present embodiment, a liquid crystal display device (a display device) 10 is described. Note that some drawings illustrate an X-axis, a Y-axis, and a Z-axis, and directions of these axes are drawn so as to be common in all the drawings. In FIG. 2, FIG. 5, and FIG. 6, an upper side is defined as a front side, and a lower side is defined as a rear side.

The liquid crystal display device 10, as illustrated in FIG. 1, includes at least a liquid crystal panel (display panel) 11, which has a horizontally elongated rectangular shape and is capable of displaying an image, and a backlight device (illumination device) that irradiates the liquid crystal panel 11 with light for use in display. The backlight device includes a light source (for example, an LED or the like) disposed on a rear side (back face side) of the liquid crystal panel 11 and configured to emit light having a white color, an optical member configured to impart an optical effect on the light from the light source, thereby converting the light into planar light, and the like. A center-side portion of a main surface of the liquid crystal panel 11 is a display region AA in which an image is displayed. In contrast, an outer peripheral portion having a frame-like shape (frame-shaped) surrounding the display region AA of the main surface of the liquid crystal panel 11 is defined as a non-display region NAA in which no image is displayed.

The liquid crystal panel 11 will be described with reference to FIG. 2 in addition to FIG. 1. As illustrated in FIGS. 1 and 2, the liquid crystal panel 11 is formed by bonding a pair of substrates 20 and 21 together. Of the pair of substrates 20, 21, the substrate on a front side is a counter substrate 20, and the substrate on a rear side is an array substrate 21. The counter substrate 20 and the array substrate 21 are each formed by layering various films on an inner face side of a glass substrate. A liquid crystal layer 22 is interposed between the pair of substrates 20, 21 and contains liquid crystal molecules, which are substances having optical characteristics that change in accordance with application of an electric field. A sealing portion 23 that seals the liquid crystal layer 22 is provided to be interposed between outer peripheral ends of the pair of substrates 20 and 21. The sealing portion 23 is formed in a rectangular frame-like shape to surround the liquid crystal layer 22. Note that polarizers 16 are bonded to the outer face sides of both the substrates 20 and 21, respectively.

As illustrated in FIG. 1 and FIG. 2, the counter substrate 20 has a short side dimension shorter than a short side dimension of the array substrate 21. The counter substrate 20 is bonded to the array substrate 21 with one end in a short side direction (Y-axis direction) aligned with the array substrate 21. Thus, the other end of the array substrate 21 in the short side direction is an exposed portion 21A that protrudes laterally relative to the counter substrate 20 and is exposed. The exposed portion 21A is entirely the non-display region NAA, and a driver (signal supply unit) 12 for supplying various signals and the flexible substrate 13 are mounted thereon.

As illustrated in FIGS. 1 and 2, the driver 12 is mounted on the exposed portion 21A of the array substrate 21 by Chip On Glass (COG). The driver 12 includes an LSI chip having a drive circuit therein. The driver 12 processes various signals transmitted by the flexible substrate 13, and supplies, for example, an image signal to source wiring lines 28 described below. The driver 12 is arranged adjacent to one side of the display region AA in the Y-axis direction in the exposed portion 21A and is disposed interposed between the flexible substrate 13 to be described below and the display region AA. The driver 12 is arranged in the exposed portion 21A at two positions spaced apart in an X-axis direction. The driver 12 has a horizontally elongated rectangular planar shape. The driver 12 has a long side dimension smaller than a long side dimension of the display region AA.

The flexible substrate 13 has a configuration in which a large number of wiring line patterns are formed on a base material made of a synthetic resin material (for example, a polyimide resin or the like) having insulating properties and flexibility. As illustrated in FIG. 1 and FIG. 2, one end side of the flexible substrate 13 is connected to the exposed portion 21A of the array substrate 21, and the other end side thereof is connected to a control substrate 14. The flexible substrate 13 is connected to an end portion of the exposed portion 21A on a side opposite to the display region AA side in the Y-axis direction with respect to the driver 12. That is, the flexible substrate 13 is attached to the exposed portion 21A at a position where the driver 12 is interposed between the flexible substrate 13 and the display region AA. The control substrate 14 is configured such that a plurality of circuit components are mounted on a rigid substrate made of a synthetic resin (for example, paper phenol, a glass epoxy resin, or the like). The plurality of circuit components include a power Integrated Circuit (IC) for outputting electric power, a timing controller that generates various signals to be supplied to the driver 12, a level shifter IC for controlling (step-down/step-up) voltage levels, and the like. The control substrate 14 includes a connector portion to which the flexible substrate 13 and the like are connected. The control substrate 14 is arranged so as to overlap the backlight device on a rear side by bending the flexible substrate 13 in a folded shape. The control substrate 14 supplies various signals to the driver 12 and also supplies a control signal (switch signal) to control wiring lines 29 described below. The control signal is a signal that periodically becomes a potential higher than a threshold voltage of a control TFT 24 described below.

As illustrated in FIG. 1, gate drive circuits 15 are provided in the non-display region NAA of the array substrate 21. A pair of gate drive circuits 15 is provided to sandwich the display region AA from both sides thereof in the X-axis direction. The gate drive circuits 15 are each provided in a vertically elongate belt-shaped range extending along the short side direction (Y-axis direction) of the array substrate 21. The gate drive circuits 15 are circuits for supplying scanning signals to gate wiring lines 27 to be described below and are provided monolithically on the array substrate 21. The scanning signal is set to have a potential higher than a threshold voltage of a pixel TFT 25 to be described below.

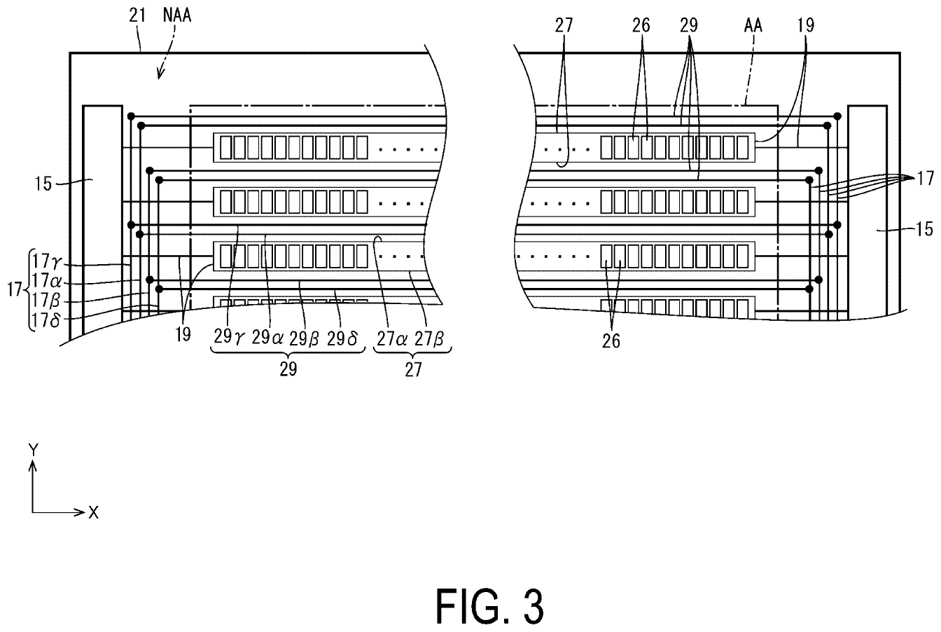

In the non-display region NAA of the array substrate 21, as illustrated in FIG. 3, control trunk wiring lines 17 are provided. Most of the control trunk wiring lines 17 are arranged in a region opened between the gate drive circuits 15 and the display region AA in the X-axis direction, and extend substantially along the Y-axis direction. The control trunk wiring lines 17 are arranged in sets of four with the display region AA interposed in the X-axis direction. The four control trunk wiring lines 17 arranged between the gate drive circuits 15 and the display region AA are arranged at positions spaced apart from each other in the X-axis direction. The control trunk wiring lines 17 each have one end led out to the exposed portion 21A of the array substrate 21 and connected to a terminal portion arranged in the mounting region of the flexible substrate 13, and the control trunk wiring lines 17 receive control signals supplied from the flexible substrate 13 via the terminal portion. Further, the array substrate 21 is provided with a common electrode 30 arranged over an entire region of at least the display region AA, and a common wiring line 18 connected to the common electrode 30. The common electrode 30 includes a central portion arranged over an entire region of the display region AA, and an outer peripheral end constituting a frame-like shape is arranged in the non-display region NAA. The common wiring line 18 is arranged in the non-display region NAA of the array substrate 21, and one end of the common wiring line 18 is connected to the outer peripheral end of the common electrode 30 being located in the non-display region NAA. The other end of the common wiring line 18 is connected to a terminal portion arranged in the mounting region of the flexible substrate 13, and the common wiring line 18 receives a common potential signal supplied from the flexible substrate 13 via the terminal portion.

In the display region AA of the array substrate 21, as illustrated in FIG. 3, a plurality of pixel electrodes 26 are arranged in a matrix shape in the X-axis direction and the Y-axis direction. The plurality of pixel electrodes 26 arranged along the X-axis direction constitute one pixel electrode row, and the plurality of pixel electrodes 26 arranged along the Y-axis direction constitute one pixel electrode column. In the display region AA of the array substrate 21, the plurality of gate wiring lines 27 are provided. The gate wiring lines 27 extend along the X-axis direction (first direction), and the plurality of gate wiring lines 27 are arranged side by side at positions spaced apart in the Y-axis direction (second direction). In more detail, the gate wiring lines 27 are arranged in pairs at positions with the pixel electrodes 26 interposed in the Y-axis direction, and the number of the gate wiring lines 27 is made to be approximately twice the number of the pixel electrodes 26 (the number of the pixel electrodes 26 constituting the pixel electrode column) arranged in the Y-axis direction. The gate wiring lines 27 extend across the display region AA along the X-axis direction, and both ends are led out to the non-display region NAA. At the end of the gate wiring lines 27 led out to the non-display region NAA, connection wiring lines 19 are connected. The connection wiring lines 19 are arranged in a region opened between the gate drive circuits 15 and the display region AA in the X-axis direction, and include a portion extending along the Y-axis direction and a portion extending along the X-axis direction. Of the connection wiring lines 19, portions extending along the Y-axis direction are connected to two gate wiring lines 27 with the pixel electrodes 26 interposed in the Y-axis direction. Of the connection wiring lines 19, portions extending along the X-axis direction extend from the portion extending along the Y-axis direction toward the gate drive circuits 15 and are connected to the gate drive circuits 15. The connection wiring lines 19 are supplied with scanning signals from the gate drive circuits 15. The scanning signals supplied to the connection wiring lines 19 are distributed to the two gate wiring lines 27 connected to the connection wiring lines 19. That is, the two gate wiring lines 27 with the pixel electrodes 26 interposed in the Y-axis direction are short-circuited by the connection wiring lines 19 and are set to the same potential.

In the display region AA of the array substrate 21, as illustrated in FIG. 3, the plurality of control wiring lines 29 are provided. The control wiring lines 29 extend along the X-axis direction, and the plurality of control wiring lines 29 are arranged with a space from the pixel electrodes 26 and the gate wiring lines 27 in the Y-axis direction. In more detail, the control wiring lines 29 are arranged two by two between the pixel electrodes 26 arranged along the Y-axis direction, and with respect to each of the pixel electrode 26 located at the uppermost position in the Y-axis direction, and the pixel electrode 26 located at the lowermost position in the Y-axis direction, the control wiring lines 29 are arranged two by two above and below in FIG. 3, and the number of the control wiring lines 29 installed is two greater than the number of the gate wiring lines 27 installed. The control wiring lines 29 are arranged at positions farther from the pixel electrodes 26 than the gate wiring lines 27 in the Y-axis direction. For example, two control wiring lines 29 sandwiched between two pixel electrode rows are sandwiched between two gate wiring lines 27. The control wiring lines 29 extend across the display region AA along the X-axis direction, and both ends thereof are led out to the non-display region NAA. At the ends of the control wiring lines 29 that are led out to the non-display region NAA, the control trunk wiring lines 17 are connected. In the present embodiment, the two control trunk wiring lines 17 which are in a relationship to interpose the display region AA in the X-axis direction are connected to both ends of the control wiring lines 29. The plurality of control wiring lines 29 are connected to one control trunk wiring line 17. The number of control wiring lines 29 connected to one control trunk wiring line 17 coincides with the number obtained by dividing the total number of the control wiring lines 29 by the number of the control trunk wiring lines 17 installed (four).

In the following, in a case in which the four control trunk wiring lines 17 that are arranged between the gate drive circuit 15 and the display region AA in the X-axis direction are distinguished, the control trunk wiring line 17 that is third closest to the display region AA (second closest to the gate drive circuit 15) is referred to as a “first control trunk wiring line” and a suffix “α” is attached to the reference numeral, the control trunk wiring line 17 that is second closest to the display region AA (third closest to the gate drive circuit 15) is referred to as a “second control trunk wiring line” and a suffix “β” is attached to the reference numeral, the control trunk wiring line 17 that is farthest from the display region AA (closest to the gate drive circuit 15) is referred to as a “third control trunk wiring line” and a suffix “γ” is attached to the reference numeral, and the control trunk wiring line 17 that is closest to the display region AA (farthest from the gate drive circuit 15) is referred to as a “fourth control trunk wiring line” and a suffix “δ” is attached to the reference numeral, and in a case in which the control trunk wiring lines 17 are collectively referred to without distinction, no suffixes “α to δ” are attached to the reference numerals.

In the following, of the plurality of control wiring lines 29, the control wiring line 29 that is connected to the first control trunk wiring line 17α is referred to as a “first control wiring line” and a suffix “α” is attached to the reference numeral, the control wiring line 29 that is connected to the second control trunk wiring line 17β is referred to as a “second control wiring line” and a suffix “β” is attached to the reference numeral, the control wiring line 29 that is connected to the third control trunk wiring line 17γ is referred to as a “third control wiring line” and a suffix “γ” is attached to the reference numeral, and the control wiring line 29 that is connected to the fourth control trunk wiring line 17δ is referred to as a “fourth control wiring line” and a suffix “δ” is attached to the reference numeral, and in a case in which the control wiring lines 29 are collectively referred to without distinction, no suffixes “α to δ” are attached to the reference numerals.

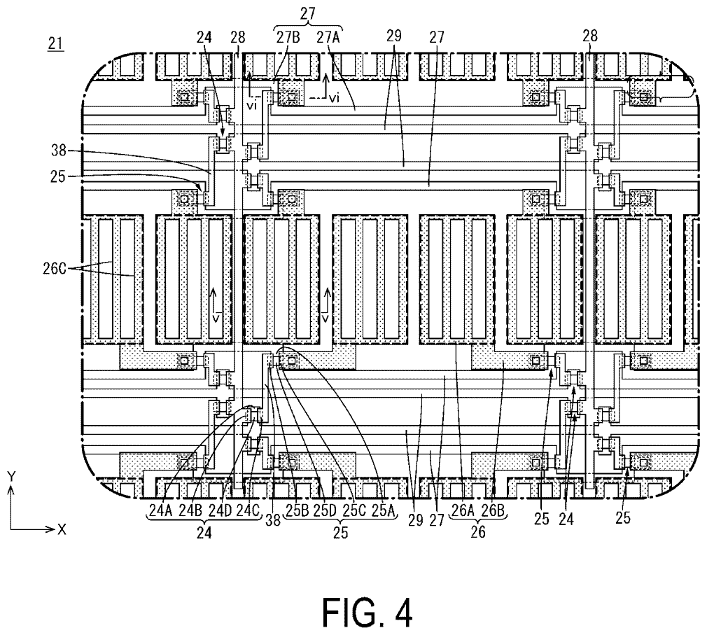

In the display region AA of the array substrate 21, as illustrated in FIG. 4, the control TFTs 24, the pixel TFTs 25, and the source wiring lines 28 are provided. The source wiring lines 28 extend along the Y-axis direction (second direction) in the display region AA and are set in a relationship to intersect with the gate wiring lines 27 and the control wiring lines 29. The plurality of source wiring lines 28 are arranged with spaces in the X-axis direction. The source wiring lines 28 extend along the Y-axis direction in a manner traversing the display region AA, and ends of the source wiring lines 28 are led out to the exposed portion 21A (the non-display region NAA). The lead-out portions of the source wiring lines 28 are connected to a terminal portion that is arranged in the mounting region of the driver 12, and the source wiring lines 28 are to receive an image signal supplied from the driver 12 via the terminal portions (see FIG. 1).

The control TFTs 24 are connected to the source wiring lines 28, the control wiring lines 29, and the pixel TFTs 25 as illustrated in FIG. 4. The control TFTs 24 are arranged at positions spaced apart from the pixel electrodes 26 in the Y-axis direction, and are arranged at positions adjacent to the source wiring lines 28 and the control wiring lines 29 to be connected. The control TFTs 24 are arranged farther from the pixel electrodes 26 and the gate wiring lines 27 (closer to the control wiring lines 29) in the Y-axis direction than the pixel TFTs 25 to be described below. The control TFTs 24 are driven based on the control signal supplied to the control wiring lines 29, and accordingly, the image signal supplied to the source wiring lines 28 can be supplied to the pixel TFTs 25.

As illustrated in FIG. 4, the pixel TFTs 25 are connected to the control TFTs 24, the pixel electrodes 26, and the gate wiring lines 27. The pixel TFTs 25 are arranged at positions spaced apart from the pixel electrodes 26 in the Y-axis direction, and are arranged at positions adjacent to the pixel electrodes 26 and the gate wiring lines 27 to be connected. The pixel TFTs 25 are arranged closer to the pixel electrodes 26 and the gate wiring lines 27 (farther from the control wiring lines 29) in the Y-axis direction than the control TFTs 24. The gate wiring lines 27 include wiring line main bodies 27A that extend along the X-axis direction, and bent portions 27B that are bent from the wiring line main bodies 27A. The bent portions 27B are bent from the wiring line main bodies 27A so as to approach the pixel TFTs 25 to be connected, and include portions close to the pixel electrodes 26 to which the pixel TFTs 25 are connected. The pixel TFTs 25 are driven based on the scanning signal supplied to the gate wiring lines 27, and accordingly, the image signal supplied from the control TFTs 24 can be supplied to the pixel electrodes 26. In more detail, as will be described below, by controlling driving of the control TFTs 24 and the pixel TFTs 25 at appropriate timings, the image signal supplied to one source wiring line 28 can be distributed to the plurality of pixel electrodes 26.

As illustrated in FIG. 4, the pixel electrodes 26 include elongated main bodies 26A and connection portions 26B that are connected to the main bodies 26A and the pixel TFTs 25. The main bodies 26A are interposed between the two gate wiring lines 27 in the Y-axis direction. The plurality of main bodies 26A are arranged side by side with spaces along the X-axis direction. The plurality of main bodies 26A are arranged side by side with spaces along the Y-axis direction, and the spaces are wider than the spaces in the X-axis direction. In the main bodies 26A, a plurality of slits 26C (three in FIG. 4) extending along a longitudinal direction of the main bodies 26A are respectively formed. Note that the specific number of the slits 26C installed, shapes of the slits 26C, formation ranges of the slits 26C, and the like can be appropriately changed in addition to those illustrated in the drawings. The connection portions 26B extend from the main bodies 26A to be connected to the pixel TFTs 25 (pixel drain electrodes 25C described below) to be connected. The planar shape (length or the like) of the connection portions 26B differs depending on the relative positional relationship between the main bodies 26A to be connected and the pixel TFTs 25 to be connected.

A cross-sectional configuration of the pixel electrodes 26 in the liquid crystal panel 11 will be described with reference to FIG. 5. FIG. 5 is a schematic cross-sectional view taken along line v-v in FIG. 4. On the inner face side in the display region AA of the array substrate 21, as illustrated in FIG. 5, the common electrode 30 is formed on a lower-layer side than the pixel electrodes 26 in such a manner as to overlap all the pixel electrodes 26. The common electrode 30 is supplied with a common potential signal (reference potential signal) of a common potential (reference potential) from the control substrate 14 via the flexible substrate 13 and the common wiring line 18, and extends in a planar shape over substantially an entire region of the display region AA. When a potential difference occurs between the pixel electrodes 26 and the common electrode 30 overlapping each other as the pixel electrodes 26 are charged, a fringe electric field (oblique electric field) including, in addition to a component along a main surface of the array substrate 21, a component in a normal direction with respect to the main surface of the array substrate 21 occurs between edges of the slits 26C in the pixel electrodes 26 and the common electrode 30. Accordingly, by using this fringe electric field, it is possible to control the alignment state of the liquid crystal molecules included in the liquid crystal layer 22. That is, an operation mode of the liquid crystal panel 11 according to this embodiment is a Fringe Field Switching (FFS) mode.

In the display region AA of the counter substrate 20 constituting the liquid crystal panel 11, as illustrated in FIG. 5, a large number of color filters 31 are provided at positions overlapping the respective pixel electrodes 26 included in the array substrate 21. The color filters 31 are arranged in an array in which three colors of red (R), green (G), and blue (B) are alternately repeated along the X-axis direction. Each of the three color filters 31 extends along the Y-axis direction (second direction), and the color filters 31 as a whole are arrayed in a generally stripe pattern. In more detail, each of the three color filters 31 extends generally along the Y-axis direction so as to be parallel to the source wiring lines 28. The color filters 31 are in an opposing state with the main bodies 26A of the pixel electrodes 26 on the array substrate 21 side. The color filters 31 and the pixel electrodes 26 that oppose each other constitute pixels as display units. Note that in a case in which the source wiring lines 28 include inclined portions in a plan view and repeatedly bends in a zig-zag shape to extend along the Y-axis direction (second direction), each of the three color filters 31 extends generally along the Y-axis direction so as to be parallel to the inclined portions of the source wiring lines 28.

As illustrated in FIG. 5, in the display region AA of the counter substrate 20, light blocking portions (black matrices) 32 is provided between color filters 31 (pixel electrodes 26) that are adjacent to each other (boundary) in the X-axis direction and the Y-axis direction. The light blocking portions 32 are provided not only in the display region AA but also in the non-display region NAA. In the display region AA, the light blocking portions 32 form a lattice pattern so as to overlap with each of the TFTs 24 and 25, the gate wiring lines 27, the source wiring lines 28, the control wiring lines 29, and the like, and in the non-display region NAA, the light blocking portion 32 generally forms a solid-like pattern. An overcoat film 33 is formed on an upper-layer side of the color filter 31 and the light blocking portion 32. The overcoat film 33 is provided in a solid-like pattern over substantially the entire region of the counter substrate 20. The overcoat film 33 is made of an organic material such as an acrylic resin (for example, PMMA, and the like), and functions to flatten a step generated on a lower-layer side (the side opposite to the liquid crystal layer 22) than the overcoat film 33. Note that, on the upper-layer side of the overcoat film 33 (the innermost face of the counter substrate 20), a first alignment film (not illustrated) for aligning the liquid crystal molecules contained in the liquid crystal layer 22 is provided. The first alignment film is made of, for example, polyimide.

Here, various films layered on an inner face side of the array substrate 21 will be described with reference to FIG. 6. FIG. 6 is a schematic cross-sectional view taken along line vi-vi in FIG. 4. As illustrated in FIG. 6, on the array substrate 21, from a lower-layer side, a first metal film, a gate insulating film 34, a semiconductor film, a second metal film, a first interlayer insulating film 35, a flattening film 36, a first transparent electrode film, a second interlayer insulating film 37, a second transparent electrode film, and a second alignment film (not illustrated) are layered in this order. The first metal film and the second metal film have conductivity and light blocking properties by being formed as a single-layer film made of one kind of metal material selected from copper, titanium, aluminum, molybdenum, and tungsten, or as a layered film made of different kinds of metal materials, or as an alloy. The first metal film constitutes the connection wiring lines 19, the gate wiring lines 27, the control wiring lines 29, and the like. The second metal film constitutes the control trunk wiring lines 17, the source wiring lines 28, and the like. The semiconductor film is formed of a thin film using, for example, an oxide semiconductor as a material, and constitutes parts of the respective TFTs 24 and 25. The first transparent electrode film and the second transparent electrode film are composed of a transparent electrode material (for example, Indium Tin Oxide (ITO) or Indium Zinc Oxide (IZO)). The first transparent electrode film constitutes the common electrode 30, and the like. The second transparent electrode film constitutes the pixel electrodes 26, and the like. The second alignment film, similarly to the first alignment film, is made of, for example, polyimide or the like, and can align the liquid crystal molecules contained in the liquid crystal layer 22.

The gate insulating film 34, the first interlayer insulating film 35, and the second interlayer insulating film 37 are each made of an inorganic material such as silicon nitride (SiNₓ) or silicon oxide (SiO₂). The flattening film 36 is made of, for example, an organic material such as PMMA (acrylic resin). The flattening film 36 has a film thickness of, for example, approximately 1 μm to 3 μm, which is much larger than the film thicknesses of the gate insulating film 34, the first interlayer insulating film 35, and the second interlayer insulating film 37. This flattening film 36 flattens an inner face of the array substrate 21 (surface on the liquid crystal layer 22 side). The gate insulating film 34 maintains an insulated state between the first metal film on the lower-layer side and the semiconductor film and the second metal film on the upper-layer side. For example, the intersection points of the gate wiring lines 27 and the control wiring lines 29 formed of the first metal film, and the source wiring lines 28 formed of the second metal film, are maintained in an insulated state by the gate insulating film 34. The first interlayer insulating film 35 and the flattening film 36 maintain an insulated state between the semiconductor film and the second metal film on the lower-layer side and the first transparent electrode film on the upper-layer side. For example, the source wiring lines 28 formed of the second metal film and the common electrode 30 formed of the first transparent electrode film are maintained in an insulated state by the first interlayer insulating film 35 and the flattening film 36. The second interlayer insulating film 37 maintains an insulated state between the first transparent electrode film on the lower-layer side and the second transparent electrode film on the upper-layer side. For example, the common electrode 30 formed of the first transparent electrode film and the pixel electrodes 26 formed of the second transparent electrode film are maintained in an insulated state by the second interlayer insulating film 37.

A configuration of the respective TFTs 24 and 25 will be described. The pixel TFT 25, as illustrated in FIGS. 4 and 6, includes a pixel gate electrode 25A, a pixel source electrode 25B, the pixel drain electrode 25C, and a pixel semiconductor portion 25D. The pixel gate electrode 25A is formed of a part of the first metal film. The pixel gate electrode 25A is formed of a part of a bent portion 27B in the gate wiring line 27. The scanning signal transmitted by the gate wiring line 27 is supplied to the pixel gate electrode 25A. The pixel source electrode 25B is formed of a part of the second metal film. The pixel source electrode 25B forms an island shape, a part of which overlaps the pixel gate electrode 25A and is connected to the pixel semiconductor portion 25D described below. The pixel drain electrode 25C is formed of a part of the second metal film. The pixel drain electrode 25C is arranged at a position spaced apart from the pixel source electrode 25B in the X-axis direction. The pixel drain electrode 25C extends along the X-axis direction, and one end thereof overlaps the pixel gate electrode 25A and is connected to the pixel semiconductor portion 25D described below. The pixel drain electrode 25C is arranged such that the other end overlaps the connection portion 26B in the pixel electrode 26. Of the first interlayer insulating film 35, the flattening film 36, and the second interlayer insulating film 37 interposed between the pixel drain electrode 25C and the connection portion 26B, a pixel contact hole CH1 is opened at a position overlapping both the pixel drain electrode 25C and the connection portion 26B. The pixel drain electrode 25C and the connection portion 26B overlapping each other are connected through the pixel contact hole CH1.

The pixel semiconductor portion 25D, as illustrated in FIGS. 4 and 6, is formed of a part of the semiconductor film. The pixel semiconductor portion 25D is arranged to overlap on an upper-layer side with the gate insulating film 34 interposed between the pixel semiconductor portion 25D and the pixel gate electrode 25A formed of a part of the first metal film. The pixel semiconductor portion 25D is maintained in an insulated state from the pixel gate electrode 25A overlapping the pixel semiconductor portion 25D by the gate insulating film 34. The pixel semiconductor portion 25D extends along the X-axis direction, one end thereof being connected in a manner directly overlapping the pixel source electrode 25B, and the other end being connected in a manner directly overlapping the pixel drain electrode 25C. When a potential higher than a threshold voltage of the pixel TFT 25 is supplied as the scanning signal from the gate wiring line 27 to the pixel gate electrode 25A, a channel region is generated in the pixel semiconductor portion 25D, so that charge can move between the pixel source electrode 25B and the pixel drain electrode 25C via this channel region.

The control TFT 24, as illustrated in FIG. 4, includes a control gate electrode 24A, a control source electrode 24B, a control drain electrode 24C, and a control semiconductor portion 24D. Note that, since the cross-sectional configuration of the control TFT 24 is similar to the cross-sectional configuration of the pixel TFT 25 illustrated in FIG. 6, and therefore FIG. 6 will be appropriately utilized in the following description. The control gate electrode 24A is formed of a part of the first metal film. The control gate electrode 24A is formed of a portion in which the control wiring line 29 extending along the X-axis direction is partially widened. In more detail, the control gate electrode 24A is formed by a portion of the control wiring line 29 that protrudes along the Y-axis direction to an upper side or a lower side of FIG. 4 from a portion adjacent to a portion intersecting with the source wiring line 28. The control signal transmitted by the control wiring line 29 is supplied to the control gate electrode 24A.

The control source electrode 24B is formed of a part of the second metal film. As illustrated in FIG. 4, the control source electrode 24B is formed of a portion in which the source wiring line 28 extending along the Y-axis direction is partially widened. In more detail, the control source electrode 24B is formed by a portion of the source wiring line 28 that protrudes along the X-axis direction to a left side or a right side in FIG. 4 from a portion adjacent to a portion intersecting with the control wiring line 29. Of the control source electrode 24B, a tip portion protruding from the source wiring line 28 overlaps the control gate electrode 24A and is connected to the control semiconductor portion 24D to be described below. The control drain electrode 24C is formed of a part of the second metal film. The control drain electrode 24C is arranged at a position spaced apart from the control source electrode 24B in the X-axis direction. The control drain electrode 24C forms an island shape, a part of which overlaps the control gate electrode 24A and is connected to the control semiconductor portion 24D to be described below. The control drain electrode 24C is connected to the pixel source electrode 25B via an electrode connection portion 38. The electrode connection portion 38, similarly to the control drain electrode 24C and the pixel source electrode 25B, is formed of a part of the second metal film. The electrode connection portion 38 extends along the Y-axis direction, one end of which is continuous with the pixel source electrode 25B, and the other end of which is continuous with the control drain electrode 24C. A length dimension of the electrode connection portion 38 varies depending on a relative positional relationship between the control drain electrode 24C and the pixel source electrode 25B to be connected.

The control semiconductor portion 24D is formed of a part of the semiconductor film. As illustrated in FIG. 4, the control semiconductor portion 24D is arranged to overlap on an upper-layer side of the control gate electrode 24A formed of a part of the first metal film with the gate insulating film 34 interposed (see FIG. 6). The control semiconductor portion 24D is maintained in an insulated state from the control gate electrode 24A overlapping the control semiconductor portion 24D by the gate insulating film 34. The control semiconductor portion 24D extends along the X-axis direction, one end thereof being connected in a manner directly overlapping the control source electrode 24B, and the other end being connected in a manner directly overlapping the control drain electrode 24C (see FIG. 6). When a potential higher than a threshold voltage of the control TFT 24 is supplied as a control signal from the control wiring line 29 to the control gate electrode 24A, a channel region is generated in the control semiconductor portion 24D, so that charge can move between the control source electrode 24B and the control drain electrode 24C via this channel region.

In the present embodiment, as illustrated in FIG. 3, a high-level potential (hereinafter, referred to as a high potential) relating to a scanning signal output from the gate drive circuit 15 is supplied via the connection wiring line 19 at the same timing to the two gate wiring lines 27 interposing the pixel electrode 26 in the Y-axis direction. In contrast, to the two control wiring lines 29 interposing the pixel electrode 26 in the Y-axis direction (a total of four control wiring lines 29), high potentials relating to control signals are supplied in synchronization with scanning signals supplied to the two gate wiring lines 27 interposing the pixel electrode 26 in the Y-axis direction and at timings different from each other. The image signal is supplied to the source wiring line 28 in synchronization with timings at which high potentials relating to control signals are supplied to the four control wiring lines 29. Accordingly, the image signal supplied to one source wiring line 28 is distributed to the four pixel electrodes 26 via four control TFTs 24 and four pixel TFTs 25 at timings at which high potentials relating to control signals are supplied to each of the four control wiring lines 29. That is, the image signal supplied to one source wiring line 28 can be distributed to each pixel electrode 26 constituting the four pixel electrode columns. As a result, the number of source wiring lines 28 installed can be reduced to approximately one-fourth of the number of pixel electrodes 26 constituting the pixel electrode row. The reduction in the number of source wiring lines 28 installed is preferable for reducing the number of drivers 12 installed. Further, since the space required for routing the source wiring lines 28 in the non-display region NAA is reduced, the frame of the liquid crystal panel 11 can be narrowed. Further, compared with a case in which a Source Shared Driving (SSD) circuit is provided in a region of the non-display region NAA between the display region AA and the driver 12, the frame of the liquid crystal panel 11 can be narrowed. Note that, in the present embodiment, the four pixel electrodes 26 are interposed between the two source wiring lines 28 adjacent to each other with a space in the X-axis direction.

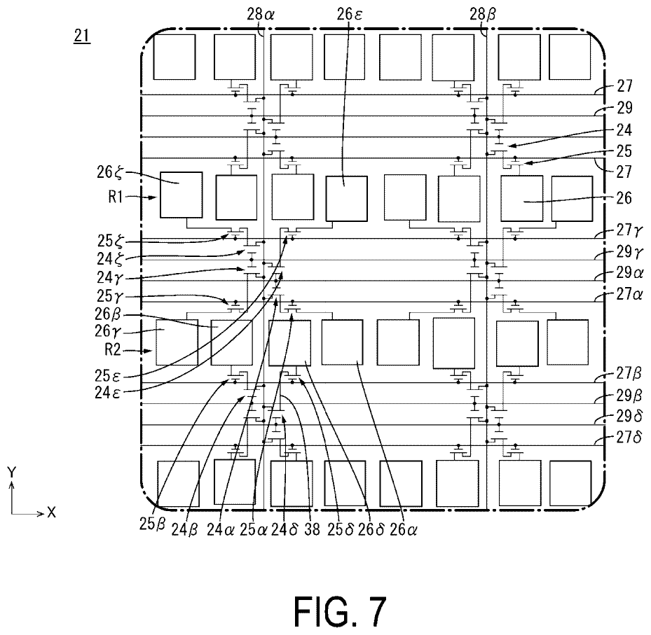

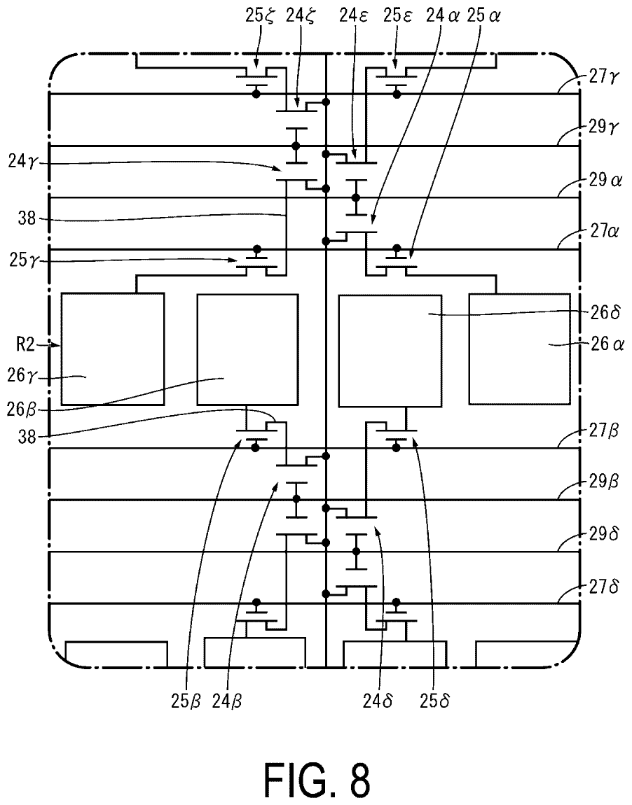

Next, the arrangement and connection relationship in the control TFT 24, the pixel TFT 25, the gate wiring line 27, and the control wiring line 29 will be described in detail with reference to FIGS. 7 and 8. In the following description, a second pixel electrode row from the top in FIG. 7 is referred to as a “first pixel electrode row R1”, and a third pixel electrode row from the top in FIG. 7 is referred to as a “second pixel electrode row R2”.

In a case in which the plurality of gate wiring lines 27 are distinguished, the gate wiring line 27 adjacent to an upper side of the second pixel electrode row R2 in FIGS. 7 and 8 is referred to as a “first gate wiring line (first scanning wiring line)” with a suffix “α” attached to the reference numeral, the gate wiring line 27 adjacent to a lower side of the second pixel electrode row R2 in FIGS. 7 and 8 is referred to as a “second gate wiring line (second scanning wiring line)” with a suffix “β” attached to the reference numeral, and the gate wiring line 27 adjacent to a lower side of the first pixel electrode row R1 in FIGS. 7 and 8 is referred to as a “third gate wiring line (third scanning wiring line)” with a suffix “γ” attached to the reference numeral. In a case in which the gate wiring lines 27 are collectively referred to without distinction, no suffixes “α to γ” are attached to the reference numerals.

In a case in which the plurality of control TFTs 24 are distinguished, the control TFT 24 connected to a first control wiring line 29α and to the pixel TFT 25 (first pixel TFT 25α) to be connected to the pixel electrode 26 (first pixel electrode 26α) belonging to the second pixel electrode row R2 is referred to as a “first control TFT (first switching element)” with a suffix “α” attached to the reference numeral, the control TFT 24 connected to a second control wiring line 29β and to the pixel TFT 25 (second pixel TFT 25β) to be connected to the pixel electrode 26 (second pixel electrode 26β) belonging to the second pixel electrode row R2 is referred to as a “second control TFT (third switching element)” with a suffix “β” attached to the reference numeral, the control TFT 24 connected to a third control wiring line 29γ and to the pixel TFT 25 (third pixel TFT 25γ) to be connected to the pixel electrode 26 (third pixel electrode 26γ) belonging to the second pixel electrode row R2 is referred to as a “third control TFT (seventh switching element)” with a suffix “γ” attached to the reference numeral, the control TFT 24 connected to a fourth control wiring line 29δ and to the pixel TFT 25 (fourth pixel TFT 25δ) to be connected to the pixel electrode 26 (fourth pixel electrode 26δ) belonging to the second pixel electrode row R2 is referred to as a “fourth control TFT (ninth switching element)” with a suffix “δ” attached to the reference numeral, the control TFT 24 connected to the first control wiring line 29α and to the pixel TFT 25 (fifth pixel TFT 25ϵ) to be connected to the pixel electrode 26 (fifth pixel electrode 26ϵ) belonging to the first pixel electrode row R1 is referred to as a “fifth control TFT” with a suffix “ϵ” attached to the reference numeral, the control TFT 24 connected to the third control wiring line 29γ and to the pixel TFT 25 (sixth pixel TFT 25ζ) to be connected to the pixel electrode 26 (sixth pixel electrode 26ζ) belonging to the first pixel electrode row R1 is referred to as a “sixth control TFT” with a suffix “ζ” attached to the reference numeral, and in a case in which the control TFT 24 is collectively referred to without distinction, no suffixes “α to ζ” are attached to the reference numerals.

In a case in which the plurality of pixel TFTs 25 are distinguished, the pixel TFT 25 connected to a first control TFT 24α, a first gate wiring line 27α, and the pixel electrode 26 (first pixel electrode 26α) belonging to the second pixel electrode row R2 is referred to as a “first pixel TFT” with a suffix “α” attached to the reference numeral, the pixel TFT 25 connected to a second control TFT 24β, a second gate wiring line 27β, and the pixel electrode 26 (second pixel electrode 26β) belonging to the second pixel electrode row R2 is referred to as a “second pixel TFT” with a suffix “β” attached to the reference numeral, the pixel TFT 25 connected to a third control TFT 24γ, a third gate wiring line 27γ, and the pixel electrode 26 (third pixel electrode 26γ) belonging to the second pixel electrode row R2 is referred to as a “third pixel TFT” with a suffix “γ” attached to the reference numeral, the pixel TFT 25 connected to a fourth control TFT 24δ, a second gate wiring line 27β, and the pixel electrode 26 (fourth pixel electrode 26δ) belonging to the second pixel electrode row R2 is referred to as a “fourth pixel TFT” with a suffix “δ” attached to the reference numeral, the pixel TFT 25 connected to a fifth control TFT 24ϵ, a third gate wiring line 27γ, and the pixel electrode 26 (fifth pixel electrode 26ϵ) belonging to the first pixel electrode row R1 is referred to as a “fifth pixel TFT” with a suffix “ϵ” attached to the reference numeral, the pixel TFT 25 connected to a sixth control TFT 24ζ, a third gate wiring line 27γ, and the pixel electrode 26 (sixth pixel electrode 26ζ) belonging to the first pixel electrode row R1 is referred to as a “sixth pixel TFT” with a suffix “ζ” attached to the reference numeral, and in a case in which the pixel TFT 25 is collectively referred to without distinction, no suffixes “α to ζ” are attached to the reference numerals.

In a case in which the plurality of pixel electrodes 26 are distinguished, the pixel electrode 26 belonging to the second pixel electrode row R2 to be connected to the first pixel TFT 25α is referred to as the “first pixel electrode” with a suffix “α” attached to the reference numeral, the pixel electrode 26 belonging to the second pixel electrode row R2 to be connected to the second pixel TFT 25β is referred to as the “second pixel electrode” with a suffix “β” attached to the reference numeral, the pixel electrode 26 belonging to the second pixel electrode row R2 to be connected to the third pixel TFT 25γ is referred to as the “third pixel electrode (a fourth pixel electrode)” with a suffix “γ” attached to the reference numeral, the pixel electrode 26 belonging to the second pixel electrode row R2 to be connected to the fourth pixel TFT 25δ is referred to as the “fourth pixel electrode (a fifth pixel electrode)” with a suffix “δ” attached to the reference numeral, the pixel electrode 26 belonging to the first pixel electrode row R1 to be connected to the fifth pixel TFT 25ϵ is referred to as the “fifth pixel electrode (a third pixel electrode)” with a suffix “ϵ” attached to the reference numeral, the pixel electrode 26 belonging to the first pixel electrode row R1 to be connected to the sixth pixel TFT 25ζ is referred to as the “sixth pixel electrode”, with a suffix “ζ” attached to the reference numeral, and in a case in which the pixel electrodes 26 is collectively referred to without distinction, no suffixes “α to ζ” are attached to the reference numerals.

When the plurality of source wiring lines 28 are distinguished, the source wiring line 28 arranged on the left side in FIG. 7 is referred to as a “first source wiring line (first signal wiring line)” with a suffix “α” attached to the reference numeral, and the source wiring line 28 arranged on the right side in FIG. 7 is referred to as a “second source wiring line” with a suffix “β” attached to the reference numeral, and in a case in which the source wiring line 28 is collectively referred to without distinction, no suffixes “α, β” are attached to the reference numerals.

In the present embodiment, the second gate wiring line 27β, as illustrated in FIG. 8, is arranged in such a manner that the second pixel electrode row R2 including at least the first pixel electrode 26α and the second pixel electrode 26β is interposed between the second gate wiring line 27β and the first gate wiring line 27α in the Y-axis direction. In addition, the first control wiring line 29α is arranged with a space from the first gate wiring line 27α without the second pixel electrode row R2 being interposed between the first control wiring line 29α and the first gate wiring line 27α, and the second control wiring line 29β is arranged with a space from the second gate wiring line 27β without the second pixel electrode row R2 being interposed between the second control wiring line 29β and the second gate wiring line 27β. In this manner, the first gate wiring line 27α and the first control wiring line 29α, and the second gate wiring line 27β and the second control wiring line 29β are dispersedly arranged so as to interpose the second pixel electrode row R2 in the Y-axis direction. Therefore, the parasitic capacitance can be reduced as compared with a case in which the first gate wiring line 27α, the first control wiring line 29α, the second gate wiring line 27β, and the second control wiring line 29β are collectively arranged on one side of the first pixel electrode 26α and the second pixel electrode 26β in the Y-axis direction. In addition, since the number of intersection points where each of the electrodes 24A to 24D and 25A to 25D of each of the TFTs 24α, 24β, 25α, and 25β intersect with each of the wiring lines 27α, 27β, 29α, and 29β can be reduced, parasitic capacitance can be reduced. Accordingly, dullness is less likely to occur in the scanning signals supplied to each of the gate wiring lines 27α and 27β and in the control signals supplied to each of the control wiring lines 29α and 29β, so that the operation of each of the TFTs 24α, 24β, 25α, and 25β can be stabilized, and the potential of each of the pixel electrodes 26α and 26β is less likely to fluctuate.

In the present embodiment, as illustrated in FIG. 8, the first gate wiring line 27α is arranged closer to the second pixel electrode row R2 including at least the first pixel electrode 26α and the second pixel electrode 26β than the first control wiring line 29α, and the second gate wiring line 27β is arranged closer to the second pixel electrode row R2 than the second control wiring line 29β. That is, the first gate wiring line 27α and the second gate wiring line 27β are arranged interposing the second pixel electrode row R2 without the first control wiring line 29α or the second control wiring line 29β being interposed, and the first control wiring line 29α and the second control wiring line 29β are arranged with the first gate wiring line 27α and the second gate wiring line 27β interposed while interposing the second pixel electrode row R2. In this manner, the pixel gate electrode 25A included in the first pixel TFT 25α can avoid intersecting with the first control wiring line 29α. Accordingly, since occurrence of parasitic capacitance between the pixel gate electrode 25A and the first control wiring line 29α can be avoided, the operation of the first pixel TFT 25α can be stabilized. Similarly, the pixel gate electrode 25A included in the second pixel TFT 25β can avoid intersecting with the second control wiring line 29β. Accordingly, since occurrence of parasitic capacitance between the pixel gate electrode 25A and the second control wiring line 29β can be avoided, the operation of the second pixel TFT 25β can be stabilized. Note that the electrode connection portion 38 that connects the control drain electrode 24C of the first control TFT 24α and the pixel source electrode 25B of the first pixel TFT 25α is set in a relationship to intersect with the first gate wiring line 27α. Further, the electrode connection portion 38 that connects the control drain electrode 24C of the second control TFT 24β and the pixel source electrode 25B of the second pixel TFT 25β is set in a relationship to intersect with the second gate wiring line 27β.

In the present embodiment, as illustrated in FIG. 8, the third control wiring line 29γ is arranged with a space from the first gate wiring line 27α and the first control wiring line 29α without the second pixel electrode row R2 including at least the first pixel electrode 26α, the second pixel electrode 26β, the third pixel electrode 26γ, and the fourth pixel electrode 26δ being interposed, and the fourth control wiring line 29δ is arranged with a space from the second gate wiring line 27β and the second control wiring line 29β without the second pixel electrode row R2 being interposed. In this manner, since the third control wiring line 29γ and the fourth control wiring line 29δ are dispersedly arranged interposing the second pixel electrode row R2 in the Y-axis direction, parasitic capacitance can be reduced as compared with a case in which the third control wiring line 29γ and the fourth control wiring line 29δ are collectively arranged on one side with respect to the second pixel electrode row R2 in the Y-axis direction. In addition, since the number of intersection points where each of the electrodes 24A to 24D and 25A to 25D of each of the TFTs 24α, 24β, 24γ, 24δ, 25α, 25β, 25γ, and 25δ intersect with each of the wiring lines 27α, 27β, 27γ, 29α, 29β, 29γ, and 29δ can be reduced, parasitic capacitance can be reduced.

In the present embodiment, as illustrated in FIG. 8, the third control wiring line 29γ is arranged with the first control wiring line 29α interposed between the third control wiring line 29γ and the first gate wiring line 27α in the Y-axis direction. That is, the third control wiring line 29γ is arranged farther from the second pixel electrode row R2 than the first control wiring line 29α in the Y-axis direction. The first gate wiring line 27α is arranged closer to the second pixel electrode row R2 than both the first control wiring line 29α and the third control wiring line 29γ. The fourth control wiring line 29δ is arranged with the second control wiring line 29β interposed between the fourth control wiring line 29δ and the second gate wiring line 27β in the Y-axis direction. That is, the fourth control wiring line 29δ is arranged farther from the second pixel electrode row R2 than the second control wiring line 29β in the Y-axis direction. The second gate wiring line 27β is arranged closer to the second pixel electrode row R2 than both the second control wiring line 29β and the fourth control wiring line 29δ. Note that the electrode connection portion 38 that connects the control drain electrode 24C of the third control TFT 24γ and the pixel source electrode 25B of the third pixel TFT 25γ is, as illustrated in FIG. 4, set in a relationship to intersect with the first gate wiring line 27α and the first control wiring line 29α. Further, the electrode connection portion 38 that connects the control drain electrode 24C of the fourth control TFT 24δ and the pixel source electrode 25B of the fourth pixel TFT 25δ is set in a relationship to intersect with the second gate wiring line 27β and the second control wiring line 29β.

In the present embodiment, as illustrated in FIG. 7, the fifth control TFT 24ϵ is connected to the first control wiring line 29α in addition to the first control TFT 24α. Further, the sixth control TFT 24ζ is connected to the third control wiring line 29γ in addition to the third control TFT 24γ. The fifth control TFT 24ϵ and the sixth control TFT 24ζ are respectively connected to the fifth pixel TFT 25ϵ and the sixth pixel TFT 25ζ. The fifth pixel TFT 25ϵ is connected to the third gate wiring line 27γ, the fifth control TFT 24ϵ, and the fifth pixel electrode 26ϵ included in the first pixel electrode row R1. The sixth pixel TFT 25ζ is connected to the third gate wiring line 27γ, the sixth control TFT 24ζ, and the sixth pixel electrode 26ζ included in the first pixel electrode row R1. In this manner, since the first control wiring line 29α and the third control wiring line 29γ have a function of controlling driving of the fifth control TFT 24ϵ and the sixth control TFT 24ζ in addition to a function of controlling driving of the first control TFT 24α and the third control TFT 24γ, as compared with a case in which another control wiring line is provided to control the fifth control TFT 24ϵ and the sixth control TFT 24ζ, a wiring space between the first pixel electrode row R1 and the second pixel electrode row R2 can be reduced, and accordingly, an aperture ratio can be improved. Note that the third gate wiring line 27γ is arranged closer to the first pixel electrode row R1 including at least the fifth pixel electrode 26ϵ and the sixth pixel electrode 26ζ than both the first control wiring line 29α and the third control wiring line 29γ in the Y-axis direction. Further, the third gate wiring line 27γ is short-circuited to the gate wiring line 27 (the gate wiring line 27 adjacent to the first pixel electrode row R1 on an upper side in FIG. 7), which is arranged interposing the first pixel electrode row R1 in the Y-axis direction, by the connection wiring line 19, and is set to the same potential as the gate wiring line 27 (see FIG. 3). Further, the electrode connection portion 38 that connects the control drain electrode 24C of the fifth control TFT 24ϵ and the pixel source electrode 25B of the fifth pixel TFT 25ϵ is set in a relationship to intersect with the third gate wiring line 27γ and the third control wiring line 29γ. Further, the electrode connection portion 38 that connects the control drain electrode 24C of the sixth control TFT 24ζ and the pixel source electrode 25B of the sixth pixel TFT 25ζ is set in a relationship to intersect with the third gate wiring line 27γ.

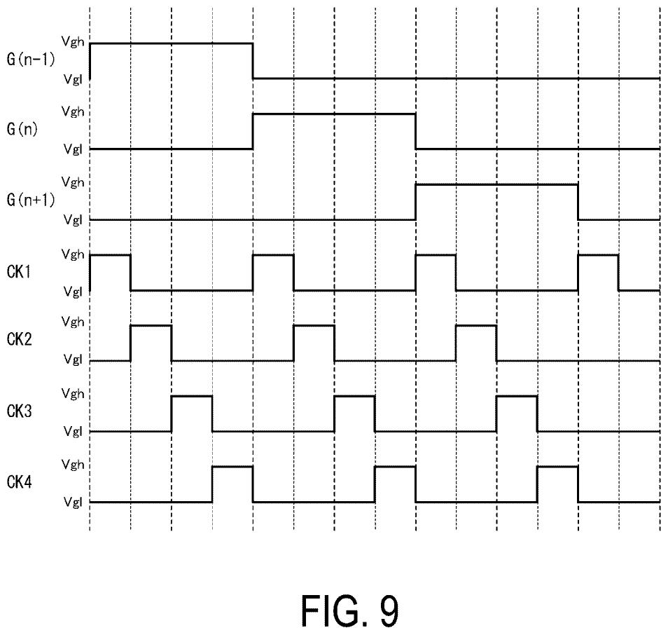

The present embodiment has the above-described structure, and the operation thereof will be described below mainly with reference to FIGS. 7 to 9. In FIG. 9, respective signal waveforms in the gate wiring lines 27 and the control wiring lines 29α to 29δ are illustrated. Specifically, in FIG. 9, illustrated from the top are scanning signals G(n−1), G(n), and G(n+1) transmitted by the gate wiring lines 27, a control signal CK1 transmitted by the second control wiring line 29β, a control signal CK2 transmitted by the fourth control wiring line 29δ, a control signal CK3 transmitted by the first control wiring line 29α, and a control signal CK4 transmitted by the third control wiring line 29γ. Of the scanning signals G(n−1), G(n), and G(n+1) illustrated in FIG. 9, the scanning signal G(n−1) is transmitted by the third gate wiring line 27γ, and the scanning signal G(n) is transmitted by the first gate wiring line 27α and the second gate wiring line 27β.

As illustrated in FIG. 9, high potentials of the scanning signals G(n−1), G(n), and G(n+1) are sequentially supplied from the gate drive circuit 15 to the plurality of connection wiring lines 19 from an upper stage side. In synchronization with supply of the scanning signals G(n−1), G(n), and G(n+1), the high potentials of the control signals CK1 to CK4 are supplied at different timings from the control substrate 14 to each of the control wiring lines 29α to 29δ, and image signals are supplied from the driver 12 to each of the source wiring lines 28 in synchronization with timings at which the control signals CK1 to CK4 are supplied to each of the control wiring lines 29α to 29δ. Here, the high potential is a potential higher than threshold voltages of the control TFTs 24 and the pixel TFTs 25. The scanning signals G(n−1), G(n), and G(n+1) and the control signals CK1 to CK4 are both generally rectangular waves, and are signal waveforms in which high potentials periodically and repeatedly appear. The period during which the control signals CK1 to CK4 are set to the high potential is about one fourth of the period during which the scanning signals G(n−1), G(n), and G(n+1) are set to the high potential, that is, the inverse of the total number of the control signals CK1 to CK4. The frequency of the control signals CK1 to CK4 coincides with a value obtained by multiplying a frame rate by a number of the scanning signals G(n−1), G(n), and G(n+1) (number of the connection wiring lines 19) output from the gate drive circuit 15 in one frame display period. The frequency of the scanning signals G(n−1), G(n), and G(n+1) coincides with the frame rate.

In more detail, as illustrated in FIG. 9, the timing at which the scanning signals G(n−1), G(n), and G(n+1) rise to the high potential coincides with the timing at which the control signal CK1 rises to the high potential. The timing at which the high potential of the control signal CK1 falls coincides with the timing at which the high potential of the control signal CK2 rises. The timing at which the high potential of the control signal CK2 falls coincides with the timing at which the high potential of the control signal CK3 rises. The timing at which the high potential of the control signal CK3 falls coincides with the timing at which the high potential of the control signal CK4 rises. The timing at which the high potential of the control signal CK4 falls coincides with the timing at which the high potentials of the scanning signals G(n−1), G(n), and G(n+1) fall. Note that the control signals CK1 to CK4 output from the control substrate 14 are supplied to the control wiring lines 29α to 29δ via the flexible substrate 13 and the control trunk wiring lines 17α to 17δ.

Specifically, as illustrated in FIGS. 7 and 9, when the high potential of the scanning signal G(n−1) from the gate drive circuit 15 is supplied to the predetermined connection wiring line 19 (the connection wiring line 19 connected to the third gate wiring line 27γ), all pixel TFTs 25 (including the fifth pixel TFT 25ϵ and the sixth pixel TFT 25ζ) connected to the two gate wiring lines 27 (including the third gate wiring line 27γ) which are arranged so as to interpose the first pixel electrode row R1 in the Y-axis direction are driven collectively. While the high potential of the scanning signal G(n−1) is supplied to the gate wiring lines 27, the high potentials of the control signals CK1 to CK4 are supplied in the order of the second control wiring line 29β, the fourth control wiring line 29δ, the first control wiring line 29α, and the third control wiring line 29γ. While the high potential of the scanning signal G(n−1) is supplied, an image signal is supplied to each of the source wiring lines 28 in synchronization with timings at which the control signals CK1 to CK4 become the high potential.

When the high potential of the control signal CK3 is supplied to the first control wiring line 29α, as illustrated in FIGS. 7 and 9, the control TFTs 24 (including the fifth control TFT 24ϵ) connected to the first control wiring line 29α are selectively driven. At this timing, the image signal supplied to the source wiring line 28 is supplied to the control drain electrode 24C via a channel region generated in the control semiconductor portion 24D from the control source electrode 24B of the driven control TFT 24. At this timing, the pixel TFTs 25 (including the fifth pixel TFT 25ϵ) connected to the two gate wiring lines 27 (including the third gate wiring line 27γ) which are arranged to interpose the first pixel electrode row R1 are driven by the high potential of the scanning signal G(n−1). Accordingly, the image signal supplied to the control drain electrode 24C of the fifth control TFT 24ϵ is supplied to the pixel drain electrode 25C via a channel region generated in the pixel semiconductor portion 25D from the pixel source electrode 25B of the fifth pixel TFT 25ϵ. As a result, the fifth pixel electrode 26ϵ included in the first pixel electrode row R1 is charged to a potential relating to the image signal supplied to the pixel drain electrode 25C of the fifth pixel TFT 25ϵ.

When the high potential of the control signal CK4 is supplied to the third control wiring line 29γ, as illustrated in FIGS. 7 and 9, the control TFTs 24 (including the sixth control TFT 24ζ) connected to the third control wiring line 29γ are selectively driven. At this timing, the image signal supplied to the source wiring line 28 is supplied to the control drain electrode 24C via a channel region generated in the control semiconductor portion 24D from the control source electrode 24B of the driven control TFT 24. At this timing, the pixel TFTs 25 (including the sixth pixel TFT 25ζ) connected to the two gate wiring lines 27 (including the third gate wiring line 27γ) arranged interposing the first pixel electrode row R1 are driven by the high potential of the scanning signal G(n−1). Accordingly, the image signal supplied to the control drain electrode 24C of the sixth control TFT 24ζ is supplied to the pixel drain electrode 25C via a channel region generated in the pixel semiconductor portion 25D from the pixel source electrode 25B of the sixth pixel TFT 25ζ. As a result, the sixth pixel electrode 26ζ included in the first pixel electrode row R1 is charged to a potential relating to the image signal supplied to the pixel drain electrode 25C of the sixth pixel TFT 25ζ.

Subsequently, as illustrated in FIGS. 8 and 9, when the high potential of the scanning signal G(n) from the gate drive circuit 15 is supplied to the predetermined connection wiring line 19 (the connection wiring line 19 connected to the first gate wiring line 27α and the second gate wiring line 27β), all the pixel TFTs 25 (including the first pixel TFT 25α, the second pixel TFT 25β, the third pixel TFT 25γ, and the fourth pixel TFT 25δ) connected to the two gate wiring lines 27 (the first gate wiring line 27α and the second gate wiring line 27β) arranged interposing the second pixel electrode row R2 in the Y-axis direction are driven collectively. While the high potential of the scanning signal G(n) is supplied to the gate wiring lines 27, the high potentials of the control signals CK1 to CK4 are supplied in the order of the second control wiring line 29β, the fourth control wiring line 29δ, the first control wiring line 29α, and the third control wiring line 29γ. While the high potential of the scanning signal G(n) is supplied, an image signal is supplied to each of the source wiring lines 28 in synchronization with timings at which the control signals CK1 to CK4 become the high potential.

When the high potential of the control signal CK1 is supplied to the second control wiring line 29β, as illustrated in FIGS. 8 and 9, the control TFTs 24 (including the second control TFT 24β) connected to the second control wiring line 29β are selectively driven. At this timing, the image signal supplied to the source wiring line 28 is supplied to the control drain electrode 24C via a channel region generated in the control semiconductor portion 24D from the control source electrode 24B of the driven control TFT 24. At this timing, the pixel TFTs 25 (including the second pixel TFT 25β) connected to the two gate wiring lines 27 (the first gate wiring line 27α and the second gate wiring line 27β) arranged interposing the second pixel electrode row R2 are driven by the high potential of the scanning signal G(n). Accordingly, the image signal supplied to the control drain electrode 24C of the second control TFT 24β is supplied to the pixel drain electrode 25C via a channel region generated in the pixel semiconductor portion 25D from the pixel source electrode 25B of the second pixel TFT 25β. As a result, the second pixel electrode 26β included in the second pixel electrode row R2 is charged to a potential relating to the image signal supplied to the pixel drain electrode 25C of the second pixel TFT 25β.

When the high potential of the control signal CK2 is supplied to the fourth control wiring line 29δ, as illustrated in FIGS. 8 and 9, the control TFTs 24 (including the fourth control TFT 24δ) connected to the fourth control wiring line 29δ are selectively driven. At this timing, the image signal supplied to the source wiring line 28 is supplied to the control drain electrode 24C via a channel region generated in the control semiconductor portion 24D from the control source electrode 24B of the driven control TFT 24. At this timing, the pixel TFTs 25 (including the fourth pixel TFT 25δ) connected to the two gate wiring lines 27 (the first gate wiring line 27α and the second gate wiring line 27β) arranged interposing the second pixel electrode row R2 are driven by the high potential of the scanning signal G(n). Accordingly, the image signal supplied to the control drain electrode 24C of the fourth control TFT 24δ is supplied to the pixel drain electrode 25C via a channel region generated in the pixel semiconductor portion 25D from the pixel source electrode 25B of the fourth pixel TFT 25δ. As a result, the fourth pixel electrode 26δ included in the second pixel electrode row R2 is charged to a potential relating to the image signal supplied to the pixel drain electrode 25C of the fourth pixel TFT 25δ.

When the high potential of the control signal CK3 is supplied to the first control wiring line 29α, as illustrated in FIGS. 8 and 9, the control TFTs 24 (including the first control TFT 24α) connected to the first control wiring line 29α are selectively driven. At this timing, the image signal supplied to the source wiring line 28 is supplied to the control drain electrode 24C via a channel region generated in the control semiconductor portion 24D from the control source electrode 24B of the driven control TFT 24. At this timing, the pixel TFTs 25 (including the first pixel TFT 25α) connected to the two gate wiring lines 27 (the first gate wiring line 27α and the second gate wiring line 27β) arranged interposing the second pixel electrode row R2 are driven by the high potential of the scanning signal G(n). Accordingly, the image signal supplied to the control drain electrode 24C of the first control TFT 24α is supplied to the pixel drain electrode 25C via a channel region generated in the pixel semiconductor portion 25D from the pixel source electrode 25B of the first pixel TFT 25α. As a result, the first pixel electrode 26α included in the second pixel electrode row R2 is charged to a potential relating to the image signal supplied to the pixel drain electrode 25C of the first pixel TFT 25α.

When the high potential of the control signal CK4 is supplied to the third control wiring line 29γ, as illustrated in FIGS. 8 and 9, the control TFTs 24 (including the third control TFT 24γ) connected to the third control wiring line 29γ are selectively driven. At this timing, the image signal supplied to the source wiring line 28 is supplied to the control drain electrode 24C via a channel region generated in the control semiconductor portion 24D from the control source electrode 24B of the driven control TFT 24. At this timing, pixel TFTs 25 (including the third pixel TFT 25γ) connected to two gate wiring lines 27 (the first gate wiring line 27α and the second gate wiring line 27β) arranged interposing the second pixel electrode row R2 are driven by the high potential of the scanning signal G(n). Accordingly, the image signal supplied to the control drain electrode 24C of the third control TFT 24γ is supplied to the pixel drain electrode 25C via a channel region generated in the pixel semiconductor portion 25D from the pixel source electrode 25B of the third pixel TFT 25γ. Accordingly, the third pixel electrode 26γ included in the second pixel electrode row R2 is charged to a potential relating to the image signal supplied to the pixel drain electrode 25C of the third pixel TFT 25γ.

As described above, the array substrate (display substrate) 21 according to the present embodiment includes the first gate wiring line (first scanning wiring line) 27α extending along the first direction, the second gate wiring line (second scanning wiring line) 27β extending along the first direction and arranged with a space from the first gate wiring line 27α, the first pixel electrode 26α interposed between the first gate wiring line 27α and the second gate wiring line 27β, the second pixel electrode 26β interposed between the first gate wiring line 27α and the second gate wiring line 27β and arranged with a space from the first pixel electrode 26α in the first direction, the first control wiring line 29α extending along the first direction and arranged with a space from the first gate wiring line 27α without the first pixel electrode 26α and the second pixel electrode 26β being interposed, a second control wiring line 29β extending along the first direction and arranged spaced apart from the second gate wiring line 27β without the first pixel electrode 26α and the second pixel electrode 26β being interposed, the first source wiring line (first signal wiring line) 28α extending along the second direction intersecting with the first direction and intersecting with the first gate wiring line 27α, the second gate wiring line 27β, the first control wiring line 29α, and the second control wiring line 29β, the first control TFT (first switching element) 24α connected to the first control wiring line 29α and the first source wiring line 28α, the first pixel TFT (second switching element) 25α connected to the first gate wiring line 27α, the first control TFT 24α, and the first pixel electrode 26α, the second control TFT (third switching element) 24β connected to the second control wiring line 29β and the first source wiring line 28α, and the second pixel TFT (fourth switching element) 25β connected to the second gate wiring line 27β, the second control TFT 24β, and the second pixel electrode 26β.

When the first control TFT 24α is driven by a signal supplied to the first control wiring line 29α, a signal supplied to the first source wiring line 28α is supplied to the first pixel TFT 25α. In synchronization with this timing, when the first pixel TFT 25α is driven by a signal supplied from the first gate wiring line 27α, the signal from the first control TFT 24α is supplied to the first pixel electrode 26α, and the first pixel electrode 26α is charged. When the second control TFT 24β is driven by a signal supplied to the second control wiring line 29β, the signal supplied to the first source wiring line 28α is supplied to the second pixel TFT 25β. In synchronization with this timing, when the second pixel TFT 25β is driven by a signal supplied from the second gate wiring line 27β, a signal from the second control TFT 24β is supplied to the second pixel electrode 26β, and the second pixel electrode 26β is charged.

In this manner, the signal supplied to the first source wiring line 28α can be distributed to the first pixel electrode 26α and the second pixel electrode 26β, which is preferable for reducing the number of source wiring lines 28. Furthermore, since the first gate wiring line 27α and the first control wiring line 29α, and the second gate wiring line 27β and the second control wiring line 29β are dispersedly arranged so as to interpose the first pixel electrode 26α and the second pixel electrode 26β in the second direction, parasitic capacitance can be reduced as compared with a case in which the first gate wiring line 27α, the first control wiring line 29α, the second gate wiring line 27β, and the second control wiring line 29β are collectively arranged on one side with respect to the first pixel electrode 26α and the second pixel electrode 26β in the second direction. In addition, since the number of intersection points where each of the electrodes 24A to 24D and 25A to 25D of each of the TFTs 24α, 24β, 25α, and 25β intersect with each of the wiring lines 27α, 27β, 29α, and 29β can be reduced, parasitic capacitance can be reduced. Accordingly, since dullness is less likely to occur in the signals supplied to each of the wiring lines 27α, 27β, 29α, and 29β, the operation of each of the TFTs 24α, 24β, 25α, and 25β can be stabilized, and the potential of each of the pixel electrodes 26α and 26β is less likely to fluctuate.

Further, the array substrate 21 includes the fifth pixel electrode (third pixel electrode) 26ϵ arranged with at least the first gate wiring line 27α and the first control wiring line 29α interposed between the fifth pixel electrode 26ϵ and the first pixel electrode 26α, the third gate wiring line (third scanning wiring line) 27γ extending along the first direction and interposed between the first pixel electrode 26α and the fifth pixel electrode 26ϵ, the fifth control TFT (fifth switching element) 24ϵ connected to the first control wiring line 29α and the first source wiring line 28α, and the fifth pixel TFT (sixth switching element) 25ϵ connected to the third gate wiring line 27γ, the fifth control TFT 24ϵ, and the fifth pixel electrode 26ϵ. When the fifth control TFT 24ϵ is driven by a signal supplied from the first control wiring line 29α, a signal supplied to the first source wiring line 28α is supplied to the fifth pixel TFT 25ϵ. In synchronization with this timing, when the fifth pixel TFT 25ϵ is driven by a signal supplied from the third gate wiring line 27γ, a signal from the fifth control TFT 24ϵ is supplied to the fifth pixel electrode 26ϵ. Accordingly, the fifth pixel electrode 26ϵ arranged with at least the first gate wiring line 27α, the first control wiring line 29α, and the third gate wiring line 27γ interposed between the fifth pixel electrode 26ϵ and the first pixel electrode 26α is charged to a potential relating to a signal supplied from the fifth control TFT 24ϵ. In this manner, since the first control wiring line 29α has a function of controlling driving of the fifth control TFT 24ϵ in addition to a function of controlling driving of the first control TFT 24α and the second control TFT 24β, as compared with a case in which another control wiring line is provided to control the fifth control TFT 24ϵ, a wiring space can be reduced, and accordingly, the aperture ratio can be improved.

Further, the first gate wiring line 27α is arranged closer to the first pixel electrode 26α and the second pixel electrode 26β than the first control wiring line 29α, and the second gate wiring line 27β is arranged closer to the first pixel electrode 26α and the second pixel electrode 26β than the second control wiring line 29β. In this manner, the pixel gate electrode 25A included in the first pixel TFT 25α can avoid intersecting with the first control wiring line 29α. Accordingly, since occurrence of parasitic capacitance between the pixel gate electrode 25A and the first control wiring line 29α can be avoided, the operation of the first pixel TFT 25α can be stabilized. Similarly, the pixel gate electrode 25A included in the second pixel TFT 25β can avoid intersecting with the second control wiring line 29β. Accordingly, since occurrence of parasitic capacitance between the pixel gate electrode 25A and the second control wiring line 29β can be avoided, the operation of the second pixel TFT 25β can be stabilized.

Further, there is provided the third pixel electrode (fourth pixel electrode) 26γ interposed between the first gate wiring line 27α and the second gate wiring line 27β and arranged with a space from the first pixel electrode 26α and the second pixel electrode 26β in the first direction, the fourth pixel electrode (fifth pixel electrode) 26δ interposed between the first gate wiring line 27α and the second gate wiring line 27β and arranged with a space from the first pixel electrode 26α, the second pixel electrode 26β, and the third pixel electrode 26γ in the first direction, the third control wiring line 29γ extending along the first direction and arranged with a space from the first gate wiring line 27α and the first control wiring line 29α without the first pixel electrode 26α, the second pixel electrode 26β, the third pixel electrode 26γ, and the fourth pixel electrode 26δ being interposed, the fourth control wiring line 29δ extending along the first direction and arranged with a space from the second gate wiring line 27β and the second control wiring line 29β without the first pixel electrode 26α, the second pixel electrode 26β, the third pixel electrode 26γ, and the fourth pixel electrode 26δ being interposed, the third control TFT (seventh switching element) 24γ connected to the third control wiring line 29γ and the first source wiring line 28α, the third pixel TFT (eighth switching element) 25γ connected to the first gate wiring line 27α, the third control TFT 24γ, and the third pixel electrode 26γ, the fourth control TFT (ninth switching element) 24δ connected to the fourth control wiring line 29δ and the first source wiring line 28α, and the fourth pixel TFT (tenth switching element) 25δ connected to the second gate wiring line 27β, the fourth control TFT 24δ, and the fourth pixel electrode 26δ.

When the third control TFT 24γ is driven by a signal supplied from the third control wiring line 29γ, a signal supplied to the first source wiring line 28α is supplied to the third pixel TFT 25γ. In synchronization with this timing, when the third pixel TFT 25γ is driven by the signal supplied from the first gate wiring line 27α, the signal from the third control TFT 24γ is supplied to the third pixel electrode 26γ, and the third pixel electrode 26γ is charged. When the fourth control TFT 24δ is driven by a signal supplied from the fourth control wiring line 29δ, the signal supplied to the first source wiring line 28α is supplied to the fourth pixel TFT 25δ. In synchronization with this timing, when the fourth pixel TFT 25δ is driven by the signal supplied from the second gate wiring line 27β, the signal from the fourth control TFT 24δ is supplied to the fourth pixel electrode 26δ, and the fourth pixel electrode 26δ is charged.

In this manner, the signal supplied to the first source wiring line 28α can be distributed not only to the first pixel electrode 26α and the second pixel electrode 26β but also to the third pixel electrode 26γ and the fourth pixel electrode 26δ, which is preferable for reducing the number of the source wiring lines 28. Furthermore, since the third control wiring line 29γ and the fourth control wiring line 29δ are dispersedly arranged so as to interpose the first pixel electrode 26α, the second pixel electrode 26β, the third pixel electrode 26γ, and the fourth pixel electrode 26δ in the second direction, parasitic capacitance can be reduced as compared with a case in which the third control wiring line 29γ and the fourth control wiring line 29δ are collectively arranged on one side with respect to the first pixel electrode 26α, the second pixel electrode 26β, the third pixel electrode 26γ, and the fourth pixel electrode 26δ in the second direction. In addition, since the number of intersection points where each of the electrodes 24A to 24D and 25A to 25D of each of the TFTs 24α, 24β, 24γ, 24δ, 25α, 25β, 25γ, and 25δ intersect with each of the wiring lines 27α, 27β, 29α, 29β, 29γ, and 29δ can be reduced, parasitic capacitance can be reduced.

Further, the liquid crystal panel (display device) 11 according to the present embodiment includes the array substrate 21 described above and the counter substrate 20 arranged so as to oppose the array substrate 21. According to the liquid crystal panel 11 having such a configuration, the parasitic capacitance can be reduced, and thus the display quality can be improved.

### SECOND EMBODIMENT

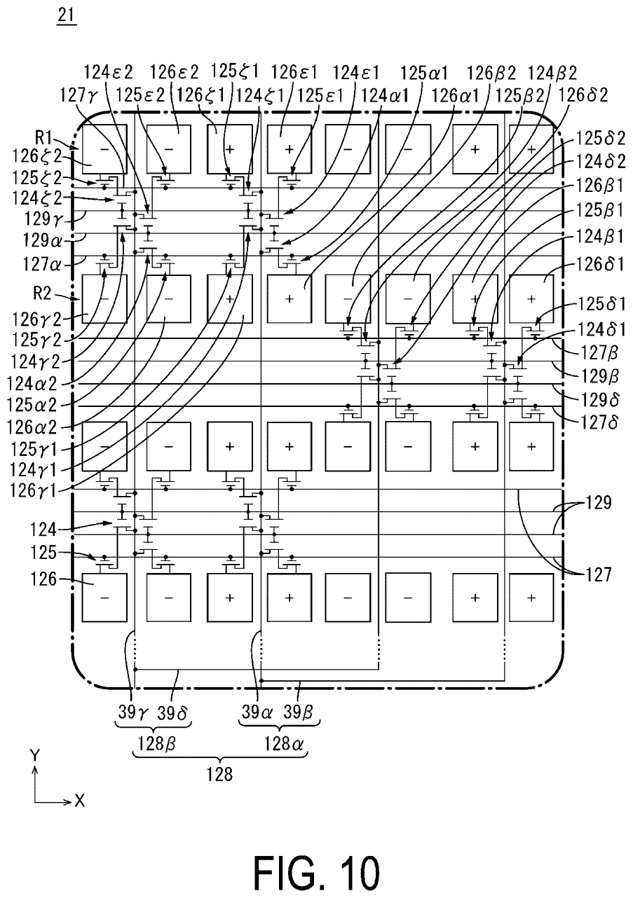

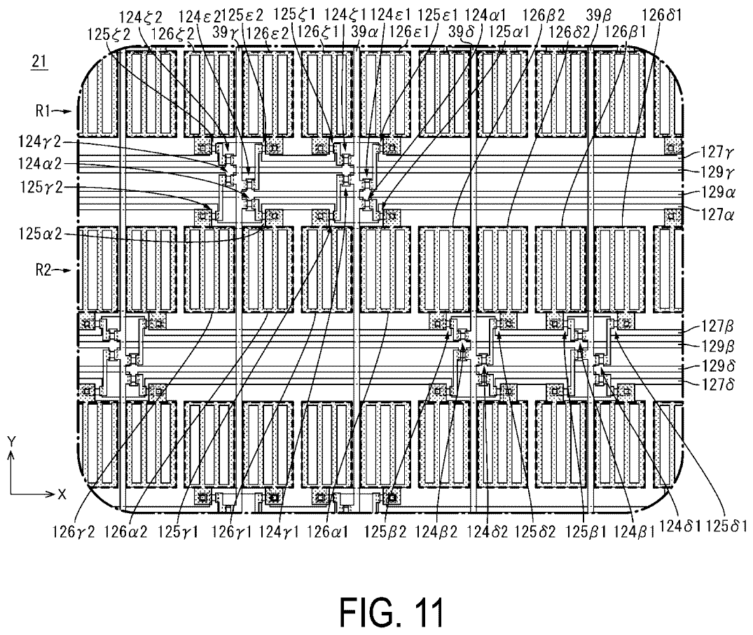

A second embodiment will be described with reference to FIG. 10 or FIG. 11. In the second embodiment, a case in which the configuration of a source wiring line 128 and the like is changed is described. Further, repetitive descriptions of structures, actions, and effects similar to those of the first embodiment described above will be omitted.

As illustrated in FIG. 10, the source wiring line 128 according to the present embodiment is provided with a branch structure including two branch portions 39. In more detail, the source wiring line 128 is configured such that the two branch portions 39 arranged in a display region AA are led out to a non-display region NAA, and lead-out portions thereof are connected to each other. Of lead-out portions of the two branch portions 39, either one end is led out to an exposed portion 21A and connected to a terminal portion arranged in a mounting region of a driver 12, the terminal portion being configured to receive an image signal supplied from the driver 12 (see FIG. 1). The branch portions 39 extend along a Y-axis direction and traverse the display region AA. The two branch portions 39 connected to each other are arranged at positions spaced apart in an X-axis direction in the display region AA.

In the following, in a case in which the plurality of branch portions 39 are distinguished, one branch portion 39 (on the left side in FIG. 10) constituting a first source wiring line 128α is referred to as a “first branch portion” with a suffix “α” attached to the reference numeral, the other branch portion 39 (on the right side in FIG. 10) constituting the first source wiring line 128α is referred to as a “second branch portion” with a suffix “β” attached to the reference numeral, one branch portion 39 (on the left side in FIG. 10) constituting a second source wiring line 128β is referred to as a “third branch portion” with a suffix “γ” attached to the reference numeral, and the other branch portion 39 (on the right side in FIG. 10) constituting the second source wiring line 128β is referred to as a “fourth branch portion” with a suffix “δ” attached to the reference numeral, and in a case in which the branch portions 39 are collectively referred to without distinction, no suffixes “α to δ” are attached to the reference numerals.

In addition, in a case in which a plurality of pixel TFTs 125α to 125ζ are distinguished, the pixel TFTs 125α to 125ζ connected to the first source wiring line 128α are classified into a “first group” with a suffix “1” attached to the reference numerals of the pixel TFTs 125α to 125ζ, the pixel TFTs 125α to 125ζ connected to the second source wiring line 128β are classified into a “second group” with a suffix “2” attached to the reference numerals of the pixel TFTs 125α to 125ζ, and in a case in which the pixel TFTs 125α to 125ζ are collectively referred to without distinction, no suffixes “1, 2” are attached to the reference numerals.

In addition, in a case in which a plurality of pixel electrodes 126α to 126ζ are distinguished, the pixel electrodes 126α to 126ζ connected to the pixel TFTs 125α1 to 125ζ1 belonging to the first group are classified into a “first group” with a suffix “1” attached to the reference numerals, the pixel electrodes 126α to 126ζ connected to the pixel TFTs 125α2 to 125ζ2 belonging to the second group are classified into a “second group” with a suffix “2” attached to the reference numerals, and in a case in which the pixel electrodes 126α to 126ζ are collectively referred to without distinction, no suffixes “1, 2” are attached to the reference numerals.

In addition, in a case in which a plurality of control TFTs 124α to 124ζ are distinguished, the control TFTs 124α to 124ζ connected to the pixel TFTs 125α1 to 125ζ1 belonging to the first group are classified into a “first group” with a suffix “1” attached to the reference numerals, the control TFTs 124α to 124ζ connected to the pixel TFTs 125α2 to 125ζ2 belonging to the second group are classified into a “second group” with a suffix “2” attached to the reference numerals, and in a case in which the control TFTs 124α to 124ζ are collectively referred to without distinction, no suffixes “1, 2” are attached to the reference numerals.

The detailed structure of the source wiring line 128 will be described. In the present embodiment, the first source wiring line 128α is configured such that four pixel electrode columns are interposed between a first branch portion 39α and a second branch portion 39β, as illustrated in FIGS. 10 and 11. Similarly, the second source wiring line 128β is configured such that the four pixel electrode columns are interposed between a third branch portion 39γ and a fourth branch portion 39δ. The first branch portion 39α is arranged to be interposed between the third branch portion 39γ and the fourth branch portion 39δ in the X-axis direction, and the two pixel electrode columns are interposed respectively between the third branch portion 39γ and the first branch portion 39α and between the first branch portion 39α and the fourth branch portion 39δ. The fourth branch portion 39δ is arranged to be interposed between the first branch portion 39α and the second branch portion 39β in the X-axis direction, and the two pixel electrode columns are interposed respectively between the first branch portion 39α and the fourth branch portion 39δ and between the fourth branch portion 39δ and the second branch portion 39β.

Of the control TFTs 124α1 to 124ζ1 connected to the first source wiring line 128α, the first control TFT 124α1, the third control TFT 124γ1, the fifth control TFT 124ϵ1, and the sixth control TFT 124ζ1 are connected to the first branch portion 39α, as illustrated in FIGS. 10 and 11, and the second control TFT 124β1 and the fourth control TFT 124δ1 are connected to the second branch portion 39β. The second control TFT 124β1 and the fourth control TFT 124δ1 connected to the second branch portion 39β are arranged at positions spaced apart by the two pixel electrode columns in the X-axis direction from the first control TFT 124α1, the third control TFT 124γ1, the fifth control TFT 124ϵ1, and the sixth control TFT 124ζ1 connected to the first branch portion 39α. Accordingly, the second pixel TFT 125β1 and the fourth pixel TFT 125δ1 connected to the second control TFT 124β1 and the fourth control TFT 124δ1 are arranged at positions spaced apart by the two pixel electrode columns in the X-axis direction from the first pixel TFT 125α1, the third pixel TFT 125γ1, the fifth pixel TFT 125ϵ1, and the sixth pixel TFT 125ζ1 connected to the first control TFT 124α1, the third control TFT 124γ1, the fifth control TFT 124ϵ1, and the sixth control TFT 124ζ1. Then, a second pixel electrode 126β1 and a fourth pixel electrode 126δ1 connected to the second pixel TFT 125β1 and the fourth pixel TFT 125δ1 are arranged at positions spaced apart by the two pixel electrode columns (including a second pixel electrode 126β2 and a fourth pixel electrode 126δ2) in the X-axis direction from a first pixel electrode 126α1, a third pixel electrode 126γ1, a fifth pixel electrode 126ϵ1, and a sixth pixel electrode 126ζ1 connected to the first pixel TFT 125α1, the third pixel TFT 125γ1, the fifth pixel TFT 125ϵ1, and the sixth pixel TFT 125ζ1.

Similarly, of control TFTs 124α2 to 124ζ2 connected to the second source wiring line 128β, a first control TFT 124α2, a third control TFT 124γ2, a fifth control TFT 124ϵ2, and a sixth control TFT 124ζ2 are connected to the third branch portion 39γ, as illustrated in FIGS. 10 and 11, while a second control TFT 124β2 and a fourth control TFT 124δ2 are connected to the fourth branch portion 39δ. A second control TFT 124β2 and a fourth control TFT 124δ2 connected to the fourth branch portion 39δ are arranged at positions spaced apart by the two pixel electrode columns in the X-axis direction from a first control TFT 124α2, a third control TFT 124γ2, a fifth control TFT 124ϵ2, and a sixth control TFT 124ζ2 connected to the third branch portion 39γ. Accordingly, the second pixel TFT 125β2 and the fourth pixel TFT 125δ2 connected to the second control TFT 124β2 and the fourth control TFT 124δ2 are arranged at positions spaced apart by the two pixel electrode columns in the X-axis direction from the first pixel TFT 125α2, the third pixel TFT 125γ2, the fifth pixel TFT 125ϵ2, and the sixth pixel TFT 125ζ2 connected to the first control TFT 124α2, the third control TFT 124γ2, the fifth control TFT 124ϵ2, and the sixth control TFT 124ζ2. Then, the second pixel electrode 126β2 and the fourth pixel electrode 126δ2 connected to the second pixel TFT 125β2 and the fourth pixel TFT 125δ2 are arranged at positions spaced apart by the two pixel electrode columns (including the first pixel TFT 125α1 and the third pixel TFT 125γ1) in the X-axis direction from a first pixel electrode 126α2, a third pixel electrode 126γ2, a fifth pixel electrode 126ϵ2, and a sixth pixel electrode 126ζ2 connected to the first pixel TFT 125α2, the third pixel TFT 125γ2, the fifth pixel TFT 125ϵ2, and the sixth pixel TFT 125ζ2.

The first pixel electrode 126α1, the third pixel electrode 126γ1, the fifth pixel electrode 126ϵ1, and the sixth pixel electrode 126ζ1 connected to the first pixel TFT 125α1, the third pixel TFT 125γ1, the fifth pixel TFT 125ϵ1, and the sixth pixel TFT 125ζ1 are arranged with the first branch portion 39α interposed between the first pixel electrode 126α1, the third pixel electrode 126γ1, the fifth pixel electrode 126ϵ1, and the sixth pixel electrode 126ζ1 in the X-axis direction, as illustrated in FIGS. 10 and 11. The second pixel electrode 126β1 and the fourth pixel electrode 126δ1 connected to the second pixel TFT 125β1 and the fourth pixel TFT 125δ1 are arranged with the second branch portion 39β interposed between the second pixel electrode 126β1 and the fourth pixel electrode 126δ1 in the X-axis direction. The first pixel electrode 126α2, the third pixel electrode 126γ2, the fifth pixel electrode 126ϵ2, and the sixth pixel electrode 126ζ2 connected to the first pixel TFT 125α2, the third pixel TFT 125γ2, the fifth pixel TFT 125ϵ2, and the sixth pixel TFT 125ζ2 are arranged with the third branch portion 39γ interposed between the first pixel electrode 126α2, the third pixel electrode 126γ2, the fifth pixel electrode 126ϵ2, and the sixth pixel electrode 126ζ2 in the X-axis direction. The second pixel electrode 126β2 and the fourth pixel electrode 126δ2 connected to the second pixel TFT 125β2 and the fourth pixel TFT 125δ2 are arranged with the fourth branch portion 39δ interposed between the second pixel electrode 126β2 and the fourth pixel electrode 126δ2 in the X-axis direction.

An image signal supplied from the driver 12 to the first source wiring line 128α is distributed to the first branch portion 39α and the second branch portion 39β, as illustrated in FIGS. 10 and 11. An image signal supplied from the driver 12 to the second source wiring line 128β is distributed to the third branch portion 39γ and the fourth branch portion 39δ. When a high potential of a control signal is supplied to a first control wiring line 129α while a high potential of a scanning signal is supplied to a first gate wiring line 127α, the first control TFTs 124α1 and 124α2 and the first pixel TFTs 125α1 and 125α2 are selectively driven, respectively. Accordingly, the image signal transmitted by the first branch portion 39α is supplied to the first pixel electrode 126α1, and the image signal transmitted by the third branch portion 39γ is supplied to the first pixel electrode 126α2. When the high potential of the control signal is supplied to a second control wiring line 129β while the high potential of the scanning signal is supplied to a second gate wiring line 127β, the second control TFTs 124β1 and 124β2 and the second pixel TFTs 125β1 and 125β2 are selectively driven, respectively. Accordingly, the image signal transmitted by the second branch portion 39β is supplied to the second pixel electrode 126β1, and the image signal transmitted by the fourth branch portion 39δ is supplied to the second pixel electrode 126β2.

When the high potential of the control signal is supplied to a third control wiring line 129γ while the high potential of the scanning signal is supplied to the first gate wiring line 127α, the third control TFTs 124γ1 and 124γ2 and the third pixel TFTs 125γ1 and 125γ2 are selectively driven, respectively. Accordingly, the image signal transmitted by the first branch portion 39α is supplied to the third pixel electrode 126γ1, and the image signal transmitted by the third branch portion 39γ is supplied to the third pixel electrode 126γ2. When the high potential of the control signal is supplied to the fourth control wiring line 129δ while the high potential of the scanning signal is supplied to the second gate wiring line 127β, the fourth control TFTs 124δ1 and 124δ2 and the fourth pixel TFTs 125δ1 and 125δ2 are selectively driven, respectively. Accordingly, the image signal transmitted by the second branch portion 39β is supplied to the fourth pixel electrode 126δ1, and the image signal transmitted by the fourth branch portion 39δ is supplied to the fourth pixel electrode 126δ2.

When the high potential of the control signal is supplied to the first control wiring line 129α while the high potential of the scanning signal is supplied to the third gate wiring line 127γ, the fifth control TFTs 124ϵ1 and 124ϵ2 and the fifth pixel TFTs 125ϵ1 and 125ϵ2 are selectively driven, respectively. Accordingly, the image signal transmitted by the first branch portion 39α is supplied to the fifth pixel electrode 126ϵ1, and the image signal transmitted by the third branch portion 39γ is supplied to the fifth pixel electrode 126ϵ2. When the high potential of the control signal is supplied to the third control wiring line 129γ while the high potential of the scanning signal is supplied to the third gate wiring line 127γ, the sixth control TFTs 124ζ1 and 124ζ2 and the sixth pixel TFTs 125ζ1 and 125ζ2 are selectively driven, respectively. Accordingly, the image signal transmitted by the first branch portion 39α is supplied to the sixth pixel electrode 126ζ1, and the image signal transmitted by the third branch portion 39γ is supplied to the sixth pixel electrode 126ζ2.

As illustrated in FIG. 10, the driver 12 according to the present embodiment supplies signals opposite in polarity to each other to the first source wiring line 128α and the second source wiring line 128β. Specifically, in a case in which the driver 12 supplies a positive-polarity image signal to the first source wiring line 128α, the driver 12 supplies a negative-polarity image signal to the second source wiring line 128β. On the other hand, in a case in which the driver 12 supplies a negative-polarity image signal to the first source wiring line 128α, the driver 12 supplies a positive-polarity image signal to the second source wiring line 128β. Note that, in FIG. 10, the positive and negative polarities of image signals supplied to each of the source wiring lines 128α and 128β are illustrated as symbols “+” and “−”, and the positive and negative polarities of image signals written into each of the pixel electrodes 126 are also illustrated as symbols “+” and “−”.

In this manner, the first pixel electrode 126α1, the second pixel electrode 126β1, the third pixel electrode 126γ1, the fourth pixel electrode 126δ1, the fifth pixel electrode 126ϵ1, and the sixth pixel electrode 126ζ1, which are charged to a potential relating to the image signal transmitted by the first source wiring line 128α, and the first pixel electrode 126α2, the second pixel electrode 126β2, the third pixel electrode 126γ2, the fourth pixel electrode 126δ2, the fifth pixel electrode 126ϵ2, and the sixth pixel electrode 126ζ2, which are charged to a potential relating to the image signal transmitted by the second source wiring line 128β, are in a relationship opposite in polarity to each other. Since the second pixel electrode 126β2 and the fourth pixel electrode 126δ2 are arranged to be interposed between the first pixel electrode 126α1 and the third pixel electrode 126γ1 and between the second pixel electrode 126β1 and the fourth pixel electrode 126δ1 in the X-axis direction, striped unevenness becomes less likely to be visually recognized as compared with a case in which the second pixel electrode 126β2 and the fourth pixel electrode 126δ2 are set to have the same polarity as the first pixel electrode 126α1, the second pixel electrode 126β1, the third pixel electrode 126γ1, and the fourth pixel electrode 126δ1.

As described above, according to the present embodiment, there is provided the first source wiring line 128α branched into the first branch portion 39α extending along the second direction and the second branch portion 39β arranged with a space from the first branch portion 39α in the first direction and extending along the second direction, the first branch portion 39α with at least the first control TFT 124α1 and the third control TFT 124γ1 connected thereto, the second branch portion 39β with at least the second control TFT 124β1 and the fourth control TFT 124δ1 connected thereto, the first pixel electrode 126α1 and the third pixel electrode 126γ1 being arranged with the first branch portion 39α interposed between the first pixel electrode 126α1 and the third pixel electrode 126γ1 in the first direction, and the second pixel electrode 126β1 and the fourth pixel electrode 126δ1 being arranged with the second branch portion 39β interposed between the second pixel electrode 126β1 and the fourth pixel electrode 126δ1 in the first direction, the second source wiring line (second signal wiring line) 128β extending along the second direction and including a portion (fourth branch portion 39δ) interposed between the first branch portion 39α and the second branch portion 39β in the first direction, the second pixel electrode (sixth pixel electrode) 126β2 arranged with a space from the second source wiring line 128β in the first direction, the fourth pixel electrode (seventh pixel electrode) 126δ2 arranged with the second source wiring line 128β interposed between the fourth pixel electrode 126δ2 and the second pixel electrode 126β2 in the first direction, the second control TFT (eleventh switching element) 124β2 connected to the second control wiring line 129β and the second source wiring line 128β, the second pixel TFT (twelfth switching element) 125β2 connected to the second gate wiring line 127β, the second control TFT 124β2, and the second pixel electrode 126β2, the fourth control TFT (thirteenth switching element) 124δ2 connected to the fourth control wiring line 129δ and the second source wiring line 128β, the fourth pixel TFT (fourteenth switching element) 125δ2 connected to the second gate wiring line 127β, the fourth control TFT 124δ2, and the fourth pixel electrode 126δ2, and the driver (signal supply unit) 12 supplying signals opposite in polarity to each other to the first source wiring line 128α and the second source wiring line 128β.

When the second control TFT 124β2 is driven by a signal supplied from the second control wiring line 129β, the signal supplied from the driver 12 to the second source wiring line 128β is supplied to the second pixel TFT 125β2. In synchronization with this timing, when the second pixel TFT 125β2 is driven by the signal supplied from the second gate wiring line 127β, the signal from the second control TFT 124β2 is supplied to the second pixel electrode 126β2, and the second pixel electrode 126β2 is charged. When the fourth control TFT 124δ2 is driven by the signal supplied from the fourth control wiring line 129δ, the signal supplied from the driver 12 to the second source wiring line 128β is supplied to the fourth pixel TFT 125δ2. In synchronization with this timing, when the fourth pixel TFT 125δ2 is driven by the signal supplied from the second gate wiring line 127β, the signal from the fourth control TFT 124δ2 is supplied to the fourth pixel electrode 126δ2, and the fourth pixel electrode 126δ2 is charged.

On the other hand, the signal supplied from the driver 12 to the first source wiring line 128α is distributed to the first branch portion 39α and the second branch portion 39β, and is supplied to the first control TFT 124α1 and the third control TFT 124γ1 connected to the first branch portion 39α, and to the second control TFT 124β1 and the fourth control TFT 124δ1 connected to the second branch portion 39β. In this manner, the first pixel electrode 126α1, the second pixel electrode 126β1, the third pixel electrode 126γ1, and the fourth pixel electrode 126δ1 are respectively charged to a potential relating to the signal supplied to the first source wiring line 128α. Since the signals supplied from the driver 12 to the first source wiring line 128α and the second source wiring line 128β are opposite in polarity to each other, the first pixel electrode 126α1, the second pixel electrode 126β1, the third pixel electrode 126γ1, and the fourth pixel electrode 126δ1 and the second pixel electrode 126β2 and the fourth pixel electrode 126δ2 are opposite in polarity to each other. Since the second pixel electrode 126β2 and the fourth pixel electrode 126δ2 are arranged to be interposed between the first pixel electrode 126α1 and the third pixel electrode 126γ1 and between the second pixel electrode 126β1 and the fourth pixel electrode 126δ1 in the first direction, striped unevenness becomes less likely to be visually recognized as compared with a case in which the second pixel electrode 126β2 and the fourth pixel electrode 126δ2 are set to have the same polarity as the first pixel electrode 126α1, the second pixel electrode 126β1, the third pixel electrode 126γ1, and the fourth pixel electrode 126δ1.

### Third Embodiment

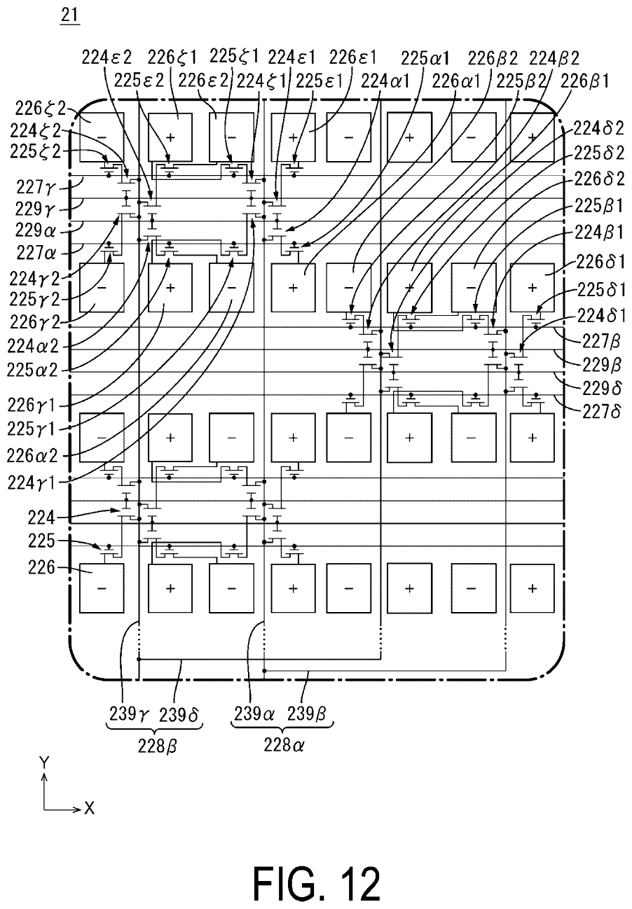

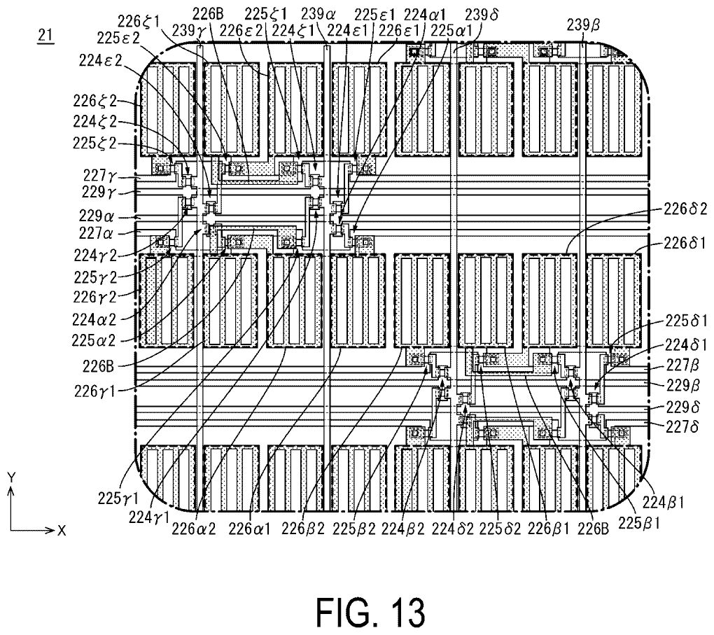

A third embodiment will be described with reference to FIG. 12 and FIG. 13. In the third embodiment, a case in which the configuration of a pixel electrode 226 is changed from the second embodiment described above is illustrated. Further, repetitive descriptions of structures, actions, and effects similar to those of the second embodiment described above will be omitted.

In the present embodiment, as illustrated in FIG. 12 and FIG. 13, an arrangement of a second pixel electrode 226β1, a third pixel electrode 226γ1, a sixth pixel electrode 226ζ1, a first pixel electrode 226α2, a fourth pixel electrode 226δ2, and a fifth pixel electrode 226ϵ2 is changed from the second embodiment described above. The second pixel electrode 226β1 is arranged at a position with a fourth branch portion 239δ interposed between the second pixel electrode 226β1 and a second pixel electrode 226β2 in an X-axis direction. Note that the second pixel electrode 226β2 is interposed between a first pixel electrode 226α1 and the fourth branch portion 239δ in the X-axis direction. The fourth pixel electrode 226δ2 is arranged at a position with a second branch portion 239β interposed between the fourth pixel electrode 226δ2 and a fourth pixel electrode 226δ1 in the X-axis direction. The fourth pixel electrode 226δ2 is interposed between the second pixel electrode 226β1 and the second branch portion 239β in the X-axis direction. That is, the second pixel electrode 226β1 and the fourth pixel electrode 226δ2 according to the present embodiment are set in a relationship in which the arrangement with respect to the X-axis direction is reversed to the second pixel electrode 126β1 and the fourth pixel electrode 126δ2 described in the second embodiment (see FIG. 10). In order to achieve the arrangement, a connection portion 226B included in the second pixel electrode 226β1 is routed so as to bypass a fourth pixel TFT 225δ2 while avoiding a short circuit with a connection portion 226B included in the fourth pixel electrode 226δ2, and as a result, the connection portion 226B intersects with a second gate wiring line 227β. The connection portion 226B included in the fourth pixel electrode 226δ2 is routed in parallel with the connection portion 226B included in the second pixel electrode 226β1, and a short circuit with the connection portion 226B included in the second pixel electrode 226β1 is avoided.

As illustrated in FIGS. 12 and 13, the third pixel electrode 226γ1 is arranged at a position with a third branch portion 239γ interposed between the third pixel electrode 226γ1 and a third pixel electrode 226γ2 in the X-axis direction. The first pixel electrode 226α2 is arranged at a position with a first branch portion 239α interposed between the first pixel electrode 226α1 and the first pixel electrode 226α2 in the X-axis direction. The first pixel electrode 226α2 is interposed between the third pixel electrode 226γ1 and the first branch portion 239α in the X-axis direction. That is, the third pixel electrode 226γ1 and the first pixel electrode 226α2 according to the present embodiment are set in a relationship in which the arrangement with respect to the X-axis direction is reversed to the third pixel electrode 126γ1 and the first pixel electrode 126α2 described in the second embodiment (see FIG. 10). In order to achieve such an arrangement, the connection portion 226B included in the third pixel electrode 226γ1 is routed so as to bypass a first pixel TFT 225α2 while avoiding a short circuit with the connection portion 226B included in the first pixel electrode 226α2, and as a result, the connection portion 226B intersects with a first gate wiring line 227α. The connection portion 226B included in the first pixel electrode 226α2 is routed in parallel with the connection portion 226B included in the third pixel electrode 226γ1, and a short circuit with the connection portion 226B included in the third pixel electrode 226γ1 is avoided.

As illustrated in FIGS. 12 and 13, the sixth pixel electrode 226ζ1 is arranged at a position with the third branch portion 239γ interposed between the sixth pixel electrode 226ζ1 and the sixth pixel electrode 226ζ2 in the X-axis direction. The fifth pixel electrode 226ϵ2 is arranged at a position with the first branch portion 239α interposed between a fifth pixel electrode 226ϵ1 and the fifth pixel electrode 226ϵ2 in the X-axis direction. That is, the sixth pixel electrode 226ζ1 and the fifth pixel electrode 226ϵ2 according to the present embodiment are set in a relationship in which the arrangement with respect to the X-axis direction is reversed to the sixth pixel electrode 126ζ1 and the fifth pixel electrode 126ϵ2 described in the second embodiment (see FIG. 10). In order to achieve the arrangement, the connection portion 226B included in the sixth pixel electrode 226ζ1 is routed so as to bypass a fifth pixel TFT 225ϵ2 while avoiding a short circuit with the connection portion 226B included in the fifth pixel electrode 226ϵ2, and as a result, the connection portion 226B intersects with a third gate wiring line 227γ. The connection portion 226B included in the fifth pixel electrode 226ϵ2 is routed in parallel with the connection portion 226B included in the sixth pixel electrode 226ζ1, and a short circuit with the connection portion 226B included in the sixth pixel electrode 226ζ1 is avoided.

As illustrated in FIG. 12 and FIG. 13, the image signal supplied from a driver 12 to a first source wiring line 228α is distributed to the first branch portion 239α and the second branch portion 239β. The image signal supplied from the driver 12 to a second source wiring line 228β is distributed to the third branch portion 239γ and the fourth branch portion 239δ. When the high potential of the control signal is supplied to a first control wiring line 229α while the high potential of the scanning signal is supplied to the first gate wiring line 227α, first control TFTs 224α1 and 224α2 and a first pixel TFT 225α1 and the first pixel TFT 225α2 are selectively driven, respectively. Accordingly, the image signal transmitted by the first branch portion 239α is supplied to the first pixel electrode 226α1, and the image signal transmitted by the third branch portion 239γ is supplied to the first pixel electrode 226α2. When the high potential of the control signal is supplied to a second control wiring line 229β while the high potential of the scanning signal is supplied to the second gate wiring line 227β, second control TFTs 224β1 and 224β2 and second pixel TFTs 225β1 and 225β2 are selectively driven, respectively. Accordingly, the image signal transmitted by the second branch portion 239β is supplied to the second pixel electrode 226β1, and the image signal transmitted by the fourth branch portion 239δ is supplied to the second pixel electrode 226β2.

When the high potential of the control signal is supplied to a third control wiring line 229γ while the high potential of the scanning signal is supplied to the first gate wiring line 227α, third control TFTs 224γ1 and 224γ2 and third pixel TFTs 225γ1 and 225γ2 are selectively driven, respectively. Accordingly, the image signal transmitted by the first branch portion 239α is supplied to the third pixel electrode 226γ1, and the image signal transmitted by the third branch portion 239γ is supplied to the third pixel electrode 226γ2. When the high potential of the control signal is supplied to a fourth control wiring line 229δ while the high potential of the scanning signal is supplied to the second gate wiring line 227β, fourth control TFTs 224δ1 and 224δ2 and a fourth pixel TFT 225δ1 and the fourth pixel TFT 225δ2 are selectively driven, respectively. Accordingly, the image signal transmitted by the second branch portion 239β is supplied to the fourth pixel electrode 226δ1, and the image signal transmitted by the fourth branch portion 239δ is supplied to the fourth pixel electrode 226δ2.

When the high potential of the control signal is supplied to the first control wiring line 229α while the high potential of the scanning signal is supplied to the third gate wiring line 227γ, fifth control TFTs 224ϵ1 and 224ϵ2 and a fifth pixel TFT 225ϵ1 and the fifth pixel TFT 225ϵ2 are selectively driven, respectively. Accordingly, the image signal transmitted by the first branch portion 239α is supplied to the fifth pixel electrode 226ϵ1, and the image signal transmitted by the third branch portion 239γ is supplied to the fifth pixel electrode 226ϵ2. When the high potential of the control signal is supplied to the third control wiring line 229γ while the high potential of the scanning signal is supplied to the third gate wiring line 227γ, sixth control TFTs 224ζ1 and 224ζ2 and sixth pixel TFTs 225ζ1 and 225ζ2 are selectively driven, respectively. Accordingly, the image signal transmitted by the first branch portion 239α is supplied to the sixth pixel electrode 226ζ1, and the image signal transmitted by the third branch portion 239γ is supplied to the sixth pixel electrode 226ζ2.

In such a configuration, signals opposite in polarity to each other are supplied from the driver 12 to the first source wiring line 228α and the second source wiring line 228β. Note that, in FIG. 12, the positive and negative polarities of image signals supplied to each of the source wiring lines 228α and 228β are illustrated as symbols “+” and “−”, and the positive and negative polarities of image signals written into each of the pixel electrodes 226 are also illustrated as symbols “+” and “−”. In this manner, the first pixel electrode 226α1, the second pixel electrode 226β1, the third pixel electrode 226γ1, the fourth pixel electrode 226δ1, the fifth pixel electrode 226ϵ1, and the sixth pixel electrode 226ζ1, which are charged to a potential relating to the image signal transmitted by the first source wiring line 228α, and the first pixel electrode 226α2, the second pixel electrode 226β2, the third pixel electrode 226γ2, the fourth pixel electrode 226δ2, the fifth pixel electrode 226ϵ2, and the sixth pixel electrode 226ζ2, which are charged to a potential relating to the image signal transmitted by the second source wiring line 228β, are in a relationship opposite in polarity to each other. The second pixel electrode 226β2 is arranged to be interposed between the first pixel electrode 226α1 and the second pixel electrode 226β1 in the X-axis direction, the first pixel electrode 226α2 is interposed between the first pixel electrode 226α1 and the third pixel electrode 226γ1 in the X-axis direction, the fourth pixel electrode 226δ2 is interposed between the second pixel electrode 226β1 and the fourth pixel electrode 226δ1 in the X-axis direction, the third pixel electrode 226γ1 is interposed between the third pixel electrode 226γ2 and the first pixel electrode 226α2 in the X-axis direction, the fifth pixel electrode 226ϵ2 is interposed between the sixth pixel electrode 226ζ1 and the fifth pixel electrode 226ϵ1 in the X-axis direction, and the sixth pixel electrode 226ζ1 is interposed between the sixth pixel electrode 226ζ2 and the fifth pixel electrode 226ϵ2 in the X-axis direction. In this manner, since the pixel electrodes 226 adjacent to each other in the X-axis direction are opposite in polarity to each other, striped unevenness becomes less likely to be visually recognized.

As described above, according to the present embodiment, there is provided the second source wiring line 228β extending along the second direction, the first source wiring line 228α branched into the first branch portion 239α extending along the second direction and the second branch portion 239β extending along the second direction and arranged with a space from the first branch portion 239α in the first direction, the first branch portion 239α connected with at least the first control TFT 224α1 and the third control TFT 224γ1, the second branch portion 239β connected with at least the second control TFT 224β1 and the fourth control TFT 224δ1, the second source wiring line 228β branched into the third branch portion 239γ extending along the second direction and the fourth branch portion 239δ extending along the second direction, the fourth branch portion 239δ arranged with the first branch portion 239α interposed between the third branch portion 239γ and the fourth branch portion 239δ in the first direction and interposed between the first branch portion 239α and the second branch portion 239β, the first pixel electrode 226α1 and the third pixel electrode 226γ1 arranged with at least the first branch portion 239α interposed between the first pixel electrode 226α1 and the third pixel electrode 226γ1 in the first direction, the second pixel electrode 226β1 and the fourth pixel electrode 226δ1 arranged with at least the second branch portion 239β interposed between the second pixel electrode 226β1 and the fourth pixel electrode 226δ1 in the first direction, the second pixel electrode (eighth pixel electrode) 226β2 interposed between the fourth branch portion 239δ and the first pixel electrode 226α1, with the fourth branch portion 239δ interposed between the second pixel electrode 226β1 and the second pixel electrode 226β2, in the first direction, the first pixel electrode (ninth pixel electrode) 226α2 interposed between the first branch portion 239α and the third pixel electrode 226γ1, with the first branch portion 239α interposed between the first pixel electrode 226α1 and the first pixel electrode 226α2 in the first direction, the fourth pixel electrode (tenth pixel electrode) 226δ2 interposed between the second branch portion 239β and the second pixel electrode 226β1, with the second branch portion 239β interposed between the fourth pixel electrode 226δ1 and the fourth pixel electrode 226δ2 in the first direction, the second control TFT (fifteenth switching element) 224β2 connected with the second control wiring line 229β and the fourth branch portion 239δ, the second pixel TFT (sixteenth switching element) 225β2 connected with the second gate wiring line 227β, the second control TFT 224β2 and the second pixel electrode 226β2, the first control TFT (seventeenth switching element) 224α2 connected with the first control wiring line 229α and the third branch portion 239γ, the first pixel TFT (eighteenth switching element) 225α2 connected with the first gate wiring line 227α, the first control TFT 224α2 and the first pixel electrode 226α2, the fourth control TFT (nineteenth switching element) 224δ2 connected with the fourth control wiring line 229δ and the fourth branch portion 239δ, and the fourth pixel TFT (twentieth switching element) 225δ2 connected with the second gate wiring line 227β, the fourth control TFT 224δ2 and the fourth pixel electrode 226δ2.

When the second control TFT 224β2 is driven by the signal supplied from the second control wiring line 229β, the signal supplied from the driver 12 to the fourth branch portion 239δ of the second source wiring line 228β is supplied to the second pixel TFT 225β2. In synchronization with this timing, when the second pixel TFT 225β2 is driven by the signal supplied from the second gate wiring line 227β, the signal from the second control TFT 224β2 is supplied to the second pixel electrode 226β2, and the second pixel electrode 226β2 is charged. When the first control TFT 224α2 is driven by the signal supplied from the first control wiring line 229α, the signal supplied from the driver 12 to the third branch portion 239γ of the second source wiring line 228β is supplied to the first pixel TFT 225α2. In synchronization with this timing, when the first pixel TFT 225α2 is driven by the signal supplied from the first gate wiring line 227α, the signal from the first control TFT 224α2 is supplied to the first pixel electrode 226α2, and the first pixel electrode 226α2 is charged. When the fourth control TFT 224δ2 is driven by the signal supplied from the fourth control wiring line 229δ, the signal supplied from the driver 12 to the fourth branch portion 239δ of the second source wiring line 228β is supplied to the fourth pixel TFT 225δ2. In synchronization with this timing, when the fourth pixel TFT 225δ2 is driven by the signal supplied from the second gate wiring line 227β, the signal from the fourth control TFT 224δ2 is supplied to the fourth pixel electrode 226δ2, and the fourth pixel electrode 226δ2 is charged.

In this manner, the signal supplied from the driver 12 to the second source wiring line 228β is distributed to the third branch portion 239γ and the fourth branch portion 239δ, and is supplied to the first control TFT 224α2 connected with the third branch portion 239γ, and the second control TFT 224β2 and the fourth control TFT 224δ2 connected with the fourth branch portion 239δ, respectively. The second pixel electrode 226β2, the first pixel electrode 226α2, and the fourth pixel electrode 226δ2 are respectively charged to a potential relating to the signals supplied to the second source wiring line 228β. Since signals supplied from the driver 12 to the first source wiring line 228α and the second source wiring line 228β are opposite in polarity, the first pixel electrode 226α1, the second pixel electrode 226β1, the third pixel electrode 226γ1, and the fourth pixel electrode 226δ1, and the second pixel electrode 226β2, the first pixel electrode 226α2, and the fourth pixel electrode 226δ2 are opposite in polarity to each other. Since the second pixel electrode 226β2 is arranged to be interposed between the first pixel electrode 226α1 and the second pixel electrode 226β1 in the first direction, the first pixel electrode 226α2 is interposed between the first pixel electrode 226α1 and the third pixel electrode 226γ1 in the first direction, and the fourth pixel electrode 226δ2 is interposed between the second pixel electrode 226β1 and the fourth pixel electrode 226δ1 in the first direction, striped unevenness becomes less likely to be visually recognized as compared with a case in which the second pixel electrode 226β2, the first pixel electrode 226α2, and the fourth pixel electrode 226δ2 are set to have the same polarity as the first pixel electrode 226α1, the second pixel electrode 226β1, the third pixel electrode 226γ1, and the fourth pixel electrode 226δ1.

### Fourth Embodiment

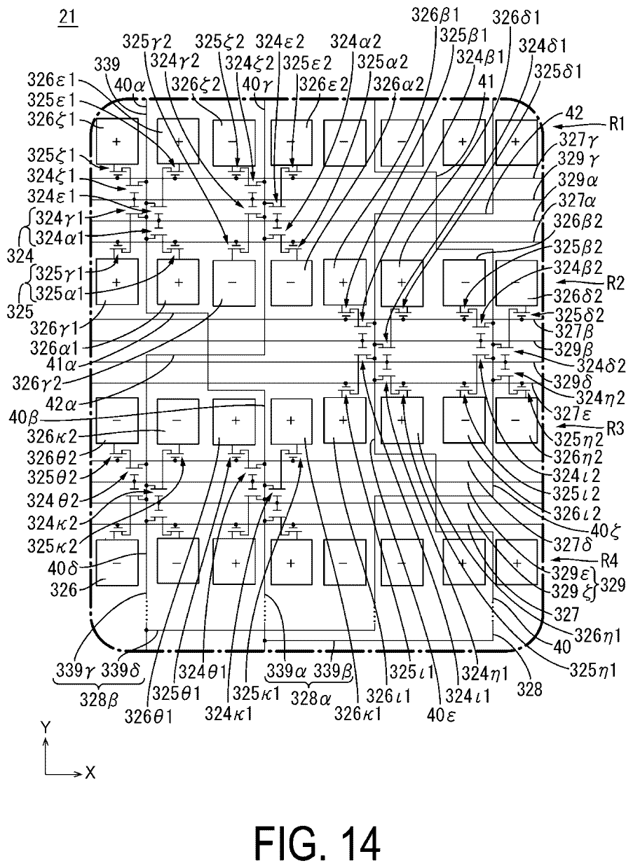

A fourth embodiment will be described with reference to FIGS. 14 to 16. In the fourth embodiment, a case in which the configuration of a source wiring line 328 is changed from the second embodiment will be illustrated. Further, repetitive descriptions of structures, actions, and effects similar to those of the second embodiment described above will be omitted.

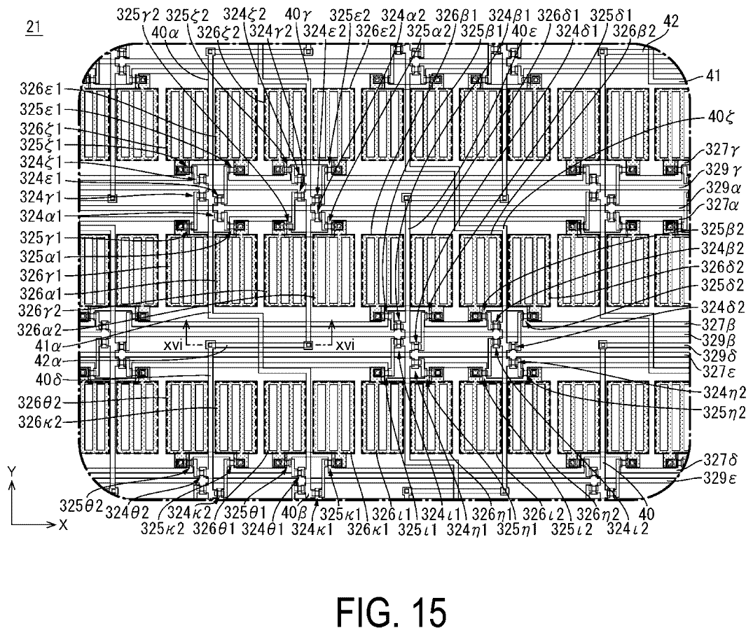

As illustrated in FIGS. 14 and 15, the source wiring line 328 according to the present embodiment has the configuration in which the source wiring line 328 is repeatedly bent at an intermediate portion in a display region AA. A branch portion 339 included in the source wiring line 328 includes a plurality of wiring line portions 40 extending along a Y-axis direction. The wiring line portion 40 is formed of a part of the second metal film and has a length sufficient to traverse (cross) two pixel electrode rows. Accordingly, the wiring line portion 40 is set in a relationship to intersect with at least two gate wiring lines 327 and two control wiring lines 329. In the wiring line portion 40, a plurality (four) of control TFTs 324 are connected. The plurality of wiring line portions 40 constituting one branch portion 339 are arrayed in a zig-zag shape in a plan view. Specifically, the wiring line portion 40 located at an odd-numbered position counted from an upper stage side in the Y-axis direction and the wiring line portion 40 located at an even-numbered position are arranged with a space corresponding to about two pixel electrode columns in an X-axis direction. The plurality of wiring line portions 40 located at odd-numbered positions are arranged to form a straight line with a space in the Y-axis direction, and the plurality of wiring line portions 40 can be said to be located in the same column. The plurality of wiring line portions 40 located at even-numbered positions are arranged to form a straight line with a space in the Y-axis direction, and the plurality of wiring line portions 40 can be said to be located in the same column.

The wiring line portion 40 located at a (2n−1)-th position counted from the upper stage side in the Y-axis direction and the wiring line portion 40 located at a (2n)-th position are connected by bridging portions 41 and 42 constituting the branch portion 339 (n: natural number). The bridging portions 41 and 42 include at least portions extending along the X-axis direction, one end of which is connected to an end of the wiring line portion 40 located at the (2n−1)-th position, and the other end of which is connected to an end of the wiring line portion 40 located at the (2n)-th position. The bridging portions 41 and 42 are arranged in a region between the two adjacent pixel electrode rows spaced in the Y-axis direction, that is, in an arrangement space of the gate wiring lines 327 and the control wiring lines 329. As illustrated in FIG. 15, the bridging portions 41 and 42 include two types, the bridging portion 41 formed of a part of the second metal film and the bridging portion 42 formed of a part of a first metal film. The bridging portion 41 formed of a part of the second metal film is directly connected to the wiring line portion 40 formed of a part of the second metal film. The bridging portion 41 extends along the X-axis direction for a predetermined length (about one pixel electrode column) from one of the wiring line portions 40 to be connected, is then bent, and intersects with the two gate wiring lines 327 and the two control wiring lines 329 while extending along the Y-axis direction. The bridging portion 41 extends along the Y-axis direction, is then bent again, extends along the X-axis direction for a predetermined length (about one pixel electrode column), and is connected to the other wiring line portion 40 to be connected.

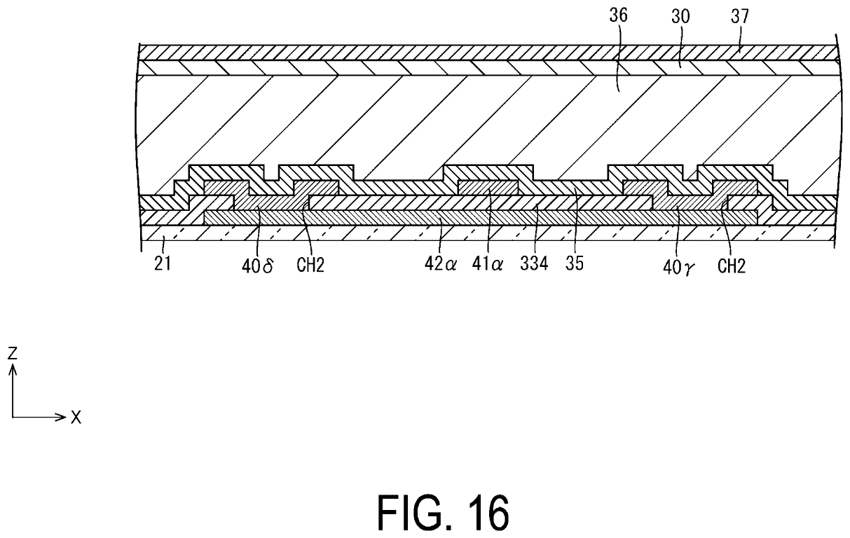

As illustrated in FIG. 15, the bridging portion 42 formed of a part of the first metal film extends along the X-axis direction, and the end thereof is arranged to overlap the end of the wiring line portion 40 formed of a part of the second metal film. As illustrated in FIG. 16, the bridging portion 42 formed of a part of the first metal film is connected to the wiring line portion 40 formed of a part of the second metal film via a source contact hole CH2 provided in a gate insulating film 334 interposed between the bridging portion 42 and the wiring line portion 40. Of the wiring line portions 40, a portion connected to the bridging portion 42 intersects with one gate wiring line 327 and one control wiring line 329.

As illustrated in FIG. 14, a first branch portion 339α included in a first source wiring line 328α and a third branch portion 339γ included in a second source wiring line 328β are set in a relationship in which the wiring line portions 40 thereof are located in the same column and the bridging portions 41 and 42 thereof intersect with each other. That is, the first branch portion 339α and the third branch portion 339γ are arranged to form a ladder shape in a plan view. In more detail, the wiring line portions 40 at odd-numbered positions constituting the first branch portion 339α and the wiring line portions 40 at even-numbered positions constituting the third branch portion 339γ are arranged to form a straight line with a space in the Y-axis direction and are located in the same column. Similarly, the wiring line portions 40 at even-numbered positions constituting the first branch portion 339α and the wiring line portions 40 at odd-numbered positions constituting the third branch portion 339γ are arranged to form a straight line with a space in the Y-axis direction and are located in the same column. The bridging portion 41 or the bridging portion 42 connecting the wiring line portion 40 at the (2n−1)-th position constituting the first branch portion 339α and the wiring line portion 40 at the (2n)-th position constituting the first branch portion 339α and the bridging portion 42 or the bridging portion 41 connecting the wiring line portion 40 at the (2n−1)-th position constituting the third branch portion 339γ and the wiring line portion 40 at the (2n)-th position constituting the third branch portion 339γ, intersect with each other and the gate insulating film 334 interposed between one of the bridging portion 41 and the bridging portion 42 and the other thereof (see FIG. 16).

As illustrated in FIG. 14, a second branch portion 339β included in the first source wiring line 328α and a fourth branch portion 339δ included in the second source wiring line 328β are set in a relationship in which the wiring line portions 40 are located in the same column with each other and the bridging portions 41 and 42 intersect with each other. That is, the second branch portion 339β and the fourth branch portion 339δ are arranged to form a ladder shape in a plan view. The second branch portion 339β and the fourth branch portion 339δ are arranged at positions spaced apart by a degree of two pixel electrode columns in the X-axis direction with respect to the first branch portion 339α and the third branch portion 339γ. In more detail, the wiring line portions 40 at odd-numbered positions constituting the second branch portion 339β and the wiring line portions 40 at even-numbered positions constituting the fourth branch portion 339δ are arranged to form a straight line with a space in the Y-axis direction and are located in the same column. Similarly, the wiring line portions 40 at even-numbered positions constituting the second branch portion 339β and the wiring line portions 40 at odd-numbered positions constituting the fourth branch portion 339δ are arranged to form a straight line with a space in the Y-axis direction and are located in the same column. The bridging portion 41 or the bridging portion 42 connecting the wiring line portion 40 at the (2n−1)-th position constituting the second branch portion 339β and the wiring line portion 40 at the (2n)-th position constituting the second branch portion 339β, and the bridging portion 42 or the bridging portion 41 connecting the wiring line portion 40 at the (2n−1)-th position constituting the fourth branch portion 339δ and the wiring line portion 40 at the (2n)-th position constituting the fourth branch portion 339δ intersect with each other with the gate insulating film 334 interposed between one of the bridging portion 41 and the bridging portion 42 and the other thereof (see FIG. 16).

In the following description, the uppermost pixel electrode row in FIG. 14 is referred to as a “first pixel electrode row R1”, the second pixel electrode row from the top in FIG. 14 is referred to as a “second pixel electrode row (first pixel electrode row) R2”, the third pixel electrode row from the top in FIG. 14 is referred to as a “third pixel electrode row (second pixel electrode row) R3”, and the fourth pixel electrode row from the top in FIG. 14 is referred to as a “fourth pixel electrode row R4”.

In addition to the first gate wiring line 327α, the second gate wiring line 327β, and the third gate wiring line 327γ, when a plurality of the gate wiring lines 327 are distinguished, the gate wiring line 327 adjacent to the second pixel electrode row R2 on the lower side in FIG. 14 is referred to as a “fourth gate wiring line (fourth scanning wiring line)” with a suffix “δ” attached to the reference numeral, and the gate wiring line 327 interposed between the third pixel electrode row R3 and a fourth control wiring line 329δ is referred to as a “fifth gate wiring line (fifth scanning wiring line)” with a suffix “ϵ” attached to the reference numeral, and when the gate wiring lines 327 are collectively referred to without distinction, no suffixes “α to ϵ” are attached to the reference numerals.

A fourth gate wiring line 327δ is arranged with the third pixel electrode row R3 interposed between the second gate wiring line 327β, a second control wiring line 329β, and the fourth control wiring line 329δ in the Y-axis direction. A fifth gate wiring line 327ϵ is arranged with the second pixel electrode row R2 and the third pixel electrode row R3 interposed in the Y-axis direction.

In addition to a first control wiring line 329α, the second control wiring line 329β, a third control wiring line 329γ, and the fourth control wiring line 329δ, when a plurality of the control wiring lines 329 are distinguished, the control wiring line 329 arranged with the fourth gate wiring line 327δ interposed between the control wiring line 329 and the second pixel electrode row R2 is referred to as a “fifth control wiring line” with a suffix “ϵ” attached to the reference numeral, and the control wiring line 329 arranged with a fifth control wiring line 329ϵ interposed between the control wiring line 329 and the fourth gate wiring line 327δ is referred to as a “sixth control wiring line” with a suffix “ζ” attached to the reference numeral, and when the control wiring lines 329 are collectively referred to without distinction, no suffixes “α to ζ” are attached to the reference numerals.

The fifth control wiring line 329ϵ is arranged with a space from the fourth gate wiring line 327δ without the third pixel electrode row R3 being interposed between the fifth control wiring line 329ϵ and the fourth gate wiring line 327δ. The sixth control wiring line 329ζ is arranged with a space from the fourth gate wiring line 327δ and the fifth control wiring line 329ϵ without the third pixel electrode row R3 being interposed between the sixth control wiring line 329ζ and the fourth gate wiring line 327δ and the fifth control wiring line 329ϵ.

In addition to a first control TFT 324α, a second control TFT 324β, a third control TFT 324γ, a fourth control TFT 324δ, a fifth control TFT 324ϵ, and a sixth control TFT 324ζ, when a plurality of the control TFTs 324 are distinguished, the control TFT 324 connected to the fourth control wiring line 329δ and a pixel TFT 325 (seventh pixel TFT 325η) to be connected to a pixel electrode 326 (seventh pixel electrode 326η) belonging to the third pixel electrode row R3 is referred to as a “seventh control TFT” with a suffix “η” attached to the reference numeral, the control TFT 324 connected to the fifth control wiring line 329ϵ and a pixel TFT 325 (eighth pixel TFT 325θ) to be connected to a pixel electrode 326 (eighth pixel electrode 326θ) belonging to the third pixel electrode row R3 is referred to as an “eighth control TFT (twenty-fifth switching element, twenty-ninth switching element)” with a suffix “θ” attached to the reference numeral, the control TFT 324 connected to the second control wiring line 329β and a pixel TFT 325 (ninth pixel TFT 325ι) to be connected to a pixel electrode 326 (ninth pixel electrode 326ι) belonging to the third pixel electrode row R3 is referred to as a “ninth control TFT” with a suffix “ι” attached to the reference numeral, and the control TFT 324 connected to the sixth control wiring line 329ζ and a pixel TFT 325 (tenth pixel TFT 325κ) to be connected to a pixel electrode 326 (tenth pixel electrode 326κ) belonging to the third pixel electrode row R3 is referred to as a “tenth control TFT (twenty-seventh switching element, thirty-first switching element)” with a suffix “κ” attached to the reference numeral, and when the control TFTs 324 are collectively referred to without distinction, no suffixes “α to κ” are attached to the reference numerals.

In addition to a first pixel TFT 325α, a second pixel TFT 325β, a third pixel TFT 325γ, a fourth pixel TFT 325δ, a fifth pixel TFT 325ϵ, and a sixth pixel TFT 325ζ, when a plurality of the pixel TFTs 325 are distinguished, the pixel TFT 325 connected to a seventh control TFT 324η, the fifth gate wiring line 327ϵ, and the pixel electrode 326 (seventh pixel electrode 326η) belonging to the third pixel electrode row R3 is referred to as a “seventh pixel TFT” with a suffix “η” attached to the reference numeral, the pixel TFT 325 connected to an eighth control TFT 324θ, the fourth gate wiring line 327δ, and the pixel electrode 326 (eighth pixel electrode 326θ) belonging to the third pixel electrode row R3 is referred to as an “eighth pixel TFT” with a suffix “θ” attached to the reference numeral, the pixel TFT 325 connected to a ninth control TFT 324ι, the fifth gate wiring line 327ϵ, and the pixel electrode 326 (ninth pixel electrode 326ι) belonging to the third pixel electrode row R3 is referred to as a “ninth pixel TFT” with a suffix “ι” attached to the reference numeral, and the pixel TFT 325 connected to the tenth control TFT 324κ, the fourth gate wiring line 327δ, and the pixel electrode 326 (tenth pixel electrode 326κ) belonging to the third pixel electrode row R3 is referred to as a “tenth pixel TFT” with a suffix “κ” attached to the reference numeral, and when the pixel TFTs 325 are collectively referred to without distinction, no suffixes “α to κ” are attached to the reference numerals.

In addition to the first pixel electrode 326α, the second pixel electrode 326β, the third pixel electrode 326γ, a fourth pixel electrode 326δ, a fifth pixel electrode 326ϵ, and a sixth pixel electrode 326ζ, when a plurality of the pixel electrodes 326 are distinguished, the pixel electrode 326 belonging to the third pixel electrode row R3 and connected to the seventh pixel TFT 325η is referred to as a “seventh pixel electrode” with a suffix “η” attached to the reference numeral, the pixel electrode 326 belonging to the third pixel electrode row R3 and connected to the eighth pixel TFT 325θ is referred to as an “eighth pixel electrode” with a suffix “θ” attached to the reference numeral, the pixel electrode 326 belonging to the third pixel electrode row R3 and connected to the ninth pixel TFT 325ι is referred to as a “ninth pixel electrode” with a suffix “ι” attached to the reference numeral, and the pixel electrode 326 belonging to the third pixel electrode row R3 and connected to the tenth pixel TFT 325κ is referred to as a “tenth pixel electrode (fourteenth pixel electrode, sixteenth pixel electrode)” with a suffix “κ” attached to the reference numeral, and when the pixel electrodes 326 are collectively referred to without distinction, no suffixes “α to κ” are attached to the reference numerals.

A first pixel electrode 326α1 and a third pixel electrode 326γ1 constitute the second pixel electrode row R2 and are arranged with a first wiring line portion 40α interposed between the first pixel electrode 326α1 and the third pixel electrode 326γ1 in the X-axis direction. A first pixel electrode (eleventh pixel electrode) 326α2 and a third pixel electrode (twelfth pixel electrode) 326γ2 constitute the second pixel electrode row R2 and are arranged with a third wiring line portion 40γ interposed between the first pixel electrode 326α2 and the third pixel electrode 326γ2 in the X-axis direction. An eighth pixel electrode (thirteenth pixel electrode) 326θ1 and a tenth pixel electrode (fourteenth pixel electrode) 326κ1 constitute the third pixel electrode row R3, and are arranged with a second wiring line portion 40β interposed between the eighth pixel electrode 326θ1 and the tenth pixel electrode 326κ1 in the X-axis direction. An eighth pixel electrode (fifteenth pixel electrode) 326θ2 and a tenth pixel electrode (sixteenth pixel electrode) 326κ2 constitute the third pixel electrode row R3, and are arranged with a fourth wiring line portion 40δ interposed between the eighth pixel electrode 326θ2 and the tenth pixel electrode 326κ2 in the X-axis direction. A second pixel electrode 326β1 and a fourth pixel electrode 326δ1 constitute the second pixel electrode row R2 and are arranged with a fifth wiring line portion 40ϵ interposed between the second pixel electrode 326β1 and the fourth pixel electrode 326δ1 in the X-axis direction. A second pixel electrode 326β2 and a fourth pixel electrode 326δ2 constitute the second pixel electrode row R2 and are arranged with a sixth wiring line portion 40ζ interposed between the second pixel electrode 326β2 and the fourth pixel electrode 326δ2 in the X-axis direction. A seventh pixel electrode 326η1 and a ninth pixel electrode 326ι1 constitute the third pixel electrode row R3 and are arranged with the fifth wiring line portion 40ϵ interposed between the seventh pixel electrode 326η1 and the ninth pixel electrode 326ι1 in the X-axis direction. A seventh pixel electrode 326η2 and a ninth pixel electrode 326ι2 constitute the third pixel electrode row R3 and are arranged with the sixth wiring line portion 40ζ interposed between the seventh pixel electrode 326η2 and the ninth pixel electrode 326ι2 in the X-axis direction.

In addition, in a case in which a plurality of the pixel TFTs 325α to 325κ are distinguished, the pixel TFTs 325α to 325κ connected to the first source wiring line 328α are classified into a “first group” with a suffix “1” attached to the reference numerals, the pixel TFTs 325α to 325κ connected to the second source wiring line 328β are classified into a “second group” with a suffix “2” attached to the reference numerals, and in a case in which the pixel TFTs 325α to 325κ are collectively referred to without distinction, no suffixes “1, 2” are attached to the reference numerals.

In addition, in a case in which a plurality of the control TFTs 324α to 324κ are distinguished, the control TFTs 324α to 324κ connected to pixel TFTs 325α1 to 325κ1 belonging to a first group are classified into a “first group” with a suffix “1” attached to the reference numerals, the control TFTs 324α to 324κ connected to pixel TFTs 325α2 to 325κ2 belonging to a second group are classified into a “second group” with a suffix “2” attached to the reference numerals, and in a case in which the control TFTs 324α to 324κ are collectively referred to without distinction, no suffixes “1, 2” are attached to the reference numerals.

In a case in which the plurality of wiring line portions 40 are distinguished, the wiring line portion 40 connected to a first control TFT 324α1, a third control TFT 324γ1, a fifth control TFT 324ϵ1, and a sixth control TFT 324ζ1 is referred to as a “first wiring line portion” with a suffix “α” attached to the reference numeral, the wiring line portion 40 connected to an eighth control TFT 324θ1 and a tenth control TFT 324κ1 is referred to as a “second wiring line portion” with a suffix “β” attached to the reference numeral, the wiring line portion 40 connected to a first control TFT 324α2, a third control TFT 324γ2, a fifth control TFT 324ϵ2, and a sixth control TFT 324ζ2 is referred to as a “third wiring line portion” with a suffix “γ” attached to the reference numeral, the wiring line portion 40 connected to an eighth control TFT 324θ2 and a tenth control TFT 324κ2 is referred to as a “fourth wiring line portion” with a suffix “δ” attached to the reference numeral, the wiring line portion 40 connected to a second control TFT 324β1, a fourth control TFT 324δ1, a seventh control TFT 324η1, and a ninth control TFT 324ι1 is referred to as a “fifth wiring line portion” with a suffix “ϵ” attached to the reference numeral, the wiring line portion 40 connected to a second control TFT 324β2, a fourth control TFT 324δ2, a seventh control TFT 324η2, and a ninth control TFT 324ι2 is referred to as a “sixth wiring line portion” with a suffix “ζ” attached to the reference numeral, and in a case in which the wiring line portions 40 are collectively referred to without distinction, no suffixes “α to ζ” are attached to the reference numerals.

The first wiring line portion 40α crosses the first pixel electrode row R1 and the second pixel electrode row R2, and the second wiring line portion 40β crosses the third pixel electrode row R3 and the fourth pixel electrode row R4. The third wiring line portion 40γ crosses the first pixel electrode row R1 and the second pixel electrode row R2 and is located in the same column as the second wiring line portion 40β. The fourth wiring line portion 40δ crosses the third pixel electrode row R3 and the fourth pixel electrode row R4 and is located in the same column as the first wiring line portion 40α. The fifth wiring line portion 40ϵ and the sixth wiring line portion 40ζ both cross the second pixel electrode row R2 and the third pixel electrode row R3.

In a case in which a plurality of the bridging portions 41 and 42 are distinguished, the bridging portion 41 connecting the first wiring line portion 40α and the second wiring line portion 40β is referred to as a “first bridging portion” with a suffix “α” attached to the reference numeral, and the bridging portion 42 connecting the third wiring line portion 40γ and the fourth wiring line portion 40δ is referred to as a “second bridging portion” with a suffix “α” attached to the reference numeral, and in a case in which the bridging portions 41 and 42 are collectively referred to without distinction, no suffix “α” is attached to the reference numerals.

In the present embodiment, of the control TFTs 324α1 to 324κ1 connected to the first source wiring line 328α, the first control TFT 324α1, the third control TFT 324γ1, the fifth control TFT 324ϵ1, and the sixth control TFT 324ζ1 are, as illustrated in FIGS. 14 and 15, connected to the first wiring line portion 40α constituting the first branch portion 339α, while the eighth control TFT 324θ1 and the tenth control TFT 324κ1 are connected to the second wiring line portion 40β constituting the first branch portion 339α. On the other hand, the second control TFT 324β1, the fourth control TFT 324δ1, the seventh control TFT 324η1, and the ninth control TFT 324ι1 are connected to the fifth wiring line portion 40ϵ constituting the second branch portion 339β.

The eighth control TFT 324θ1 and the tenth control TFT 324κ1 connected to the second wiring line portion 40β are, as illustrated in FIGS. 14 and 15, arranged at positions shifted by two pixel electrode columns in the X-axis direction and by one pixel electrode row in the Y-axis direction with respect to the first control TFT 324α1, the third control TFT 324γ1, the fifth control TFT 324ϵ1, and the sixth control TFT 324ζ1 connected to the first wiring line portion 40α. Accordingly, the eighth pixel TFT 325θ1 and the tenth pixel TFT 325κ1 connected to the eighth control TFT 324θ1 and the tenth control TFT 324κ1 are arranged at positions shifted by two pixel electrode columns in the X-axis direction and by one pixel electrode row in the Y-axis direction with respect to the first pixel TFT 325α1, the third pixel TFT 325γ1, the fifth pixel TFT 325ϵ1, and the sixth pixel TFT 325ζ1 connected to the first control TFT 324α1, the third control TFT 324γ1, the fifth control TFT 324ϵ1, and the sixth control TFT 324ζ1. The eighth pixel electrode 326θ1 and the tenth pixel electrode 326κ1 connected to the eighth pixel TFT 325θ1 and the tenth pixel TFT 325κ1 are arranged at positions shifted by two pixel electrode columns in the X-axis direction and by one pixel electrode row in the Y-axis direction with respect to the first pixel electrode 326α1, the third pixel electrode 326γ1, a fifth pixel electrode 326ϵ1, and a sixth pixel electrode 326ζ1 connected to the first pixel TFT 325α1, the third pixel TFT 325γ1, the fifth pixel TFT 325ϵ1, and the sixth pixel TFT 325ζ1. The eighth pixel electrode 326θ1 constitutes a pixel electrode column adjacent in the X-axis direction to a pixel electrode column including the first pixel electrode 326α1 and the fifth pixel electrode 326ϵ1.

On the other hand, the second control TFT 324β1, the fourth control TFT 324δ1, the seventh control TFT 324η1, and the ninth control TFT 324ι1 connected to the fifth wiring line portion 40ϵ are, as illustrated in FIGS. 14 and 15, arranged with a space of two pixel electrode columns in the X-axis direction with respect to the first control TFT 324α1, the third control TFT 324γ1, the fifth control TFT 324ϵ1, and the sixth control TFT 324ζ1 connected to the first wiring line portion 40α, and arranged at positions shifted by one pixel electrode row in the Y-axis direction. Accordingly, the second pixel TFT 325β1, the fourth pixel TFT 325δ1, the seventh pixel TFT 325η1, and the ninth pixel TFT 325ι1 connected to the second control TFT 324β1, the fourth control TFT 324δ1, the seventh control TFT 324η1, and the ninth control TFT 324ι1 are arranged, with respect to the first pixel TFT 325α1, the third pixel TFT 325γ1, the fifth pixel TFT 325ϵ1, and the sixth pixel TFT 325ζ1 connected to the first control TFT 324α1, the third control TFT 324γ1, the fifth control TFT 324ϵ1, and the sixth control TFT 324ζ1, with a space of two pixel electrode columns in the X-axis direction, and arranged at positions shifted by one pixel electrode row in the Y-axis direction. The second pixel electrode 326β1, the fourth pixel electrode 326δ1, the seventh pixel electrode 326η1, and the ninth pixel electrode 326ι1 connected to the second pixel TFT 325β1, the fourth pixel TFT 325δ1, the seventh pixel TFT 325η1, and the ninth pixel TFT 325ι1 are arranged with a space of two pixel electrode columns (including the first pixel electrode 326α2, the third pixel electrode 326γ2, a fifth pixel electrode 326ϵ2, and a sixth pixel electrode 326ζ2) in the X-axis direction and are arranged at positions shifted by one pixel electrode row in the Y-axis direction with respect to the first pixel electrode 326α1, the third pixel electrode 326γ1, the fifth pixel electrode 326ϵ1, and the sixth pixel electrode 326ζ1 connected to the first pixel TFT 325α1, the third pixel TFT 325γ1, the fifth pixel TFT 325ϵ1, and the sixth pixel TFT 325ζ1.

Similarly, as illustrated in FIG. 14 and FIG. 15, of the control TFTs 324α2 to 324κ2 connected to the second source wiring line 328β, the first control TFT 324α2, the third control TFT 324γ2, the fifth control TFT 324ϵ2, and the sixth control TFT 324ζ2 are connected to the third wiring line portion 40γ constituting the third branch portion 339γ, and the eighth control TFT 324θ2 and the tenth control TFT 324κ2 are connected to the fourth wiring line portion 40δ constituting the third branch portion 339γ. On the other hand, the second control TFT 324β2, the fourth control TFT 324δ2, the seventh control TFT 324η2, and the ninth control TFT 324ι2 are connected to the sixth wiring line portion 40ζ constituting the fourth branch portion 339δ.

As illustrated in FIG. 14 and FIG. 15, the eighth control TFT 324θ2 and the tenth control TFT 324κ2 connected to the fourth wiring line portion 40δ are arranged at positions shifted by two pixel electrode columns in the X-axis direction and by one pixel electrode row in the Y-axis direction with respect to the first control TFT 324α2, the third control TFT 324γ2, the fifth control TFT 324ϵ2, and the sixth control TFT 324ζ2 connected to the third wiring line portion 40γ. Accordingly, the eighth pixel TFT 325θ2 and the tenth pixel TFT 325κ2 connected to the eighth control TFT 324θ2 and the tenth control TFT 324κ2 are arranged at positions shifted by two pixel electrode columns in the X-axis direction and by one pixel electrode row in the Y-axis direction with respect to the first pixel TFT 325α2, the third pixel TFT 325γ2, the fifth pixel TFT 325ϵ2, and the sixth pixel TFT 325ζ2 connected to the first control TFT 324α2, the third control TFT 324γ2, the fifth control TFT 324ϵ2, and the sixth control TFT 324ζ2. The eighth pixel electrode 326θ2 and the tenth pixel electrode 326κ2 connected to the eighth pixel TFT 325θ2 and the tenth pixel TFT 325κ2 are arranged at positions shifted by two pixel electrode columns in the X-axis direction and by one pixel electrode row in the Y-axis direction with respect to the first pixel electrode 326α2, the third pixel electrode 326γ2, the fifth pixel electrode 326ϵ2, and the sixth pixel electrode 326ζ2 connected to the first pixel TFT 325α2, the third pixel TFT 325γ2, the fifth pixel TFT 325ϵ2, and the sixth pixel TFT 325ζ2. The tenth pixel electrode 326κ2 constitutes a pixel electrode column adjacent to a pixel electrode column including the third pixel electrode 326γ2 and the sixth pixel electrode 326ζ2 in the X-axis direction.

On the other hand, as illustrated in FIG. 14 and FIG. 15, the second control TFT 324β2, the fourth control TFT 324δ2, the seventh control TFT 324η2, and the ninth control TFT 324ι2 connected to the sixth wiring line portion 40ζ are arranged with a space of two pixel electrode columns in the X-axis direction and at positions shifted by one pixel electrode row in the Y-axis direction with respect to the first control TFT 324α2, the third control TFT 324γ2, the fifth control TFT 324ϵ2, and the sixth control TFT 324ζ2 connected to the third wiring line portion 40γ. Accordingly, the second pixel TFT 325β2, the fourth pixel TFT 325δ2, the seventh pixel TFT 325η2, and the ninth pixel TFT 325ι2 connected to the second control TFT 324β2, the fourth control TFT 324δ2, the seventh control TFT 324η2, and the ninth control TFT 324ι2 are arranged with a space of two pixel electrode columns in the X-axis direction and at positions shifted by one pixel electrode row in the Y-axis direction with respect to the first pixel TFT 325α2, the third pixel TFT 325γ2, the fifth pixel TFT 325ϵ2, and the sixth pixel TFT 325ζ2 connected to the first control TFT 324α2, the third control TFT 324γ2, the fifth control TFT 324ϵ2, and the sixth control TFT 324ζ2. The second pixel electrode 326β2, the fourth pixel electrode 326δ2, the seventh pixel electrode 326η2, and the ninth pixel electrode 326ι2 connected to the second pixel TFT 325β2, the fourth pixel TFT 325δ2, the seventh pixel TFT 325η2, and the ninth pixel TFT 325ι2 are arranged with a space of two pixel electrode columns (including the second pixel electrode 326β2, the fourth pixel electrode 326δ2, the seventh pixel electrode 326η2, and the ninth pixel electrode 326ι2) in the X-axis direction and at positions shifted by one pixel electrode row in the Y-axis direction with respect to the first pixel electrode 326α2, the third pixel electrode 326γ2, the fifth pixel electrode 326ϵ2, and the sixth pixel electrode 326ζ2 connected to the first pixel TFT 325α2, the third pixel TFT 325γ2, the fifth pixel TFT 325ϵ2, and the sixth pixel TFT 325ζ2.

As illustrated in FIG. 14 and FIG. 15, the first pixel electrode 326α1, the third pixel electrode 326γ1, the fifth pixel electrode 326ϵ1, and the sixth pixel electrode 326ζ1 connected to the first pixel TFT 325α1, the third pixel TFT 325γ1, the fifth pixel TFT 325ϵ1, and the sixth pixel TFT 325ζ1 are arranged with the first wiring line portion 40α interposed between the first pixel electrode 326α1, the third pixel electrode 326γ1, the fifth pixel electrode 326ϵ1, and the sixth pixel electrode 326ζ1 in the X-axis direction. The eighth pixel electrode 326θ1 and the tenth pixel electrode 326κ1 connected to the eighth pixel TFT 325θ1 and the tenth pixel TFT 325κ1 are arranged with the second wiring line portion 40β interposed between the eighth pixel electrode 326θ1 and the tenth pixel electrode 326κ1 in the X-axis direction. The first pixel electrode 326α2, the third pixel electrode 326γ2, the fifth pixel electrode 326ϵ2, and the sixth pixel electrode 326ζ2 connected to the first pixel TFT 325α2, the third pixel TFT 325γ2, the fifth pixel TFT 325ϵ2, and the sixth pixel TFT 325ζ2 are arranged with the third wiring line portion 40γ interposed between the first pixel electrode 326α2, the third pixel electrode 326γ2, the fifth pixel electrode 326ϵ2, and the sixth pixel electrode 326ζ2 in the X-axis direction. The eighth pixel electrode 326θ2 and the tenth pixel electrode 326κ2 connected to the eighth pixel TFT 325θ2 and the tenth pixel TFT 325κ2 are arranged with the fourth wiring line portion 40δ interposed between the eighth pixel electrode 326θ2 and the tenth pixel electrode 326κ2 in the X-axis direction. The second pixel electrode 326β1, the fourth pixel electrode 326δ1, the seventh pixel electrode 326η1, and the ninth pixel electrode 326ι1 connected to the second pixel TFT 325β1, the fourth pixel TFT 325δ1, the seventh pixel TFT 325η1, and the ninth pixel TFT 325ι1 are arranged with the fifth wiring line portion 40ϵ interposed between the second pixel electrode 326β1, the fourth pixel electrode 326δ1, the seventh pixel electrode 326η1, and the ninth pixel electrode 326ι1 in the X-axis direction. The second pixel electrode 326β2, the fourth pixel electrode 326δ2, the seventh pixel electrode 326η2, and the ninth pixel electrode 326ι2 connected to the second pixel TFT 325β2, the fourth pixel TFT 325δ2, the seventh pixel TFT 325η2, and the ninth pixel TFT 325ι2 are arranged with the sixth wiring line portion 40ζ interposed between the second pixel electrode 326β2, the fourth pixel electrode 326δ2, the seventh pixel electrode 326η2, and the ninth pixel electrode 326ι2 in the X-axis direction.

As illustrated in FIG. 14 and FIG. 15, the image signal supplied from the driver 12 to the first source wiring line 328α is distributed to the first branch portion 339α (the first wiring line portion 40α and the second wiring line portion 40β) and the second branch portion 339β (fifth wiring line portion 40ϵ). The image signal supplied from the driver 12 to the second source wiring line 328β is distributed to the third branch portion 339γ (the third wiring line portion 40γ and the fourth wiring line portion 40δ) and the fourth branch portion 339δ (sixth wiring line portion 40ζ). When the high potential of the control signal is supplied to the first control wiring line 329α while the high potential of the scanning signal is supplied to the first gate wiring line 327α, the first control TFTs 324α1 and 324α2 and the first pixel TFTs 325α1 and 325α2 are selectively driven, respectively. Accordingly, the image signal transmitted by the first branch portion 339α is supplied to the first pixel electrode 326α1, and the image signal transmitted by the third branch portion 339γ is supplied to the first pixel electrode 326α2. When the high potential of the control signal is supplied to the second control wiring line 329β while the high potential of the scanning signal is supplied to the second gate wiring line 327β, the second control TFTs 324β1 and 324β2 and the second pixel TFTs 325β1 and 325β2 are selectively driven, respectively. Accordingly, the image signal transmitted by the second branch portion 339β is supplied to the second pixel electrode 326β1, and the image signal transmitted by the fourth branch portion 339δ is supplied to the second pixel electrode 326β2.

When the high potential of the control signal is supplied to the third control wiring line 329γ while the high potential of the scanning signal is supplied to the first gate wiring line 327α, the third control TFTs 324γ1 and 324γ2 and the third pixel TFTs 325γ1 and 325γ2 are selectively driven, respectively. Accordingly, the image signal transmitted by the first branch portion 339α is supplied to the third pixel electrode 326γ1, and the image signal transmitted by the third branch portion 339γ is supplied to the third pixel electrode 326γ2. When the high potential of the control signal is supplied to the fourth control wiring line 329δ while the high potential of the scanning signal is supplied to the second gate wiring line 327β, the fourth control TFTs 324δ1 and 324δ2 and the fourth pixel TFTs 325δ1 and 325δ2 are selectively driven, respectively. Accordingly, the image signal transmitted by the second branch portion 339β is supplied to the fourth pixel electrode 326δ1, and the image signal transmitted by the fourth branch portion 339δ is supplied to the fourth pixel electrode 326δ2.

When the high potential of the control signal is supplied to the first control wiring line 329α while the high potential of the scanning signal is supplied to the third gate wiring line 327γ, the fifth control TFTs 324ϵ1 and 324ϵ2 and the fifth pixel TFTs 325ϵ1 and 325ϵ2 are selectively driven, respectively. Accordingly, the image signal transmitted by the first branch portion 339α is supplied to the fifth pixel electrode 326ϵ1, and the image signal transmitted by the third branch portion 339γ is supplied to the fifth pixel electrode 326ϵ2. When the high potential of the control signal is supplied to the third control wiring line 329γ while the high potential of the scanning signal is supplied to the third gate wiring line 327γ, the sixth control TFTs 324ζ1 and 324ζ2 and the sixth pixel TFTs 325ζ1 and 325ζ2 are selectively driven, respectively. Accordingly, the image signal transmitted by the first branch portion 339α is supplied to the sixth pixel electrode 326ζ1, and the image signal transmitted by the third branch portion 339γ is supplied to the sixth pixel electrode 326ζ2.

When the high potential of the control signal is supplied to the fourth control wiring line 329δ while the high potential of the scanning signal is supplied to the fifth gate wiring line 327ϵ, the seventh control TFTs 324η1 and 324β2 and the seventh pixel TFTs 325η1 and 325η2 are selectively driven, respectively. Accordingly, the image signal transmitted by the second branch portion 339β is supplied to the seventh pixel electrode 326η1, and the image signal transmitted by the fourth branch portion 339δ is supplied to the seventh pixel electrode 326η2. When the high potential of the control signal is supplied to the fifth control wiring line 329ϵ while the high potential of the scanning signal is supplied to the fourth gate wiring line 327δ, the eighth control TFTs 324θ1 and 324θ2 and the eighth pixel TFTs 325θ1 and 325θ2 are selectively driven, respectively. Accordingly, the image signal transmitted by the first branch portion 339α is supplied to the eighth pixel electrode 326θ1, and the image signal transmitted by the third branch portion 339γ is supplied to the eighth pixel electrode 326θ2.

When the high potential of the control signal is supplied to the second control wiring line 329β while the high potential of the scanning signal is supplied to the fifth gate wiring line 327ϵ, the ninth control TFTs 324ι1 and 324ι2 and the ninth pixel TFTs 325ι1 and 325ι2 are selectively driven, respectively. Accordingly, the image signal transmitted by the second branch portion 339β is supplied to the ninth pixel electrode 326ι1, and the image signal transmitted by the fourth branch portion 339δ is supplied to the ninth pixel electrode 326ι2. When the high potential of the control signal is supplied to the sixth control wiring line 329ζ while the high potential of the scanning signal is supplied to the fourth gate wiring line 327δ, the tenth control TFTs 324κ1 and 324κ2 and the tenth pixel TFTs 325κ1 and 325κ2 are selectively driven, respectively. Accordingly, the image signal transmitted by the first branch portion 339α is supplied to the tenth pixel electrode 326κ1, and the image signal transmitted by the third branch portion 339γ is supplied to the tenth pixel electrode 326κ2.

In such a configuration, signals opposite in polarity to each other are supplied from the driver 12 to the first source wiring line 328α and the second source wiring line 328β. Note that, in FIG. 14, the positive and negative polarities of image signals supplied to the source wiring lines 328α and 328β are illustrated as symbols “+” and “−”, and the positive and negative polarities of image signals written into the pixel electrodes 326 are also illustrated as symbols “+” and “−”. In this manner, the first pixel electrode 326α1, the second pixel electrode 326β1, the third pixel electrode 326γ1, the fourth pixel electrode 326δ1, the fifth pixel electrode 326ϵ1, the sixth pixel electrode 326ζ1, the seventh pixel electrode 326η1, the eighth pixel electrode 326θ1, the ninth pixel electrode 326ι1, and the tenth pixel electrode 326κ1, which are charged to a potential relating to the image signal transmitted by the first source wiring line 328α, and the first pixel electrode 326α2, the second pixel electrode 326β2, the third pixel electrode 326γ2, the fourth pixel electrode 326δ2, the fifth pixel electrode 326ϵ2, the sixth pixel electrode 326ζ2, the seventh pixel electrode 326η2, the eighth pixel electrode 326θ2, the ninth pixel electrode 326ι2, and the tenth pixel electrode 326κ2, which are charged to a potential relating to the image signal transmitted by the second source wiring line 328β, are in a relationship opposite in polarity to each other.

The first pixel electrode 326α1 and the third pixel electrode 326γ1 to which the signal is supplied from the first source wiring line 328α, and the first pixel electrode 326α2 and the third pixel electrode 326γ2 to which the signal is supplied from the second source wiring line 328β are arranged side by side in the X-axis direction. The eighth pixel electrode 326θ1 and the tenth pixel electrode 326κ1 to which the signal is supplied from the first source wiring line 328α, and the eighth pixel electrode 326θ2 and the tenth pixel electrode 326κ2 to which the signal is supplied from the second source wiring line 328β are arranged side by side in the X-axis direction. The fifth pixel electrode 326ϵ1 and the sixth pixel electrode 326ζ1 to which the signal is supplied from the first source wiring line 328α, and the fifth pixel electrode 326ϵ2 and the sixth pixel electrode 326ζ2 to which the signal is supplied from the second source wiring line 328β are arranged side by side in the X-axis direction. The second pixel electrode 326β1 and the fourth pixel electrode 326δ1 to which the signal is supplied from the first source wiring line 328α, and the second pixel electrode 326β2 and the fourth pixel electrode 326δ2 to which the signal is supplied from the second source wiring line 328β are arranged side by side in the X-axis direction. The seventh pixel electrode 326η1 and the ninth pixel electrode 326ι1, to which signals are supplied from the first source wiring line 328α, and the seventh pixel electrode 326η2 and the ninth pixel electrode 326ι2, to which signals are supplied from the second source wiring line 328β, are arranged side by side in the X-axis direction.

The first pixel electrode 326α1 and the third pixel electrode 326γ1, to which signals are supplied from the first source wiring line 328α, and the eighth pixel electrode 326θ2 and the tenth pixel electrode 326κ2, to which signals are supplied from the second source wiring line 328β, are arranged side by side in the Y-axis direction. The first pixel electrode 326α2 and the third pixel electrode 326γ2, to which signals are supplied from the second source wiring line 328β, and the eighth pixel electrode 326θ1 and the tenth pixel electrode 326κ1, to which signals are supplied from the first source wiring line 328α, are arranged side by side in the Y-axis direction.

As described above, in the present embodiment, four pixel electrodes 326 in total, two by two adjacent to each other with one wiring line portion 40 interposed between the two pixel electrodes 326, are charged to a potential of the same polarity. The plurality of wiring line portions 40 constituting the first branch portion 339α and the plurality of wiring line portions 40 constituting the third branch portion 339γ form a zig-zag shape, the plurality of wiring line portions 40 constituting the second branch portion 339β and the plurality of wiring line portions 40 constituting the fourth branch portion 339δ form a zig-zag shape, the plurality of wiring line portions 40 constituting the first branch portion 339α and the plurality of wiring line portions 40 constituting the fourth branch portion 339δ are arranged at positions shifted by one pixel electrode row in the Y-axis direction, and the plurality of wiring line portions 40 constituting the second branch portion 339β and the plurality of wiring line portions 40 constituting the third branch portion 339γ are arranged at positions shifted by one pixel electrode row in the Y-axis direction. With such a configuration, the four pixel electrodes 326 charged to a potential of one polarity (for example, positive polarity) supplied from the first branch portion 339α and the four pixel electrodes 326 charged to a potential of the other polarity (for example, negative polarity) supplied from the third branch portion 339γ are aligned in the X-axis direction and the Y-axis direction. The four pixel electrodes 326 charged to a potential of one polarity (for example, positive polarity) supplied from the second branch portion 339β and the four pixel electrodes 326 charged to a potential of the other polarity (for example, negative polarity) supplied from the fourth branch portion 339δ are aligned in the X-axis direction and the Y-axis direction. The four pixel electrodes 326 charged to a potential of one polarity (for example, positive polarity) supplied from the first branch portion 339α and the four pixel electrodes 326 charged to a potential of the other polarity (for example, negative polarity) supplied from the fourth branch portion 339δ are arranged at positions shifted by one pixel electrode row in the Y-axis direction. The four pixel electrodes 326 charged to a potential of one polarity (for example, positive polarity) supplied from the second branch portion 339β and the four pixel electrodes 326 charged to a potential of the other polarity (for example, negative polarity) supplied from the third branch portion 339γ are arranged at positions shifted by one pixel electrode row in the Y-axis direction. As a result, striped unevenness is less likely to be visually recognized.

As described above, according to the present embodiment, there is provided the first pixel electrode 326α1, the second pixel electrode 326β1, the third pixel electrode 326γ1, and the fourth pixel electrode 326δ1 constituting the second pixel electrode row (first pixel electrode row) R2, the third pixel electrode row (second pixel electrode row) R3 composed of the plurality of pixel electrodes 326 arranged with at least the second gate wiring line 327β and the second control wiring line 329β interposed between the plurality of pixel electrodes 326 and the second pixel electrode row R2 in the second direction, and the second source wiring line 328β extending along the second direction, in which the first source wiring line 328α includes the first wiring line portion 40α crossing the second pixel electrode row R2 and extending along the second direction, the second wiring line portion 40β crossing the third pixel electrode row R3, extending along the second direction and arranged at a position spaced apart from the first wiring line portion 40α in the first direction, and the first bridging portion 41α connecting the first wiring line portion 40α and the second wiring line portion 40β, the second source wiring line 328β includes the third wiring line portion 40γ crossing the second pixel electrode row R2 and positioned in the same column as the second wiring line portion 40β and extending along the second direction, the fourth wiring line portion 40δ crossing the third pixel electrode row R3, extending along the second direction and positioned in the same column as the first wiring line portion 40α, and the second bridging portion 42α connecting the third wiring line portion 40γ and the fourth wiring line portion 40δ, the first pixel electrode 326α1 and the third pixel electrode 326γ1 are arranged with the first wiring line portion 40α interposed between the first pixel electrode 326α1 and the third pixel electrode 326γ1 in the first direction, the first pixel electrode (eleventh pixel electrode) 326α2 is arranged with a space from the third wiring line portion 40γ in the first direction, the third pixel electrode (twelfth pixel electrode) 326γ2 is arranged with the third wiring line portion 40γ interposed between the first pixel electrode 326α2 and the third pixel electrode 326γ2 in the first direction, the eighth pixel electrode (thirteenth pixel electrode) 326θ1 is the pixel electrode 326 constituting the third pixel electrode row R3 arranged with a space from the second wiring line portion 40β in the first direction, the tenth pixel electrode (fourteenth pixel electrode) 326κ1 is the pixel electrode 326 constituting the third pixel electrode row R3 arranged with the second wiring line portion 40β interposed between the eighth pixel electrode 326θ1 and the tenth pixel electrode 326κ1 in the first direction, the eighth pixel electrode (fifteenth pixel electrode) 326θ2 is the pixel electrode 326 constituting the third pixel electrode row R3 arranged with a space from the fourth wiring line portion 40δ in the first direction, the tenth pixel electrode (sixteenth pixel electrode) 326κ2 is the pixel electrode 326 constituting the third pixel electrode row R3 arranged with the fourth wiring line portion 40δ interposed between the eighth pixel electrode 326θ2 and the tenth pixel electrode 326κ2 in the first direction, the fourth gate wiring line (fourth scanning wiring line) 327δ extends along the first direction and is arranged with the third pixel electrode row R3 interposed between the second gate wiring line 327β, the second control wiring line 329β, the fourth control wiring line 329δ, and the fourth gate wiring line 327δ in the second direction, the fifth control wiring line 329ϵ extends along the first direction and arranged with a space from the fourth gate wiring line 327δ without the third pixel electrode row R3 being interposed between the fifth control wiring line 329ϵ and the fourth gate wiring line 327δ, the sixth control wiring line 329ζ extends along the first direction and arranged with a space from the fourth gate wiring line 327δ and the fifth control wiring line 329ϵ without the third pixel electrode row R3 being interposed between the fourth gate wiring line 327δ and the fifth control wiring line 329ϵ, the fifth gate wiring line (fifth scanning wiring line) 327ϵ extends along the first direction and is interposed between the second pixel electrode row R2 and the third pixel electrode row R3 in the second direction, the first control TFT (twenty-first switching element) 324α2 is connected to the first control wiring line 329α and the third wiring line portion 40γ, the first pixel TFT (twenty-second switching element) 325α2 is connected to the first gate wiring line 327α, the first control TFT 324α2, and the first pixel electrode 326α2, the third control TFT (twenty-third switching element) 324γ2 is connected to the third control wiring line 329γ and the third wiring line portion 40γ, the third pixel TFT (twenty-fourth switching element) 325γ2 is connected to the first gate wiring line 327α, the third control TFT 324γ2, and the third pixel electrode 326γ2, the eighth control TFT (twenty-fifth switching element) 324θ1 is connected to the fifth control wiring line 329ϵ and the second wiring line portion 40β, the eighth pixel TFT (twenty-sixth switching element) 325θ1 is connected to the fourth gate wiring line 327δ, the eighth control TFT 324θ1, and the eighth pixel electrode 326θ1, the tenth control TFT (twenty-seventh switching element) 324κ1 is connected to the sixth control wiring line 329ζ and the second wiring line portion 40β, the tenth pixel TFT (twenty-eighth switching element) 325κ1 is connected to the fourth gate wiring line 327δ, the tenth control TFT 324κ1, and the tenth pixel electrode 326κ1, the eighth control TFT (twenty-ninth switching element) 324θ2 is connected to the fifth control wiring line 329ϵ and the fourth wiring line portion 40δ, the eighth pixel TFT (thirtieth switching element) 325θ2 is connected to the fourth gate wiring line 327δ, the eighth control TFT 324θ2, and the eighth pixel electrode 326θ2, the tenth control TFT (thirty-first switching element) 324κ2 is connected to the sixth control wiring line 329ζ and the fourth wiring line portion 40δ, the tenth pixel TFT (thirty-second switching element) 325κ2 is connected to the fourth gate wiring line 327δ, the tenth control TFT 324κ2, and the tenth pixel electrode 326κ2, and a driver 12 is configured to supply signals opposite in polarity to each other to the first source wiring line 328α and the second source wiring line 328β.

In this manner, the signal supplied from the driver 12 to the first source wiring line 328α is supplied to the first wiring line portion 40α, the first bridging portion 41α, and the second wiring line portion 40β. The signal supplied to the first wiring line portion 40α is supplied to the first control TFT 324α1 and the third control TFT 324γ1. The signal supplied to the second wiring line portion 40β is supplied to the eighth control TFT 324θ1 and the tenth control TFT 324κ1. Accordingly, the first pixel electrode 326α1, the third pixel electrode 326γ1, the eighth pixel electrode 326θ1, and the tenth pixel electrode 326κ1 are respectively charged to a potential relating to the signal supplied to the first source wiring line 328α.

On the other hand, the signal supplied from the driver 12 to the second source wiring line 328β is supplied to the third wiring line portion 40γ, the second bridging portion 42α, and the fourth wiring line portion 40δ. The signal supplied to the third wiring line portion 40γ is supplied to the first control TFT 324α2 and the third control TFT 324γ2. The signal supplied to the fourth wiring line portion 40δ is supplied to the eighth control TFT 324θ2 and the tenth control TFT 324κ2. Accordingly, the first pixel electrode 326α2, the third pixel electrode 326γ2, the eighth pixel electrode 326θ2, and the tenth pixel electrode 326κ2 are respectively charged to a potential relating to the signal supplied to the second source wiring line 328β.

Since the signal supplied from the driver 12 to the first source wiring line 328α and the second source wiring line 328β are opposite in polarity, the first pixel electrode 326α1, the second pixel electrode 326β1, the third pixel electrode 326γ1, the fourth pixel electrode 326δ1, the eighth pixel electrode 326θ1, and the tenth pixel electrode 326κ1 and the first pixel electrode 326α2, the third pixel electrode 326γ2, the eighth pixel electrode 326θ2, and the tenth pixel electrode 326κ2 are opposite in polarity to each other. The first pixel electrode 326α1 and the third pixel electrode 326γ1 to which the signal is supplied from the first source wiring line 328α and the first pixel electrode 326α2 and the third pixel electrode 326γ2 to which the signal is supplied from the second source wiring line 328β are arranged side by side in the first direction. The eighth pixel electrode 326θ1 and the tenth pixel electrode 326κ1 to which the signal is supplied from the first source wiring line 328α and the eighth pixel electrode 326θ2 and the tenth pixel electrode 326κ2 to which the signal is supplied from the second source wiring line 328β are arranged side by side in the first direction. The first pixel electrode 326α1 and the third pixel electrode 326γ1 to which the signal is supplied from the first source wiring line 328α and the eighth pixel electrode 326θ2 and the tenth pixel electrode 326κ2 to which the signal is supplied from the second source wiring line 328β are arranged side by side in the second direction. The first pixel electrode 326α2 and the third pixel electrode 326γ2 to which the signal is supplied from the second source wiring line 328β and the eighth pixel electrode 326θ1 and the tenth pixel electrode 326κ1 to which the signal is supplied from the first source wiring line 328α are arranged side by side in the second direction. With the above arrangement, striped unevenness is less likely to be visually recognized.

### Fifth Embodiment

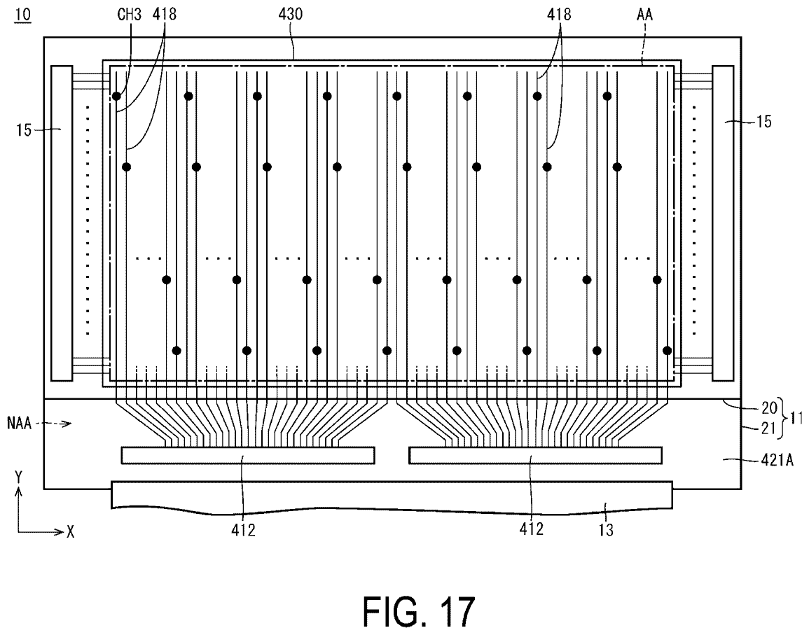

A fifth embodiment will be described with reference to FIGS. 17 to 20. In the fifth embodiment, a case in which the configuration of common wiring lines 418 are changed from the first embodiment will be illustrated. Further, repetitive descriptions of structures, actions, and effects similar to those of the first embodiment described above will be omitted.

The common wiring lines 418 according to the present embodiment are arranged in a display region AA as illustrated in FIG. 17. In more detail, the common wiring lines 418 extend along a Y-axis direction in a manner traversing the display region AA similarly to source wiring lines 428, and ends thereof are led out to an exposed portion 421A (non-display region NAA). The lead-out portions of the common wiring lines 418 are connected to terminal portions arranged in mounting region of a driver 412, and receive the common potential signals supplied from the driver 412 via the terminal portions.

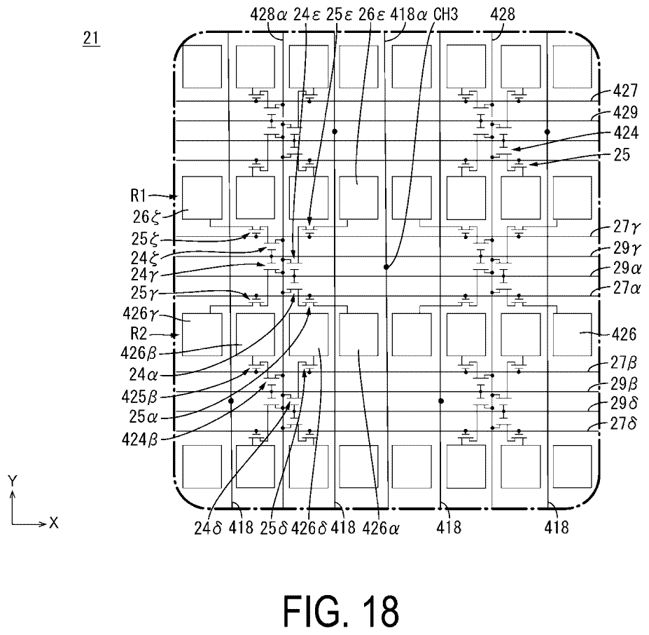

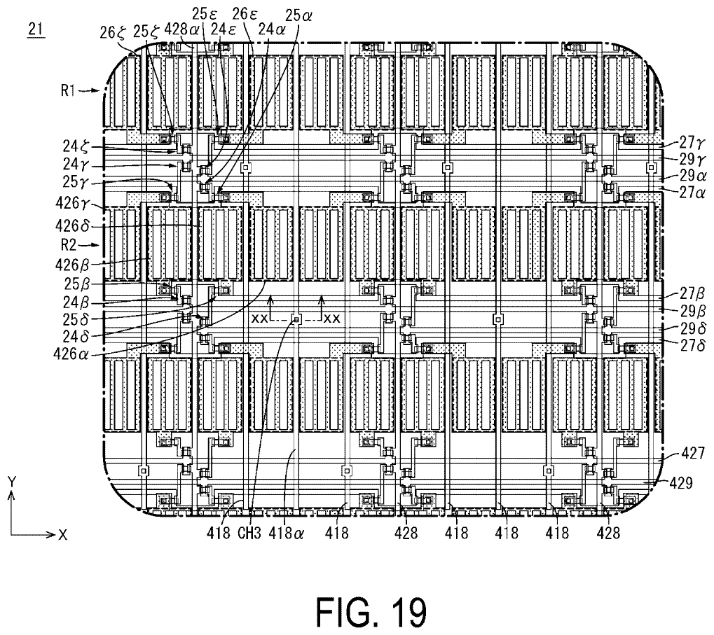

As illustrated in FIGS. 18 and 19, the common wiring lines 418 are arranged between pixel electrodes 426 adjacent to each other in an X-axis direction in the display region AA. In more detail, in regions opened between the plurality of pixel electrodes 426 arranged along the X-axis direction, each of the common wiring lines 418 is arranged in the regions in which the source wiring lines 428 are not arranged. The number of the common wiring lines 418 installed is about three-fourths of the number of the pixel electrodes 426 constituting a pixel electrode row and about three times the number of the source wiring lines 428 installed. The plurality of common wiring lines 418 include at least a first common wiring line 418α arranged with a first pixel electrode 426α interposed between the first common wiring line 418α and a first source wiring line 428α in the X-axis direction. The reason why a space for arranging the common wiring lines 418 can be secured in the display region AA is that, as described in the first embodiment, the signal supplied to the first source wiring line 428α is distributed to the first pixel electrode 426α, a second pixel electrode 426β, a third pixel electrode 426γ, and a fourth pixel electrode 426δ, and therefore the number of the source wiring lines 428 installed is reduced to about one-fourth of the number of the pixel electrodes 426 constituting the pixel electrode row.

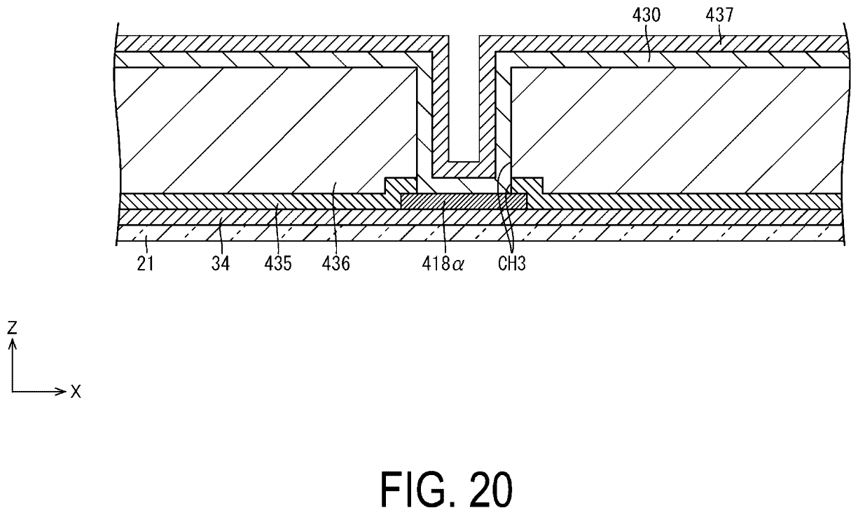

As illustrated in FIGS. 19 and 20, the common wiring line 418, similarly to the source wiring lines 428, is formed of a part of a second metal film. The common wiring line 418 is arranged to overlap a common electrode 430 and is arranged in the display region AA. In a first interlayer insulating film 435 and a flattening film 436 interposed between the common wiring line 418 and the common electrode 430, a common contact hole CH3 is provided at a position overlapping both the common wiring line 418 and the common electrode 430. The common wiring line 418 is connected to the common electrode 430 via the common contact hole CH3. Accordingly, the common potential signal output from the driver 412 to the common wiring line 418 can be supplied to the common electrode 430. Moreover, since the second metal film constituting the common wiring line 418 has a lower sheet resistance than a first transparent electrode film constituting the common electrode 430, by appropriately setting an arrangement of the common contact hole CH3 in the plane of the common electrode 430, the resistance distribution in the plane of the common electrode 430 can be reduced. Accordingly, the common electrode 430 can be stably kept at the common potential. Note that the number of common contact holes CH3 arranged to overlap one common wiring line 418 may be one or more.

As illustrated in FIG. 19, the common contact hole CH3 is arranged to be interposed between two adjacent control wiring lines 429 in the Y-axis direction without other wiring lines or the like being interposed. That is, the common contact hole CH3 is arranged by utilizing an arrangement space of control TFTs 424. Accordingly, since space efficiency of wiring lines or the like in the display region AA is improved, an aperture ratio of pixels is preferably improved. Note that the common wiring line 418 has a portion overlapping the common contact hole CH3 that is wider than that of other portions.

As described above, according to the present embodiment, the common electrode 430 arranged to overlap the first pixel electrode 426α and the second pixel electrode 426β via a second interlayer insulating film (insulating film) 437, and the common wiring line 418 extending along a second direction and connected to the common electrode 430 are included, and the common wiring line 418 includes at least the first common wiring line 418α arranged with the first pixel electrode 426α interposed between the first common wiring line 418α and the first source wiring line 428α in a first direction. The common electrode 430 is supplied with the common potential signal by the common wiring line 418. A potential difference based on the potential of the first pixel electrode 426α occurs between the first pixel electrode 426α and the common electrode 430, and an electric field is generated between the first pixel electrode 426α and the common electrode 430 by the potential difference. A potential difference based on the potential of the second pixel electrode 426β occurs between the second pixel electrode 426β and the common electrode 430, and an electric field is generated between the second pixel electrode 426β and the common electrode 430 by the potential difference. Since the signal supplied to the first source wiring line 428α is distributed to the first pixel electrode 426α and the second pixel electrode 426β, a space can be secured at a position with the first pixel electrode 426α interposed between the space and the first source wiring line 428α in the first direction, and the first common wiring line 418α can be arranged by utilizing the space.

### Sixth Embodiment

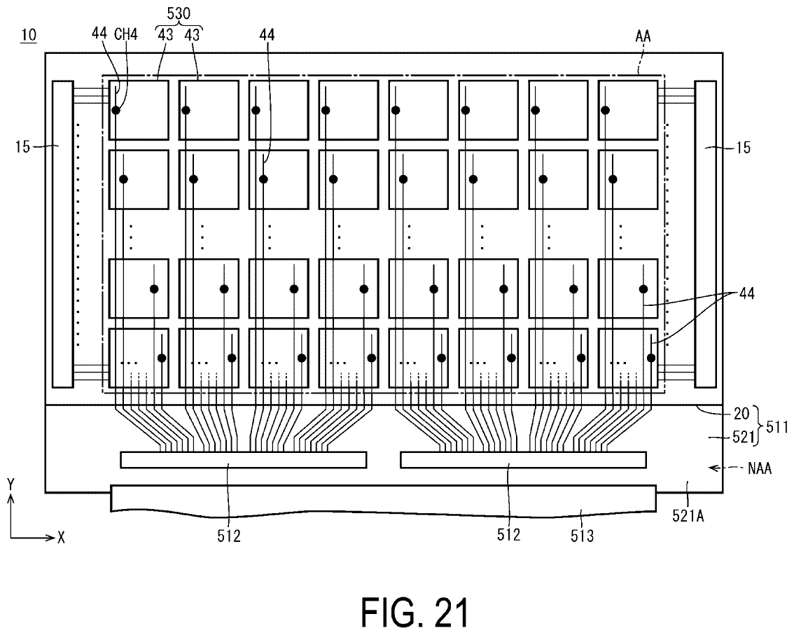

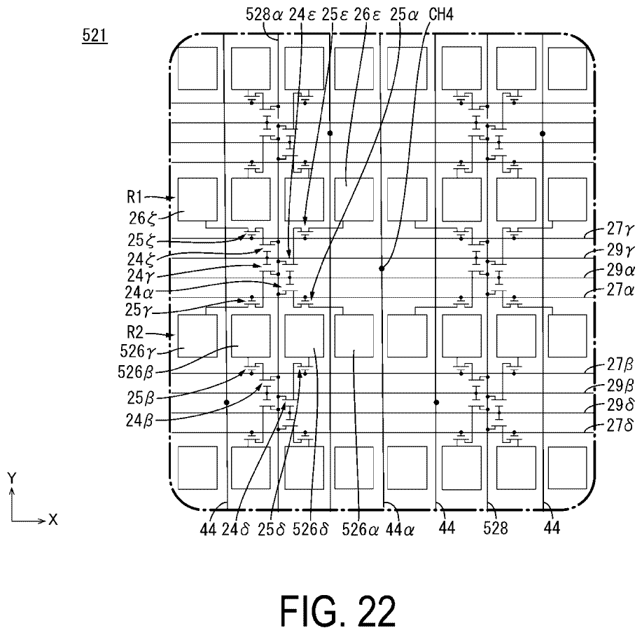

A sixth embodiment will now be described with reference to FIG. 21 or FIG. 22. In the sixth embodiment, a case in which a touch panel function is added to a liquid crystal panel 511 from the above-described fifth embodiment is illustrated. Repeated descriptions of structures, actions, and effects similar to those of the fifth embodiment described above will be omitted.

In the liquid crystal panel 511 according to the present embodiment, as illustrated in FIG. 21, in addition to a display function of displaying an image, the touch panel function (a position input function) of detecting an input position by a user is included. In the liquid crystal panel 511, a touch panel pattern for exhibiting the touch panel function is integrated (made in an in-cell form). The touch panel pattern is a so-called projected electrostatic capacitive type, and the detection type thereof is a self-capacitance type. The touch panel pattern is constituted by a plurality of touch electrodes (position detection electrodes) 43 arranged in a matrix shape in a main surface of the liquid crystal panel 511. The touch electrodes 43 are disposed in the display region AA of the liquid crystal panel 511. Thus, the display region AA of the liquid crystal panel 511 substantially coincides with a touch region (position input region) in which an input position is detectable, and the non-display region NAA substantially coincides with a non-touch region (non-position input region) in which an input position is not detectable. The touch electrodes 43 are constituted by dividing common electrodes 530 provided on an array substrate 521. Specifically, in the main surface of the array substrate 521, the common electrode 530 arranged generally in a solid-like pattern is provided with partition openings in a lattice pattern, and the plurality of touch electrodes 43 arranged in a checkerboard-like shape in an X-axis direction and a Y-axis direction are formed. Then, when a finger (position input body) as a conductor is brought close to a surface (display surface) of the liquid crystal panel 511 in an attempt to perform position input based on an image of the display region AA of the liquid crystal panel 511 visually recognized by a user, electrostatic capacitance is formed between the finger and the touch electrodes 43. Thus, in the electrostatic capacitance detected at the touch electrodes 43 near the finger, a change occurs as the finger approaches, and the change becomes different from that at the touch electrodes 43 far from the finger, and detection of the input position based on the change becomes possible. Note that, in addition to the illustration in FIG. 21, the specific number of the touch electrodes 43 installed is changeable as appropriate. The touch electrode 43 has a substantially rectangular shape when viewed in a plan view, and one side thereof has a dimension of approximately several millimeters. Thus, the touch electrodes 43 have a size in a plan view that is much larger than pixels described below, and are arranged in a range straddling a plurality of pixels in both the X-axis direction and the Y-axis direction.

As illustrated in FIG. 21, a plurality of touch wiring lines (position detection wiring lines) 44 provided in the liquid crystal panel 511 are selectively connected to the plurality of touch electrodes 43. The touch wiring lines 44, similar to a source wiring lines 528, extend along the Y-axis direction in a manner traversing the display region AA, and are connected to a specific one of the plurality of touch electrodes 43 aligned along the Y-axis direction in the display region AA. The touch wiring lines 44 have ends led out to an exposed portion 521A (non-display region NAA), and the lead-out portions are connected to terminal portions arranged in a mounting region of the driver 512. The touch wiring lines 44 are connected to a detection circuit via the above-described terminal portions. The detection circuit may be included in the driver 512, but may also be included outside the liquid crystal panel 511 via a flexible substrate 513. The touch wiring lines 44 receive the signal supplied from the driver 512 via the terminal portions arranged in the mounting region of the driver 512. The touch wiring lines 44 are configured such that a common potential signal relating to the image display function and a touch signal (position detection signal) relating to the touch panel function are supplied from the driver 512 in a time-division manner. A timing at which the common potential signal is supplied from the driver 512 to the touch wiring lines 44 is a display period, and a timing at which a touch signal is supplied from the driver 512 to the touch wiring lines 44 is a sensing period (position detection period). The common potential signal is transmitted to all the touch wiring lines 44 at the same timing (display period), and all the touch electrodes 43 function as the common electrode 530 with a reference potential based on the common potential signal. The touch electrodes 43 have the touch panel function and also have the function of the above-described common electrode 530. During the display period, a potential based on the image signal is charged to pixel electrodes 526, and during the display period, the touch electrodes 43 function as the common electrode 530.

As illustrated in FIG. 22, the touch wiring lines 44 are arranged between the pixel electrodes 526 adjacent to each other in the X-axis direction in the display region AA. In more detail, of regions opened between a plurality of the pixel electrodes 526 aligned along the X-axis direction, in regions where the source wiring lines 528 are not arranged, the touch wiring lines 44 are respectively arranged. The number of the touch wiring lines 44 installed is about three-fourths of the number of the pixel electrodes 526 constituting a pixel electrode row, and is about three times the number of source wiring lines 528 installed. The plurality of touch wiring lines 44 include at least a first touch wiring line 44α arranged with a first pixel electrode 526α interposed between a first source wiring line 528α and the first touch wiring line 44α in the X-axis direction. The reason why an arrangement space of the touch wiring lines 44 can be secured in the display region AA in this manner is that, as described in the above-described first embodiment, the signal supplied to the first source wiring line 528α is distributed to the first pixel electrode 526α, a second pixel electrode 526β, a third pixel electrode 526γ, and a fourth pixel electrode 526δ, and thus the number of the source wiring lines 528 installed is reduced to about one-fourth of the number of the pixel electrodes 526 constituting the pixel electrode row.

The touch wiring lines 44, similarly to the source wiring lines 528 and the common wiring lines 418 described in the fifth embodiment (see FIG. 19 and FIG. 20), are formed of a part of a second metal film. The touch wiring lines 44 are arranged to overlap the touch electrodes 43 in the display region AA. In a first interlayer insulating film 35 and a flattening film 36 interposed between the touch wiring line 44 and the touch electrode 43, a touch contact hole CH4 is provided at a position overlapping both the touch wiring line 44 and the touch electrode 43. The touch wiring line 44 is connected to the touch electrode 43 through the touch contact hole CH4. Accordingly, each signal output from the driver 412 to the touch wiring lines 44 can be supplied to the touch electrodes 43. The touch contact hole CH4 is arranged in the same manner as the common contact hole CH3 described in the fifth embodiment (see FIG. 19 and FIG. 20).

As described above, according to the present embodiment, there is provided the touch electrodes (position detection electrodes) 43 arranged to overlap at least the first pixel electrode 526α and the second pixel electrode 526β with an insulating film interposed between the touch electrodes 43 and at least the first pixel electrode 526α and the second pixel electrode 526β, and the touch wiring lines 44 (position detection wiring lines) extending along a second direction and connected to the touch electrodes 43, and the touch wiring lines 44 including at least a first touch wiring line 44α arranged with the first pixel electrode 526α interposed between the first touch wiring line 44α and the first source wiring line 528α in a first direction. To the touch electrodes 43, a position detection signal and a common potential signal are supplied through the touch wiring lines 44 in a time-division manner. At a timing when a common potential signal is supplied to the touch electrodes 43, a potential difference based on a potential of the first pixel electrode 526α occurs between the first pixel electrode 526α and the touch electrodes 43, and an electric field is generated between the first pixel electrode 526α and the touch electrodes 43 by the potential difference. At a timing when the common potential signal is supplied to the touch electrodes 43, a potential difference based on a potential of the second pixel electrode 526β occurs between the second pixel electrode 526β and the touch electrodes 43, and an electric field is generated between the second pixel electrode 526β and the touch electrodes 43 by the potential difference. At a timing when a position detection signal is supplied to the touch electrodes 43, position detection can be performed based on a potential of the touch electrodes 43. Since a signal supplied to the first source wiring line 528α is distributed to the first pixel electrode 526α and the second pixel electrode 526β, a space can be secured at a position interposing the first pixel electrode 526α between the first source wiring line 528α and the first touch wiring line 44α in the first direction, and the space can be used for arranging the first touch wiring line 44α.

### Seventh Embodiment

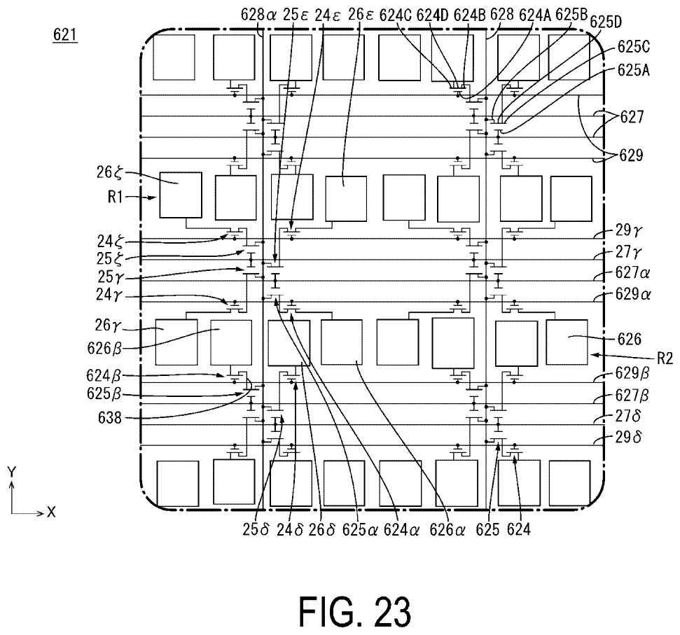

A seventh embodiment will be described with reference to FIG. 23. In the seventh embodiment, a case is illustrated in which connection objects of control TFTs 624 and pixel TFTs 625 are changed from the above-described first embodiment, and arrangements of the control TFTs 624, the pixel TFTs 625, gate wiring lines 627, and control wiring lines 629 are changed. Further, repetitive descriptions of structures, actions, and effects similar to those of the first embodiment described above will be omitted.

As illustrated in FIG. 23, the control wiring lines 629 according to the present embodiment are arranged with a space from pixel electrodes 626 without other wiring lines (including the gate wiring lines 627) being interposed in a Y-axis direction. That is, the control wiring lines 629 are arranged at positions closer to the pixel electrodes 626 than the gate wiring lines 627 in the Y-axis direction. In contrast, the gate wiring lines 627 are arranged at positions farther from the pixel electrodes 626 than the control wiring lines 629 in the Y-axis direction. For example, the two gate wiring lines 627 interposed between two pixel electrode rows are arranged to be interposed between the two control wiring lines 629.

As illustrated in FIG. 23, the control TFTs 624 according to the present embodiment are connected to the pixel electrodes 626, while the pixel TFTs 625 are connected to source wiring lines 628. In more detail, the pixel TFTs 625 are connected to the source wiring lines 628, the gate wiring lines 627, and the control TFTs 624. Of the pixel TFTs 625, a pixel gate electrode 625A is connected to the gate wiring lines 627, a pixel source electrode 625B is connected to the source wiring lines 628, and a pixel drain electrode 625C is connected to the control TFTs 624. The pixel TFTs 625 are arranged at positions spaced apart from the pixel electrodes 626 in the Y-axis direction and at positions adjacent to the source wiring lines 628 and the gate wiring lines 627 to be connected. The pixel TFTs 625 are arranged farther from the pixel electrodes 626 and the control wiring lines 629 (closer to the gate wiring lines 627) than the control TFTs 624 described below in the Y-axis direction. The pixel TFTs 625 are driven based on the scanning signal supplied to the gate wiring lines 627, and accordingly, an image signal supplied to the source wiring lines 628 can be supplied to the control TFTs 624.

As illustrated in FIG. 23, the control TFTs 624 are connected to the pixel TFTs 625, the pixel electrodes 626, and the control wiring lines 629. Of the control TFTs 624, a control gate electrode 624A is connected to the control wiring lines 629, a control source electrode 624B is connected to the pixel drain electrode 625C of the pixel TFT 625, and a control drain electrode 624C is connected to the pixel electrodes 626. The control TFTs 624 are arranged at positions spaced apart from the pixel electrodes 626 in the Y-axis direction and at positions adjacent to the pixel electrodes 626 and the control wiring lines 629 to be connected. The control TFTs 624 are arranged closer to the pixel electrodes 626 and the control wiring lines 629 (farther from the gate wiring lines 627) than the pixel TFTs 625 in the Y-axis direction. The control wiring lines 629 may have bent portions similarly to the gate wiring lines 27 described in the first embodiment (see FIG. 4). The control TFTs 624 are driven based on a control signal supplied to the control wiring lines 629, and accordingly, the image signal supplied from the pixel TFTs 625 can be supplied to the pixel electrodes 626. Similarly to the above-described first embodiment, by controlling driving of the control TFT 624 and the pixel TFT 625 at appropriate timings, the image signal supplied to one source wiring line 628 can be distributed to the plurality of pixel electrodes 626.

Also in the present embodiment, a second gate wiring line 627β, as illustrated in FIG. 23, is arranged to interpose a second pixel electrode row R2 including at least a first pixel electrode 626α and a second pixel electrode 626β between a first gate wiring line 627α and a second gate wiring line 627β in the Y-axis direction. In addition, the first gate wiring line 627α is arranged with a space from a first control wiring line 629α without the second pixel electrode row R2 being interposed between the first gate wiring line 627α and the first control wiring line 629α, and the second gate wiring line 627β is arranged with a space from a second control wiring line 629β without the second pixel electrode row R2 being interposed between the second gate wiring line 627β and the second control wiring line 629β. In this manner, the first gate wiring line 627α and the first control wiring line 629α, and the second gate wiring line 627β and the second control wiring line 629β, are dispersedly arranged so as to interpose the second pixel electrode row R2 in the Y-axis direction. Therefore, as compared with a case in which the first gate wiring line 627α, the first control wiring line 629α, the second gate wiring line 627β, and the second control wiring line 629β are collectively arranged on one side with respect to the first pixel electrode 626α and the second pixel electrode 626β in the Y-axis direction, parasitic capacitance can be reduced. In addition, since the number of intersection points where electrodes 624A to 624D and 625A to 625D of each of TFTs 624α, 624β, 625α, and 625β intersect with each of the wiring lines 627α, 627β, 629α, and 629β can be reduced, parasitic capacitance can be reduced. Accordingly, since dullness is less likely to occur in the scanning signals supplied to each of the gate wiring lines 627α and 627β and in the control signals supplied to each of the control wiring lines 629α and 629β, so that the operation of each of the TFTs 624α, 624β, 625α, and 625β can be stabilized, and the potential of each of the pixel electrodes 626α and 626β is less likely to fluctuate.

In the present embodiment, as illustrated in FIG. 23, the first control wiring line 629α is arranged closer to the second pixel electrode row R2 including at least the first pixel electrode 626α and the second pixel electrode 626β than the first gate wiring line 627α, and the second control wiring line 629β is arranged closer to the second pixel electrode row R2 than the second gate wiring line 627β. That is, the first control wiring line 629α and the second control wiring line 629β are arranged with the second pixel electrode row R2 interposed without the first gate wiring line 627α and the second gate wiring line 627β being interposed, and the first gate wiring line 627α and the second gate wiring line 627β are arranged with the second pixel electrode row R2 interposed with the first control wiring line 629α and the second control wiring line 629β interposed. In this manner, the control gate electrode 624A included in the first control TFT 624α can avoid intersecting with the first gate wiring line 627α. Accordingly, since occurrence of parasitic capacitance between the control gate electrode 624A and the first gate wiring line 627α can be avoided, the operation of the first control TFT 624α can be stabilized. Similarly, the control gate electrode 624A included in the second control TFT 624β can avoid intersecting with the second gate wiring line 627β. Accordingly, since occurrence of parasitic capacitance between the control gate electrode 624A and the second gate wiring line 627β can be avoided, the operation of the second control TFT 624β can be stabilized. Note that an electrode connection portion 638 connecting the pixel drain electrode 625C of the first pixel TFT 625α and the control source electrode 624B of the first control TFT 624α is set in a relationship to intersect with the first control wiring line 629α. Further, the electrode connection portion 638 connecting the pixel drain electrode 625C of the second pixel TFT 625β and the control source electrode 624B of the second control TFT 624β is set in a relationship to intersect with the second control wiring line 629β.

As described above, the array substrate (display substrate) 621 of the present embodiment includes the first gate wiring line (first scanning wiring line) 627α extending along a first direction, the second gate wiring line (second scanning wiring line) 627β extending along the first direction and arranged with a space from the first gate wiring line 627α, the first pixel electrode 626α interposed between the first gate wiring line 627α and the second gate wiring line 627β, the second pixel electrode 626β interposed between the first gate wiring line 627α and the second gate wiring line 627β and arranged with a space from the first pixel electrode 626α in the first direction, the first control wiring line 629α extending along the first direction and arranged with a space from the first gate wiring line 627α without the first pixel electrode 626α and the second pixel electrode 626β being interposed, the second control wiring line 629β extending along the first direction and arranged with a space from the second gate wiring line 627β without the first pixel electrode 626α and the second pixel electrode 626β being interposed, a first source wiring line (first signal wiring line) 628α extending along a second direction intersecting with the first direction and intersecting with the first gate wiring line 627α, the second gate wiring line 627β, the first control wiring line 629α, and the second control wiring line 629β, the first pixel TFT (first switching element) 625α connected to the first gate wiring line 627α and the first source wiring line 628α, the first control TFT (second switching element) 624α connected to the first control wiring line 629α, the first pixel TFT 625α, and the first pixel electrode 626α, the second pixel TFT (third switching element) 625β connected to the second gate wiring line 627β and the first source wiring line 628α, and the second control TFT (fourth switching element) 624β connected to the second control wiring line 629β, the second pixel TFT 625β, and the second pixel electrode 626β.

When the first pixel TFT 625α is driven by the signal supplied to the first gate wiring line 627α, the signal supplied to the first source wiring line 628α is supplied to the first pixel TFT 625α. In synchronization with this timing, when the first control TFT 624α is driven by the signal supplied from the first control wiring line 629α, the signal from the first pixel TFT 625α is supplied to the first pixel electrode 626α and the first pixel electrode 626α is charged. When the second pixel TFT 625β is driven by the signal supplied to the second gate wiring line 627β, the signal supplied to the first source wiring line 628α is supplied to the second pixel TFT 625β. In synchronization with this timing, when the second control TFT 624β is driven by the signal supplied from the second control wiring line 629β, the signal from the second pixel TFT 625β is supplied to the second pixel electrode 626β and the second pixel electrode 626β is charged.

In this manner, since a signal supplied to the first source wiring line 628α can be distributed to the first pixel electrode 626α and the second pixel electrode 626β, the number of source wiring lines 628 can preferably be reduced. In addition, since the first gate wiring line 627α and the first control wiring line 629α and the second gate wiring line 627β and the second control wiring line 629β are dispersedly arranged interposing the first pixel electrode 626α and the second pixel electrode 626β in the second direction, parasitic capacitance can be reduced as compared with a case in which the first gate wiring line 627α, the first control wiring line 629α, the second gate wiring line 627β, and the second control wiring line 629β are collectively arranged on one side with respect to the first pixel electrode 626α and the second pixel electrode 626β in the second direction. In addition, since the number of intersection points where electrodes 624Aα to 624Dα, 624Aβ to 624Dβ, 625Aα to 625Dα, and 625Aβ to 625Dβ of each of the TFTs 624α, 624β, 625α, and 625β intersect with each of the wiring lines 627α, 627β, 629α, and 629β can be reduced, parasitic capacitance can be reduced. Accordingly, since dullness is less likely to occur in the signals supplied to each of the wiring lines 627α, 627β, 629α, and 629β, the operation of each of the TFTs 624α, 624β, 625α, and 625β can be stabilized, and the potential of each of the pixel electrodes 626α and 626β is less likely to fluctuate.

### Other Embodiments

The techniques disclosed herein are not limited to the embodiments described above and illustrated in the drawings, and the following embodiments, for example, are also included within the technical scope.

(1) The end of the control trunk wiring line 17 may be connected to a terminal portion arranged in a mounting region of the drivers 12, 412, and 512, and the control trunk wiring line 17 may receive a control signal supplied from the drivers 12, 412, and 512 via the terminal portion.

(2) In the configuration described in the first to fourth embodiments, the end of the common wiring line 18 may be connected to a terminal portion arranged in the mounting region of the driver 12, and the common wiring line 18 may receive a common potential signal supplied from the driver 12 via the terminal portion.

(3) In the configuration described in the first to sixth embodiments, the arrangement of the first control wiring lines 29α, 129α, 229α, and 329α and the third control wiring lines 29γ, 129γ, 229γ, and 329γ may be exchanged. Similarly, the arrangement of the second control wiring lines 29β, 129β, 229β, and 329β and the fourth control wiring lines 29δ, 129δ, 229δ, and 329δ may also be exchanged.

(4) In the configuration described in the first to seventh embodiments, the arrangement of the first control wiring lines 29α, 129α, 229α, 329α, and 629α and the first gate wiring lines 27α, 127α, 227α, 327α, and 627α may also be exchanged. Similarly, the arrangement of the second control wiring lines 29β, 129β, 229β, 329β, and 629β and the second gate wiring lines 27β, 127β, 227β, 327β, and 627β may also be exchanged. Similarly, the arrangement of the third control wiring lines 29γ, 129γ, 229γ, and 329γ and the third gate wiring lines 27γ, 127γ, 227γ, and 327γ may also be exchanged. Similarly, the arrangement of the fourth control wiring lines 29δ, 129δ, 229δ, and 329δ and the fourth gate wiring lines 27δ and 327δ may also be exchanged.

(5) In the configuration described in the fifth embodiment, the common contact hole CH3 may be arranged to be interposed between the gate wiring line 427 and the control wiring line 429 in the Y-axis direction. The common contact hole CH3 may be arranged to be interposed between the pixel electrode 426 and the gate wiring line 427 in the Y-axis direction.

(6) In the configuration described in the fifth embodiment, the end of the common wiring line 418 may be connected to a terminal portion arranged in a mounting region of the flexible substrate 13, and the common wiring line 418 may receive a common potential signal supplied from the flexible substrate 13 via the terminal portion.

(7) In the configuration described in the fifth embodiment, a third metal film constituting the common wiring line 418 and an insulating film positioned on an upper-layer side thereof can additionally be provided between the flattening film 36 and the second interlayer insulating film 437. Since the insulating film is interposed between the common wiring line 418 formed of a part of the third metal film and the common electrode 430, the common contact hole CH3 may be provided in the insulating film.

(8) In the configuration described in the sixth embodiment, the end of the touch wiring line 44 may be connected to a terminal portion arranged in a mounting region of the flexible substrate 513, and the touch wiring line 44 may receive a touch signal and a common potential signal supplied from the flexible substrate 513 via the terminal portion.

(9) In the configuration described in the sixth embodiment, the arrangement of the touch contact hole CH4 may also be changed similarly to the common contact hole CH3 described in the above (5).

(10) In the configuration described in the sixth embodiment, a third metal film constituting the touch wiring line 44 and an insulating film positioned on an upper-layer side thereof can additionally be provided between the flattening film 36 and the second interlayer insulating film 37. Since an insulating film is interposed between the touch wiring line 44 formed of a part of the third metal film and the touch electrode 43, the touch contact hole CH4 may be provided in the insulating film.

(11) In the configuration described in the sixth embodiment, the touch panel pattern may be a mutual-capacitance type in addition to a self-capacitance type.

(12) The configuration described in the fifth and sixth embodiments may also be applied to the configuration described in the second to fourth embodiments.

(13) In the configuration described in the seventh embodiment, the arrangement of the first gate wiring line 627α and the third gate wiring line 627γ may also be exchanged. Similarly, the arrangement of the second gate wiring line 627β and the fourth gate wiring line 627δ may also be exchanged.

(14) The source wiring lines 28, 128, 328, 428, 528, and 628 may be not only configured to extend linearly along the Y-axis direction in the display region AA but also configured to extend generally along the Y-axis direction while being repeatedly bent in a zig-zag shape including inclined portions. In that case, the pixel electrodes 26, 126, 226, 326, 426, 526, and 626 may be formed in a bent shape in accordance with a planar shape of the source wiring lines 28, 128, 328, 428, 528, and 628.

(15) The number and arrangement of the drivers 12, 412, and 512 installed may be appropriately changed to those not illustrated in the drawings.

(16) The material of the semiconductor film provided in the array substrates 21 and 621 may be any of an amorphous silicon material, an oxide semiconductor material, a polycrystalline polysilicon material, or the like. In a case in which a polycrystalline polysilicon material is used as a material of the semiconductor film, the semiconductor film may be provided on a lower-layer side than the first metal film.

(17) Each of the TFTs 24, 25, 124, 125, 324, 325, 424, 624, and 625 may be of a bottom-gate type, a top-gate type, or a double-gate type.

(18) The pixel electrodes 26, 126, 226, 326, 426, 526, and 626 may be formed of the first transparent electrode film, and the common electrodes 30, 430, and 530 may be formed of the second transparent electrode film. In that case, slits for alignment control in the common electrodes 30, 430, and 530 are preferably formed.

(19) Instead of the gate drive circuit 15, a gate driver may be mounted on the array substrates 21 and 621.

(20) The drivers 12, 412, and 512 may be Chip On Film (COF) mounted on the flexible substrate 13 that is Film On Glass (FOG) mounted on the array substrates 21 and 621.

(21) The planar shape of the liquid crystal panels 11 and 511 may be a vertically long rectangular shape, a square shape, a circular shape, a semicircular shape, a vertically long elliptical shape, an oval shape, a trapezoidal shape, or the like.

(22) The liquid crystal panels 11 and 511 may be of a reflective type or a transflective type in addition to a transmissive type.

(23) The display mode of the liquid crystal panels 11 and 511 may be a Multi-domain Vertical Alignment (MVA) mode, an In-Plane Switching (IPS) mode, a Twisted Nematic (TN) mode, or the like.

(24) As the display device, a panel other than the liquid crystal panels 11 and 511, such as an organic ElectroLuminescence (EL) display panel, or an ElectroPhoretic Display (EPD) panel of a microcapsule type may also be used.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display substrate comprising:
a first scanning wiring line extending along a first direction;
a second scanning wiring line extending along the first direction and arranged with a space from the first scanning wiring line;
a first pixel electrode interposed between the first scanning wiring line and the second scanning wiring line;
a second pixel electrode interposed between the first scanning wiring line and the second scanning wiring line and arranged with a space from the first pixel electrode in the first direction;
a first control wiring line extending along the first direction and arranged with a space from the first scanning wiring line without the first pixel electrode and the second pixel electrode being interposed;
a second control wiring line extending along the first direction and arranged with a space from the second scanning wiring line without the first pixel electrode and the second pixel electrode being interposed;
a first signal wiring line extending along a second direction intersecting with the first direction and intersecting with the first scanning wiring line, the second scanning wiring line, the first control wiring line, and the second control wiring line;
a first switching element connected to the first control wiring line or the first scanning wiring line and the first signal wiring line;
a second switching element connected to the first scanning wiring line or the first control wiring line, the first switching element, and the first pixel electrode;
a third switching element connected to the second control wiring line or the second scanning wiring line and the first signal wiring line; and
a fourth switching element connected to the second scanning wiring line or the second control wiring line, the third switching element, and the second pixel electrode.

2. The display substrate according to claim 1,
wherein the first switching element is connected to the first control wiring line, the second switching element is connected to the first scanning wiring line, the third switching element is connected to the second control wiring line, and the fourth switching element is connected to the second scanning wiring line.

3. The display substrate according to claim 2, comprising:
a third pixel electrode arranged with at least the first scanning wiring line and the first control wiring line interposed between the third pixel electrode and the first pixel electrode;
a third scanning wiring line extending along the first direction and interposed between the first pixel electrode and the third pixel electrode;
a fifth switching element connected to the first control wiring line and the first signal wiring line; and
a sixth switching element connected to the third scanning wiring line, the fifth switching element, and the third pixel electrode.

4. The display substrate according to claim 2,
wherein the first scanning wiring line is arranged closer to the first pixel electrode and the second pixel electrode than the first control wiring line, and the second scanning wiring line is arranged closer to the first pixel electrode and the second pixel electrode than the second control wiring line.

5. The display substrate according to claim 2, comprising:
a fourth pixel electrode interposed between the first scanning wiring line and the second scanning wiring line and arranged with a space from the first pixel electrode and the second pixel electrode in the first direction;
a fifth pixel electrode interposed between the first scanning wiring line and the second scanning wiring line and arranged with a space from the first pixel electrode, the second pixel electrode, and the fourth pixel electrode in the first direction;
a third control wiring line extending along the first direction and arranged with a space from the first scanning wiring line and the first control wiring line without the first pixel electrode, the second pixel electrode, the fourth pixel electrode, and the fifth pixel electrode being interposed;
a fourth control wiring line extending along the first direction and arranged with a space from the second scanning wiring line and the second control wiring line without the first pixel electrode, the second pixel electrode, the fourth pixel electrode, and the fifth pixel electrode being interposed;
a seventh switching element connected to the third control wiring line and the first signal wiring line;
an eighth switching element connected to the first scanning wiring line, the seventh switching element, and the fourth pixel electrode;
a ninth switching element connected to the fourth control wiring line and the first signal wiring line; and
a tenth switching element connected to the second scanning wiring line, the ninth switching element, and the fifth pixel electrode.

6. The display substrate according to claim 5, including the first signal wiring line branched into a first branch portion extending along the second direction and a second branch portion extending along the second direction and arranged with a space from the first branch portion in the first direction, the first branch portion being connected with at least the first switching element and the seventh switching element, the second branch portion being connected with at least the third switching element and the ninth switching element, the first pixel electrode and the fourth pixel electrode being arranged with the first branch portion interposed between the first pixel electrode and the fourth pixel electrode in the first direction, and the second pixel electrode and the fifth pixel electrode being arranged with the second branch portion interposed between the second pixel electrode and the fifth pixel electrode in the first direction, the display substrate comprising:
a second signal wiring line extending along the second direction and including a portion interposed between the first branch portion and the second branch portion in the first direction;
a sixth pixel electrode arranged with a space from the second signal wiring line in the first direction;
a seventh pixel electrode arranged with the second signal wiring line interposed between the sixth pixel electrode and the seventh pixel electrode in the first direction;
an eleventh switching element connected to the second control wiring line and the second signal wiring line;
a twelfth switching element connected to the second scanning wiring line, the eleventh switching element, and the sixth pixel electrode;
a thirteenth switching element connected to the fourth control wiring line and the second signal wiring line;
a fourteenth switching element connected to the second scanning wiring line, the thirteenth switching element, and the seventh pixel electrode; and
a signal supply unit configured to supply signals opposite in polarity to each other to the first signal wiring line and the second signal wiring line.

7. The display substrate according to claim 5, including a second signal wiring line extending along the second direction, a first signal wiring line branched into a first branch portion extending along the second direction and a second branch portion extending along the second direction and arranged with a space from the first branch portion in the first direction, the first branch portion being connected with at least the first switching element and the seventh switching element, the second branch portion being connected with at least the third switching element and the ninth switching element, a second signal wiring line branched into a third branch portion extending along the second direction and a fourth branch portion extending along the second direction, the fourth branch portion being arranged with the first branch portion interposed between the third branch portion and the fourth branch portion in the first direction and interposed between the first branch portion and the second branch portion, the first pixel electrode and the fourth pixel electrode being arranged with at least the first branch portion interposed between the first pixel electrode and the fourth pixel electrode in the first direction, and the second pixel electrode and the fifth pixel electrode being arranged with at least the second branch portion interposed between the second pixel electrode and the fifth pixel electrode in the first direction, the display substrate comprising:
an eighth pixel electrode arranged with the fourth branch portion interposed between the second pixel electrode and the eighth pixel electrode in the first direction and interposed between the first pixel electrode and the fourth branch portion;
a ninth pixel electrode arranged with the first branch portion interposed between the first pixel electrode and the ninth pixel electrode in the first direction and interposed between the fourth pixel electrode and the first branch portion;
a tenth pixel electrode arranged with the second branch portion interposed between the fifth pixel electrode and the tenth pixel electrode in the first direction and interposed between the second pixel electrode and the second branch portion;
a fifteenth switching element connected to the second control wiring line and the fourth branch portion;
a sixteenth switching element connected to the second scanning wiring line, the fifteenth switching element, and the eighth pixel electrode;
a seventeenth switching element connected to the first control wiring line and the third branch portion;
an eighteenth switching element connected to the first scanning wiring line, the seventeenth switching element, and the ninth pixel electrode;
a nineteenth switching element connected to the fourth control wiring line and the fourth branch portion; and
a twentieth switching element connected to the second scanning wiring line, the nineteenth switching element, and the tenth pixel electrode.

8. The display substrate according to claim 5, including the first pixel electrode, the second pixel electrode, the fourth pixel electrode, and the fifth pixel electrode constituting a first pixel electrode row, the display substrate comprising:
a second pixel electrode row including a plurality of pixel electrodes arranged with at least the second scanning wiring line and the second control wiring line interposed between the first pixel electrode row and the second pixel electrode row in the second direction; and
a second signal wiring line extending along the second direction,
wherein the first signal wiring line includes a first wiring line portion crossing the first pixel electrode row and extending along the second direction, a second wiring line portion crossing the second pixel electrode row, arranged at a position spaced apart from the first wiring line portion in the first direction and extending along the second direction, and a first bridging portion connecting the first wiring line portion and the second wiring line portion, the second signal wiring line includes a third wiring line portion crossing the first pixel electrode row, positioned in the same column as the second wiring line portion and extending along the second direction, a fourth wiring line portion crossing the second pixel electrode row, positioned in the same column as the first wiring line portion and extending along the second direction, and a second bridging portion connecting the third wiring line portion and the fourth wiring line portion, the first pixel electrode and the fourth pixel electrode are arranged with the first wiring line portion interposed between the first pixel electrode and the fourth pixel electrode in the first direction, an eleventh pixel electrode is arranged with a space from the third wiring line portion in the first direction, a twelfth pixel electrode is arranged with the third wiring line portion interposed between the eleventh pixel electrode and the twelfth pixel electrode in the first direction, a thirteenth pixel electrode is the pixel electrode constituting the second pixel electrode row and is arranged with a space from the second wiring line portion in the first direction, a fourteenth pixel electrode is the pixel electrode constituting the second pixel electrode row and is arranged with the second wiring line portion interposed between the thirteenth pixel electrode and the fourteenth pixel electrode in the first direction, a fifteenth pixel electrode is the pixel electrode constituting the second pixel electrode row and is arranged with a space from the fourth wiring line portion in the first direction, a sixteenth pixel electrode is the pixel electrode constituting the second pixel electrode row and is arranged with the fourth wiring line portion interposed between the fifteenth pixel electrode and the sixteenth pixel electrode in the first direction, a fourth scanning wiring line extends along the first direction and is arranged with the second pixel electrode row interposed between the second scanning wiring line, the second control wiring line, and the fourth control wiring line in the second direction, a fifth control wiring line extends along the first direction and is arranged with a space from the fourth scanning wiring line without the second pixel electrode row being interposed, a sixth control wiring line extends along the first direction and is arranged with a space from the fourth scanning wiring line and the fifth control wiring line without the second pixel electrode row being interposed, a fifth scanning wiring line extends along the first direction and is interposed between the first pixel electrode row and the second pixel electrode row in the second direction, a twenty-first switching element is connected to the first control wiring line and the third wiring line portion, a twenty-second switching element is connected to the first scanning wiring line, the twenty-first switching element, and the eleventh pixel electrode, a twenty-third switching element is connected to the third control wiring line and the third wiring line portion, a twenty-fourth switching element is connected to the first scanning wiring line, the twenty-third switching element, and the twelfth pixel electrode, a twenty-fifth switching element is connected to the fifth control wiring line and the second wiring line portion, a twenty-sixth switching element is connected to the fourth scanning wiring line, the twenty-fifth switching element, and the thirteenth pixel electrode, a twenty-seventh switching element is connected to the sixth control wiring line and the second wiring line portion, a twenty-eighth switching element is connected to the fourth scanning wiring line, the twenty-seventh switching element, and the fourteenth pixel electrode, a twenty-ninth switching element is connected to the fifth control wiring line and the fourth wiring line portion, a thirtieth switching element is connected to the fourth scanning wiring line, the twenty-ninth switching element, and the fifteenth pixel electrode, a thirty-first switching element is connected to the sixth control wiring line and the fourth wiring line portion, a thirty-second switching element is connected to the fourth scanning wiring line, the thirty-first switching element, and the sixteenth pixel electrode, and a signal supply unit is configured to supply signals opposite in polarity to each other to the first signal wiring line and the second signal wiring line.

9. The display substrate according to claim 1, comprising:
a common electrode arranged to overlap at least the first pixel electrode and the second pixel electrode with an insulating film interposed between the common electrode and at least the first pixel electrode and the second pixel electrode; and
a common wiring line extending along the second direction and connected to the common electrode,
wherein the common wiring line includes at least the first common wiring line arranged with the first pixel electrode interposed between the first signal wiring line and the first common wiring line in the first direction.

10. The display substrate according to claim 1, comprising:
a position detection electrode arranged to overlap at least the first pixel electrode and the second pixel electrode with an insulating film interposed between the position detection electrode and at least the first pixel electrode and the second pixel electrode; and
a position detection wiring line extending along the second direction and connected to the position detection electrode,
wherein the position detection wiring line includes at least a first position detection wiring line arranged with the first pixel electrode interposed between the first signal wiring line and the first position detection wiring line in the first direction.

11. A display device, comprising:
the display substrate according to claim 1; and
a counter substrate arranged to face the display substrate.
